(19) United States
(12) Patent Application Publication
(10) Pub. No.: US 2026/0112595 A1
(43) Pub. Date: Apr. 23, 2026

(54) MULTI-CHANNEL ION ROUTER FOR GUIDING IONS BETWEEN SELECTIVELY OPERATED PORTS

(71) Applicant: Thermo Finnigan LLC, San Jose, CA (US)

(72) Inventors: Michael W. Senko, Sunnyvale, CA (US); Michael P. Goodwin, Santa Clara, CA (US)

(21) Appl. No.: 19/345,320

(22) Filed: Sep. 30, 2025

Related U.S. Application Data
(60) Provisional application No. 63/709,236, filed on Oct. 18, 2024.

(51) Int. Cl. H01J 49/06

(52) U.S. Cl. CPC H01J 49/066; H01J 49/067; H01J 49/068

(57) ABSTRACT

An ion router including a pair of opposing surfaces, at least three ports each defining an opening between the pair of opposing surfaces, and a plurality of ion channels defined by arrays of electrodes coupled to the pair of surfaces. At least one port is configured as an entrance port through which ions are received into the ion router and at least two ports are configured to be selectively operated as either one of an exit port through which ions exit the ion router or a closed port through which ions are neither received nor ejected by the ion router. The plurality of ion channels converge toward a common position within the ion router and are configured to receive voltages for guiding ions from a port configured as an entrance port to a port selectively operated as an exit port.

### RELATED APPLICATIONS

The present application claims priority under 35 U.S.C. § 119(e) to U.S. Provisional Patent Application No. 63/709,236, filed Oct. 18, 2024, which is incorporated herein by reference in its entirety.

### BACKGROUND INFORMATION

Mass spectrometry has often been referred to as a “Gold Standard” tool for the identification and analysis of various classes of compounds. In no small measure, the power of mass spectrometry resides in the ability of modern mass spectrometers to separately isolate, store, and subsequently manipulate—via ion fragmentation or ion-ion chemical reaction—specific ion species of interest that are chosen from among the multitude of ion species that are generally produced by ionization of any sample mixture. In many types of mass spectrometers, quadrupole mass filters are often employed to perform the ion isolation function. For example, in a mass spectrometer of the triple-quadrupole type or of the quadrupole-time-of-flight (Q-TOF) type, a mass filter is disposed upstream from a mass analyzer. The mass filter may receive a stream of ions composed of a variety of ion species comprising a variety of mass-to-charge (m/z) ratios. To isolate a particular ion species comprising a specific m/z, a specific pair of direct-current (DC) and oscillatory radio-frequency (RF) voltages may be applied to rod electrodes of the mass filter. The application of DC and RF voltages of the appropriate magnitude permits transmission, through the mass filter, of only a narrow range of m/z values that encompasses the specific m/z of interest. Under such operation, ions having all other m/z values are ejected from the apparatus and neutralized. The ion species that comprises the specific m/z that is of interest is thus transmitted, without significant contamination from other ion species, through the mass filter to other, downstream mass spectrometer components that may manipulate and analyze ions of the isolated ion species in various ways.

Although mass filters perform an important function, they are nonetheless inefficient in that, at any one time, they cause the elimination of all ions except for those specific ions that are permitted to pass through the apparatus by the choice of filter passband. As a result, typically more than ninety percent of potentially available compositionally relevant information may be wasted by the mass filter at any particular time.

To improve overall analytical efficiency, various types of pre-separation apparatuses have been employed, generally upstream from a mass filter, as a means of providing non-destructive initial coarse separation of ion species. Once separated by the pre-separation apparatus, the various coarsely separated groups of ions may then be separately transferred to a mass filter for narrow-band isolation of ion species of interest. Because of the earlier pre-separation, a lesser proportion of ions will be discarded by the mass filter during each such isolation.

As one example of such a pre-separation method, ion mobility spectrometry (IMS) is often used to separate ionized molecules in the gas phase based on their mobility in a carrier buffer gas. The reader is referred to Kanu et al. (Kanu, Abu B., Prabha Dwivedi, Maggie Tam, Laura Matz, and Herbert H. Hill Jr. “Ion mobility-mass spectrometry.” Journal of mass spectrometry 43, no. 1 (2008): 1-22.) for a general review of coupling of ion mobility spectrometers to mass spectrometers. According to another separation method, which is known as trapped ion mobility spectrometry (TIMS), ions are trapped along a non-uniform electric DC field (field gradient) by a counteracting gas flow or along a uniform electric DC field by a counteracting gas flow which has a non-uniform axial velocity profile (gas velocity gradient). The trapped ions are separated in space according to ion mobility and subsequently eluted (released) over time according to their mobility by adjusting one of the gas velocity and the DC electric field. The details of the TIMS technique are described, for example, in U.S. Pat. No. 6,630,662 in the name of inventor Loboda; U.S. Pat. No. 7,838,826 B1 in the name of inventor Park; and U.S. Pat. No. 11,226,308 in the names of Rather and Michelmann. Additional descriptions are provided in Michelmann et al. (Michelmann, Karsten, Joshua A. Silveira, Mark E. Ridgeway, and Melvin A. Park. “Fundamentals of trapped ion mobility spectrometry.” Journal of the American Society for Mass Spectrometry 26, no. 1 (2014): 14-24.) as well as in Silveira et al. (Silveira, Joshua A., Karsten Michelmann, Mark E. Ridgeway, and Melvin A. Park. “Fundamentals of trapped ion mobility spectrometry part II: fluid dynamics.” Journal of the American Society for Mass Spectrometry 27, no. 4 (2016): 585-595.)

Both the ion mobility spectrometry technique and the trapped ion mobility spectrometry technique make use of ion guides that are configured to provide an axial DC field along their length. Such axial fields may be provided by proportioning a voltage that is applied between entrance and exit ends of the ion guide among a plurality of electrodes that are disposed between the entrance and exit ends of the ion guide. As one example, the voltage may be proportioned among segments of the rod electrodes of a quadrupole or multipole ion guide apparatus. Alternatively, as discussed in greater detail later in this document, the voltage may be proportioned, for example, among a plurality of mutually parallel electrode plates or among a plurality of thin electrode wires deposited on or otherwise adhered to a substrate plate or wafer.

With the provision of appropriate power supplies and electrical connections, the various rod segments of a segmented quadrupole ion guide, plate electrodes of a stacked plate or stacked ring ion guide, or electrode wires of a printed circuit board may be provided with so-called “travelling-wave” DC voltages (U.S. Pat. No. 6,812,453 in the names of inventors Bateman et al). Generally, in such operation, periodically varying DC voltages are applied to the individual rod segment electrodes, plate electrodes, or wires, the phase of the periodicity being shifted between pairs of electrodes such that electrical potential wells are caused to migrate from an ion guide's ion inlet end to its ion outlet end. Travelling DC voltage waves have been used to control ions in mass spectrometers in accordance with several different configurations. The most common commercially-available ion guides and mass spectrometer collision cells that employ DC travelling waves are the T-Wave™ systems that are provided by Waters Corporation of Milford, Massachusetts, USA. The T-Wave™ systems employ stacked ring ion guides, with radial confinement of ions provided by RF voltages and axial ion propulsion provided by a summed DC travelling wave. Other DC travelling wave configurations known by the acronym “SLIM” (Structures for Lossless Ion Manipulation) have been developed at Pacific Northwest National Laboratory and are described in Tolmachev et al. (Tolmachev, Aleksey V., Ian K. Webb, Yehia M. Ibrahim, Sandilya VB Garimella, Xinyu Zhang, Gordon A. Anderson, and Richard D. Smith. “Characterization of ion dynamics in structures for lossless ion manipulations.” Analytical chemistry 86, no. 18 (2014): 9162-9168.) as well as in Ibrahim et al. (Ibrahim, Yehia M., Ahmed M. Hamid, Liulin Deng, Sandilya VB Garimella, Ian K. Webb, Erin S. Baker, and Richard D. Smith. “New frontiers for mass spectrometry based upon structures for lossless ion manipulations.” Analyst 142, no. 7 (2017): 1010-1021.). The SLIM ion guides employ similar travelling wave concepts to trap and propel ions, but do so using modified electrode configurations that are amenable to printed circuit board implementation. The T-Wave™ and SLIM travelling wave systems are most commonly used at relatively high pressures (e.g., approximately 1 Torr), where the axial motion of ions is impeded by gas collisions, such that separation is possible based partially on collisional cross section.

Recently, there have been descriptions of ion guides in which travelling waves are implemented not by DC voltages but, instead, by the manipulation of the main RF axial-confinement waveform(s) that are applied to multipole rod segments or to plate electrodes of stacked ring structures. According to these teachings, the various electrodes of an electrode array (e.g., an array of plate electrodes, rod-electrode segments, printed-circuit-board electrodes, etc.) may be logically grouped into consecutive subsets of electrodes (e.g., sets comprising three or more electrodes each) whereby, within each subset, a differently modulated RF waveform is applied to each electrode of the subset. Examples include RF travelling waves created via amplitude modulation (U.S. Pat. No. 9,799,503 in the names of inventors Williams et al.) and frequency modulation (U.S. Pat. No. 10,692,710 in the names of inventors Prabhakaran et al.).

### SUMMARY

The following description presents a simplified summary of one or more aspects of the systems and methods described herein. This summary is not an extensive overview of all contemplated aspects and is intended to neither identify key or critical elements of all aspects nor delineate the scope of any or all aspects. Its sole purpose is to present one or more aspects of the systems and methods described herein as a prelude to the detailed description that is presented below.

In some illustrative examples, an ion router comprises: a pair of opposing surfaces; at least three ports, each port included in the at least three ports defining an opening between the pair of opposing surfaces, wherein at least one port included in the at least three ports is configured as an entrance port through which ions are received into the ion router, and wherein at least two ports included in the at least three ports are configured to be selectively operated as either one of an exit port through which ions exit the ion router or a closed port through which ions are neither received nor ejected by the ion router; and a plurality of ion channels defined by arrays of electrodes coupled to the pair of surfaces and configured to receive one or more voltages for guiding ions from a port configured as an entrance port to a port selectively operated as an exit port, wherein the plurality of ion channels converge toward a common position within the ion router.

In some illustrative examples, an ion router comprises: a pair of opposing surfaces; at least three ports, each port included in the at least three ports defining an opening between the pair of opposing surfaces, wherein at least one port included in the at least three ports is configured to be selectively operated as any one of an entrance port through which ions are received into the ion router, an exit port through which ions exit the ion router, or a closed port through which ions are neither received nor ejected by the ion router; and a plurality of ion channels defined by arrays of electrodes coupled to the pair of surfaces and configured to receive one or more voltages for guiding ions from a port operated as an entrance port to a port operated as an exit port.

In some illustrative examples, a system comprises: an ion router comprising: a pair of opposing surfaces; at least three ports, each port included in the at least three ports defining an opening between the pair of opposing surfaces, wherein each port included in the at least three ports is configured to be selectively operated as any of an entrance port through which ions are received into the ion router, an exit port through which ions exit the ion router, or a closed port through which ions are neither received nor ejected by the ion router; and a plurality of ion channels defined by arrays of electrodes coupled to the pair of surfaces and configured to receive one or more voltages for guiding ions from a port operated as an entrance port to a port operated as an exit port; and an ion sorter coupled with a first port included in the at least three ports, wherein the ion router is configured to transmit ions to the ion sorter when the first port is selectively operated as an exit port and to receive ions from the ion sorter when the first port is selectively operation as an entrance port.

In some illustrative examples, a method of operating an ion router comprises: applying a first direct current (DC) voltage to a first port electrode associated with a first port to selectively operate the first port as an entrance port through which ions are received into the ion router, an exit port through which ions exit the ion router, or as a closed port through which ions are neither received nor ejected by the ion router; applying a second DC voltage to a second port electrode associated with a second port to selectively operate the second port as an entrance port through which ions are received into the ion router, an exit port through which ions exit the ion router, or as a closed port through which ions are neither received nor ejected by the ion router; applying a third DC voltage to a third port electrode associated with a third port to selectively operate the third port as an entrance port through which ions are received into the ion router, an exit port through which ions exit the ion router, or as a closed port through which ions are neither received nor ejected by the ion router; and introducing ions into a port operated as an entrance port to guide the ions from the port operated as an entrance port to a port operated as an exit port.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1A is a schematic cross-sectional depiction of a known stacked-ring ion guide ion transport apparatus.

FIG. 1B is a schematic depiction of an exemplary plate electrode as may be employed in a stacked-ring ion guide ion transport apparatus.

FIG. 1C is a schematic depiction of a known ion manipulation and ion guiding device that may be employed as an ion transport apparatus.

FIG. 1D is a schematic depiction of an electrode configuration of a surface of the known ion manipulation and ion guiding device of FIG. 1C.

FIG. 2A is a schematic cross-sectional depiction of an embodiment of an ion tunnel stacked-ring ion guide in accordance with the present teachings, wherein the directions of ion migration are caused to differ for different mass-to-charge (m/z) ratios by application of a static, uniform DC axial field that is in opposition to the downstream migration of pseudopotential wells produced by application of travelling Radio-Frequency (RF) waves.

FIG. 2B is another schematic cross-sectional depiction of the ion tunnel stacked-ring ion guide of FIG. 2A, wherein ions are caused to migrate to and accumulate within various different stability zones in accordance with their respective mass-to-charge (m/z) ratios by application of a static, non-uniform DC axial field that is in opposition to the downstream migration of the pseudopotential wells.

FIG. 2C is a schematic depiction of the extraction of ions from the stacked-ring ion guide apparatus of FIG. 2A, in order their respective m/z ratios, by ramping an amplitude (or amplitudes) of RF voltages applied to electrodes of the apparatus.

FIG. 3A is a schematic cross-sectional depiction of a first embodiment of an ion funnel stacked-ring ion guide in accordance with the present teachings, wherein the directions of ion migration are caused to differ for different mass-to-charge (m/z) ratios by application of a static, uniform DC axial field that pulls ions towards the downstream, narrow end of the funnel and that is in opposition to the upstream migration of pseudopotential wells produced by application of travelling RF waves.

FIG. 3B is a modified version, in accordance with the present teachings, of the ion manipulation and ion guiding device of FIG. 1C.

FIG. 4A is a set of simulated plots of the equilibrium positions of ions of various m/z ratios within an ion guide ion separator apparatus under application of a gradient of a DC axial field, the direction of which opposes the direction of RF-generated travelling waves.

FIG. 4B is a set of simulated plots of the equilibrium positions of ions of various m/z ratios within an ion guide ion separator apparatus under application of a gradient in the amplitude of travelling-wave-inducing RF waveforms in the presence of an opposing uniform DC axial field.

FIG. 5 is a schematic depiction of a portion of a mass spectrometer apparatus that includes a quadrupole mass filter or other mass spectrometer component arranged in series with an ion optical apparatus that is configured and operated in accordance with the present teachings.

FIG. 6A is a reproduction of the schematic cross-sectional depiction of the apparatus of FIG. 2A and of the ion packets therein, further showing a schematic example of how DC voltages may be apportioned among stacked electrodes to generate a static, uniform DC axial field.

FIG. 6B is a schematic plot of the application, in accordance with some embodiments of the present teachings, of a gradient of the magnitude of the uniform axial electric field, \vec{E}, in opposition to the urging of ions by movement of RF-generated travelling pseudo-potential wells (pseudo-waves).

FIG. 6C is a schematic plot of a profile of the magnitudes of DC voltages, V, applied to a series of electrodes within an ion guide or ion separator apparatus that may be used to generate the axial electric field profile of FIG. 6B.

FIG. 6D is a schematic plot of the application, in accordance with some other embodiments of the present teachings, of an axial electric field, \vec{E}, that is in opposition to the urging of ions by movement of RF-generated travelling pseudo-waves, wherein the magnitude of the electric field increases along a direction towards an ion outlet in a first portion of an ion guide or ion separator apparatus and is constant in a second portion of the ion guide or ion separator apparatus, the plot also schematically depicting the positions, within the apparatus, of packets of ions having different respective mass-to-charge ratios at a first time, t₁, at which an applied amplitude of pseudopotential wells is at a first value.

FIG. 6E is a schematic plot of a profile of the magnitudes of DC voltages, V, applied to a series of electrodes within an ion guide or ion separator apparatus that may be used to generate the axial electric field profile of FIG. 6D.

FIG. 6F is a schematic depiction of the positions of the packets of ions of FIG. 6D at a second time, t₂, at which an applied amplitude of pseudopotential wells is at a second value that is greater than the first applied amplitude value.

FIG. 6G is a schematic depiction of the positions of the packets of ions of FIG. 6D and FIG. 6F at a third time, t₃, at which the applied amplitude of the pseudopotential wells is at a third value that is greater than the second applied amplitude value.

FIG. 6H is a schematic plot of the application, in accordance with some embodiments of the present teachings, of an axial electric field, \vec{E}, that is in opposition to the urging of ions by movement of RF-generated travelling pseudo-waves, wherein the magnitude of the electric field increases at a first rate along a direction towards an ion outlet in a first portion of an ion guide or ion separator apparatus and increases at a second, lesser rate in the same direction in a second portion of the ion guide or ion separator apparatus.

FIG. 7A is a schematic plot of a first method of ramping of an RF amplitude that is applied to electrodes of ion guides in accordance with the present teachings.

FIG. 7B is a schematic plot of a second method of ramping of an RF amplitude that is applied to electrodes of ion guides in accordance with the present teachings.

FIG. 8 is a plot of the mass spectral resolution of ions emerging from an ion guide or ion separator apparatus in which a DC electric field profile of the type shown in FIG. 6D is employed while an amplitude of an opposing set of RF-generated pseudo-waves is increased over time in accordance with the present teachings.

FIG. 9 is a plot of the variation, versus mass-to-charge ratio, of mass spectral resolution of ions emerging from an ion guide or ion separator apparatus versus total time allotted for ramping an amplitude of an opposing set of RF-generated pseudo-waves in accordance with the present teachings, wherein a DC electric field profile of the type shown in FIG. 6D is employed.

FIG. 10A is a flow diagram of a first method of operating an ion guide in accordance with the present teachings.

FIG. 10B is a flow diagram of a second method of operating an ion guide in accordance with the present teachings.

FIG. 10C is a flow diagram of a third method of operating an ion guide in accordance with the present teachings.

FIG. 11A is a schematic depiction of an example voltage profile and resultant electric field vector magnitudes as may be applied to an ion guide apparatus in accordance with alternative methods of the present teachings.

FIG. 11B is a schematic depiction of a second example voltage profile and the resultant electric field vector magnitudes that may be applied to an ion guide apparatus in alternation with the voltage profile of FIG. 7A, in accordance with alternative methods of the present teachings.

FIG. 12 shows a perspective view of an illustrative ion router.

FIG. 13 shows a cross-sectional view of the ion router of FIG. 12 taken along the dash-dot-dash line labeled 13 in FIG. 12.

FIGS. 14A and 14B show cross-sectional views of the ion router of FIG. 12 taken along the dash-dot-dash line labeled 14 in FIG. 12.

FIG. 15 shows a cross-sectional view of the ion router of FIG. 12 taken along the dash-dot-dash line labeled 15 in FIG. 14A as well as illustrative ion trajectories within the ion router when electrodes of the ion router receive voltages.

FIGS. 16-19 show alternative configurations of electrodes on a surface.

FIG. 20 shows a perspective view of another illustrative ion router.

FIGS. 21A and 21B show cross-sectional views of the ion router of FIG. 20 taken along the dash-dot-dash lines labeled 21A and 21B in FIG. 20, respectively.

FIG. 22 shows a perspective view of another illustrative ion router.

FIGS. 23A and 23B show cross-sectional views of the ion router of FIG. 22 taken along the dash-dot-dash lines labeled 23A and 23B in FIG. 20, respectively.

FIG. 24 shows a mass spectrometry system incorporating an ion router according to the principles described herein.

FIG. 25 shows a flowchart of an illustrative method of routing ions.

### DETAILED DESCRIPTION

The present application relates to mass spectrometers and mass spectrometry. More particularly, the present application relates to ion optics components, including ion routers, ion guides, ion traps, and ion separation devices that are employed in mass spectrometers and to methods of use of such ion optics components within mass spectrometers. All patents, patent application publications and other published articles mentioned herein are hereby incorporated by reference herein in their entirety as if set forth fully herein.

In some examples, as a result of the m/z-dependence of the pseudopotential-derived forces (i.e., travelling pseudopotential wells) that drive ion migration in RF-modulated travelling-wave devices, a variety of ion sorting and/or ion storage devices may be constructed by counteracting the m/z-dependent pseudopotential force with an opposing m/z-independent force, such as an opposing DC field. Such RF-DC ion sorting devices may be configured to provide initial coarse separation and temporary storage of ion species without reliance upon gas flow. Such RF-DC sorting devices, as disclosed herein, may be deployed under both high-vacuum and moderate vacuum conditions and are therefore more versatile than conventional ion sorting devices. Whereas existing DC travelling wave devices require RF containment that is separate from the DC travelling wave to move ions, the apparatuses and methods described herein utilize RF voltage to both contain ions and move ions.

Since an RF-derived travelling wave has an m/z-dependent force (i.e., a greater force at lower m/z values), it is possible to oppose this force with a second m/z-independent force. For example, a static opposed DC axial electric field may be created by applying a simple DC potential gradient across a plurality of electrodes. The combination of opposed forces may then be used, to advantage, to spatially sort ions within an ion guide or ion trapping device. Such a pair of opposing applied forces will create three different ion behavior conditions, as follows: (1) firstly, in the case of ions having the smallest m/z values, for which the force attributable to the RF travelling wave dominates the DC-field force, the movement will be in the direction of the travelling wave; (2) in the case of ions having the greatest m/z values, for which the DC axial field dominates, the movement will be opposite to the direction of the travelling wave; and (3), finally, for ions having a particular critical m/z value, RF-derived and DC-potential gradient-derived forces will balance such that ions will not move in either direction and will be trapped within a specific region within an ion optical device, where the position of the specific region depends on the particular m/z value and on the applied voltages.

By coordinated application of an RF field and a static DC field, it is possible, in some embodiments, to configure an ion guide so that low-m/z-value ions and high-m/z-value ions are caused to migrate in opposite directions, while, at the same time, ions having the critical m/z value are trapped at a trapping location within the ion guide. According to some other embodiments, a gradient may be applied either to the RF field, the DC field or both the RF and DC fields. In such cases, the trapping location will become m/z dependent, thereby both trapping and spatially separating ions based on their respective m/z values. Therefore, in such embodiments, the ions may be spatially sorted along a length of the ion guide, similar to the fashion in which ions in liquid-phase isoelectric focusing move to the point in a pH gradient that makes the ions neutral. The RF field gradient can be created by changing the RF amplitude, V, along the length of the device or, more simply, by changing the electrode geometry by varying either axial spacing of the electrodes or by varying the electrode aperture diameters. The DC field gradient can most simply be created by altering the resistors in the divider network used to create the gradient.

The spatial and temporal ion separation and sorting provided by apparatuses described herein do not rely on gas flow. However, optimal operation of such apparatuses may be achieved with ambient gas pressures in the range of 0.01 Torr to approximately 2 Torr. At lower pressures, when an ion is pulled from a pseudopotential well by the opposed DC, there are insufficient gas collisions to allow the ion to settle into an adjacent pseudopotential well. In such low-pressure regimes, ions may be pulled through or across several travelling RF pseudopotential wells by an opposing DC field. Such low-pressure behavior is harmful to the ultimate resolution of the separation. The strength of the ion mobility contribution will be dependent on ion characteristics as well as various controllable parameters, such as gas composition, gas temperature, etc. Unfortunately, this ion mobility contribution is difficult to predict as a result of the time-varying RF field. Accordingly, it may be necessary, under some circumstances, to perform an appropriate calibration of each apparatus' response under various chosen experimental conditions and various classes of ions. In many embodiments, even at pressures in the range from 0.01 to 0.5 Torr, the contribution of ion mobility effects between ions can be small or even negligible in comparison to effects caused by differences in mass-to-charge ratio or differences in charge of the ions.

In the description herein, it is understood that a word appearing in the singular encompasses its plural counterpart, and that a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of candidates or alternatives is merely illustrative, not limiting, unless implicitly or explicitly understood or stated otherwise.

Unless otherwise defined, all other technical and scientific terms used herein have the meaning commonly understood by one of ordinary skill in the art to which this invention belongs. In case of conflict, the present specification, including definitions, will control. It will be appreciated that there is an implied “about” prior to any quantitative terms mentioned in the present description, such that slight and insubstantial deviations are within the scope of the present teachings. In addition, the use of “comprise”, “comprises”, “comprising”, “contain”, “contains”, “containing”, “include”, “includes”, and “including” are not intended to be limiting. As used herein, “a” or “an” also may refer to “at least one” or “one or more.” Also, the use of “or” is inclusive, such that the phrase “A or B” is true when “A” is true, “B” is true, or both “A” and “B” are true.

As used herein, the term “DC”, when referring to a voltage applied to one or more electrodes of a mass spectrometer component (such as an ion tunnel or ion funnel), does not necessarily imply the imposition of or the existence of an electrical current through those electrodes. The term “DC” is thus used herein to distinguish the referred-to voltage(s) from applied oscillatory voltages that oscillate at radio frequencies and that, themselves, are referred to as “RF” voltages.

As used herein, the term “static”, as applied to a DC electric field (a vector field) or to an RF amplitude, refers to a DC field or an RF amplitude that is maintained essentially unchanging with time during a period of time, possibly with inconsequential variations of not greater than ten percent of an average field strength or an average RF amplitude. The term “uniform”, as applied to a DC field, refers to a DC field that is maintained so as to have a magnitude and a direction that do not substantially vary, other than inconsequential statistical variations, across a span encompassing a series of electrodes; for example, across a series of electrodes spanning a length of an ion optical component from an ion entrance end to an ion exit end. Conversely, the terms “gradient” and “non-uniform”, as applied to a DC field, refer, respectively, to a spatial variation, spanning a series of electrodes, of at least a magnitude of a DC field and to a DC field that is caused to exhibit such a variation. It should be noted that a “static” DC field may either be uniform or may have a gradient. The term “uniform”, as applied to an RF amplitude, refers to an RF amplitude that is maintained so as to not substantially vary across a span encompassing a series of electrodes. Conversely, the terms “gradient” and “non-uniform”, as applied to an RF amplitude, refers to a spatial variation, spanning a series of electrodes, of the applied amplitude.

As used herein, the terms “dynamic” and “ramped”, as applied to either a DC field or an RF amplitude, refer to a DC field or an RF amplitude that is caused to vary with time, in either a monotonically increasing fashion or a monotonically decreasing fashion, over a period of time. The ramping of the magnitude of a DC field that is applied across a series of electrodes requires the ramping of a DC potential that is applied to a subset (i.e., to one or more) of those electrodes. Similarly, the ramping of an RF amplitude of RF waveforms that are applied across a series of electrodes requires the ramping of an RF amplitude that is applied to one or more of those electrodes.

A DC field or RF amplitude that is maintained in a static state over a first time period may, at other times that occur either before or after the time period, be maintained in a dynamic or ramped state and vice versa. Likewise, a DC field or RF amplitude that is maintained in a uniform state over a first time period may, at other times, be maintained in a non-uniform state and vice-versa. As used herein, the terms “urge” and “urges”, when used in relation to the effect, upon an ion or ions, of a direction of an applied force, do not necessarily imply that the ion or ions are caused to move in that direction in response to the force, since the direction of movement of any ion at the time of application of a force depends on its initial momentum vector as well as the vector sum of all such applied forces.

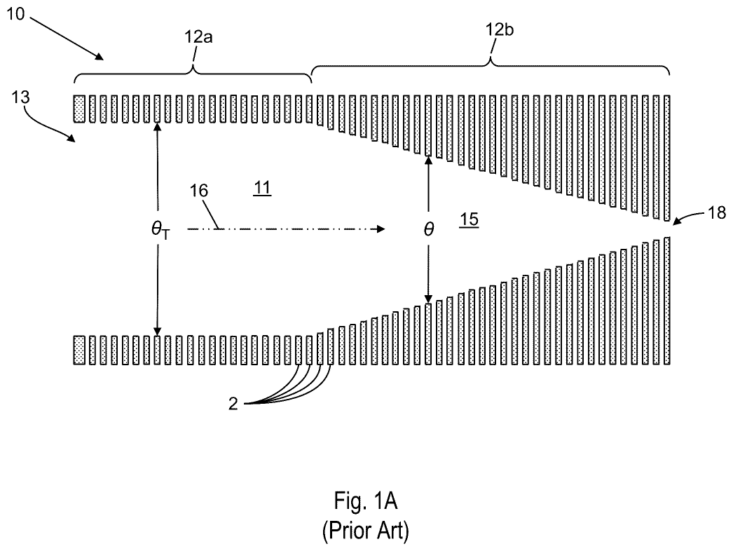

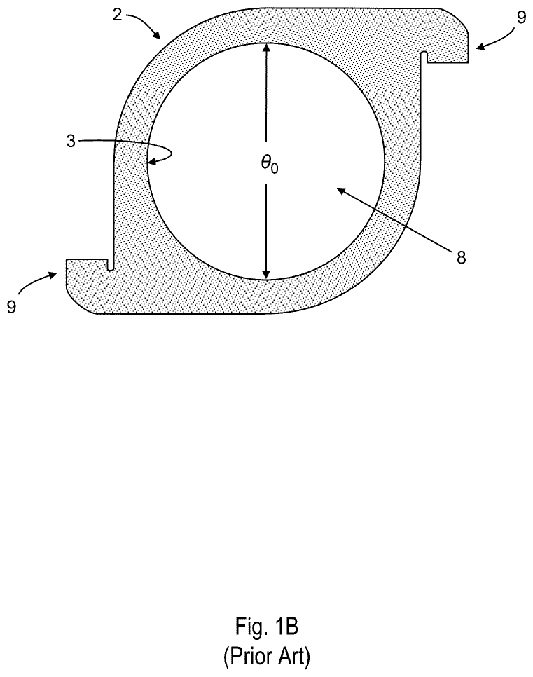

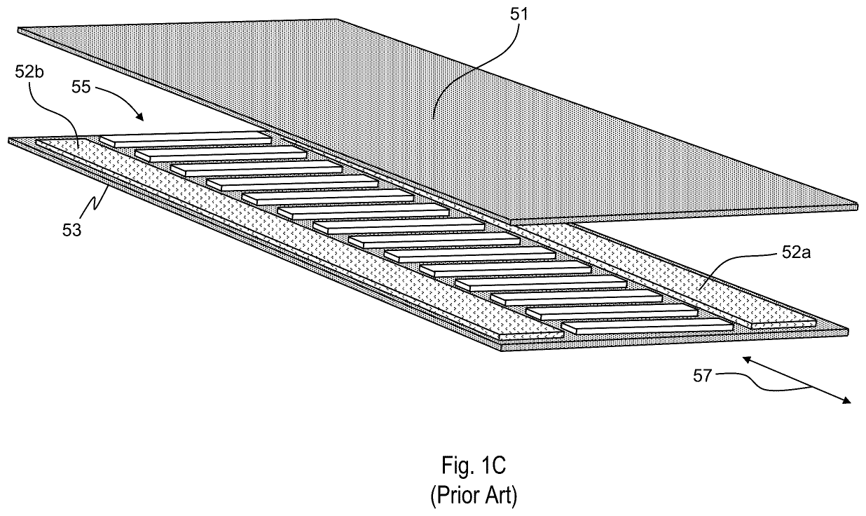

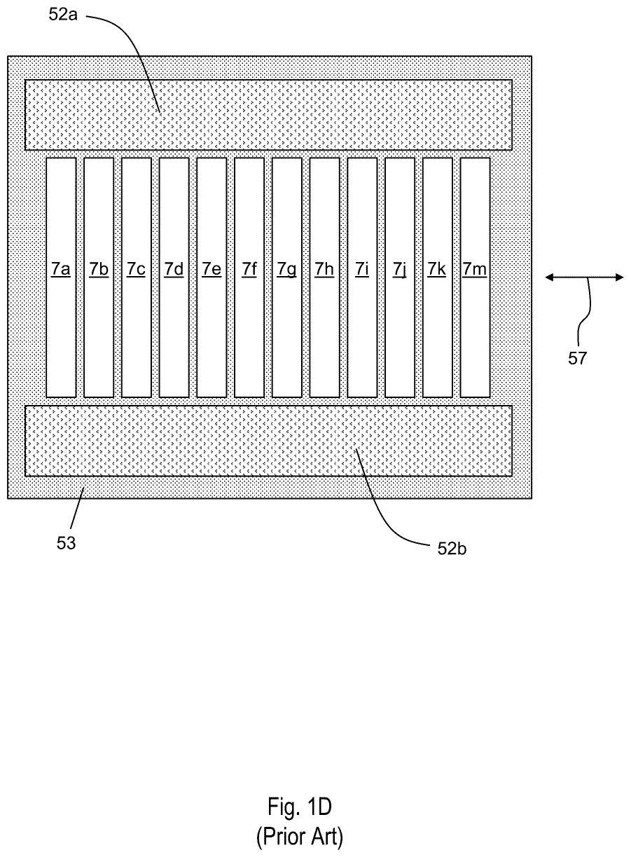

As noted above, so-called “stacked-ring ion guides” are frequently employed in mass spectrometry to either guide or otherwise manipulate ions. In this document, the term “stacked-ring ion guides” is used to refer to ion guides that either: comprise a series or stack of ring or ring-like electrodes; comprise a series or stack of plate or plate-like electrodes; and/or comprise a series or stack of printed circuit boards that have electrode structures printed on the board surfaces. Stacked-ring ion guides are often used as either so-called “ion tunnels” or “ion funnels”. FIG. 1A provides a schematic longitudinal cross-sectional view, of a stacked-ring ion guide apparatus 10 that includes both an ion tunnel section 12a and an ion funnel section 12b. It should be noted, however, that many apparatuses that are referred to in the art simply as “ion funnels” have both an ion tunnel section and an ion funnel section as depicted in FIG. 1A.

Generally described, the stacked-ring ion guide apparatus 10 comprises a plurality of closely spaced ring electrodes or plate electrodes 2. A schematic view of a typical individual ring or plate electrode 2 is provided in FIG. 1B. For purposes of clarity, FIG. 1A depicts only a small number of electrodes 2. It should be kept in mind that, in practice, a typical ion funnel or ion tunnel apparatus may comprise one-hundred or more individual electrodes. Each ring or plate electrode 2 (FIG. 1B) has an aperture 8 that is typically circular in form and that is defined by a ring inner surface 3. Each ring electrode 2 may comprise one or more tabs, such tabs 9, for mounting to a support structure (not shown) and possibly providing electrical connection to one or more power sources (e.g., a voltage source and/or any other type of power supply.

Within an ion tunnel, as exemplified by the ion tunnel section 12a, all apertures of the electrodes of the section have a constant diameter θ_{T}. In contrast, within an ion funnel section 12b, the diameters, θ, of the various apertures generally decrease along a direction away from an ion inlet end 13 and towards an ion outlet end 18 of the device. As used in this document, the term “wide end” is used to designate an end of an ion funnel section at which the variable aperture diameter, θ, is greatest and the term “narrow end” is used to designate the opposite end of the ion funnel section, at which the aperture diameter is smallest. In operation, oscillatory radio-frequency (RF) voltages are applied to the electrodes in a prescribed phase relationship to radially confine the ions to the interior of the device. According to the generally-prescribed conventional phase relationship, the phase of the RF voltage waveform of each electrode of the stack is π radians (180 degrees) out of phase with the phase of each immediately adjacent electrode. The collection of all of the apertures of all of the electrodes 2 define an ion occupation volume 11, within which ions generally travel from the ion inlet end 13 to the ion outlet end 18 of the apparatus 10, as indicated by the arrow on longitudinal axis 16. In general operation, pseudopotential wells centered about the axis 16 and generated by the applied RF configuration serve to confine ions within the ion occupation volume 11. The relatively large electrode apertures of the ion inlet end 13 and the ion tunnel portion 12a of the apparatus are generally employed for the purpose of capturing a dispersed or diffuse cloud of ions. In contrast, the decrease, towards the ion outlet 18, of electrode apertures of the ion funnel portion 12b causes the ion cloud to be squeezed into a narrow beam that can be passed into a high-vacuum chamber through a narrow aperture. Migration of ions in the direction from the ion inlet end towards the ion outlet may be facilitated by a flow of gas within which the ions are entrained. Also, the ions may be urged in the same direction by provision of a DC axial field that is generated by differentially providing DC voltages to the electrodes 2.

FIG. 1C is a schematic depiction of another known type of ion manipulation and ion guiding device 50, as taught in the previously mentioned U.S. Pat. No. 10,692,710. As described in that patent, the device 50 comprises two parallel substrate plates or wafers 51 and 53 that are spaced apart from one another, each plate or wafer having a surface upon which a plurality of electrodes is disposed. For example, the plates or wafers 51 and 53 may be the substrates of printed circuit boards. The electrode bearing surfaces may face one another across a gap between the two substrate plates or wafers as shown. A central axis 57 is defined through the device 50. Each of the electrode-bearing surfaces has an array 55 of inner electrodes and also has outer guard electrodes 52a, 52b. The outer guard electrodes 52a, 52b are positioned on either side of the array 55 of inner electrodes. The array 55 of inner electrodes and the outer electrodes 52a, 52b extend substantially along a length of the electrode-bearing surfaces of the substrate plates or wafers 51, 53. In operation, ions can be confined within the gap between the electrode-bearing surfaces and guided parallel to the central axis 57 as taught in U.S. Pat. No. 10,692,710.

FIG. 1D schematically shows a portion of an electrode-bearing surface of an individual substrate plate or wafer 53 of the known ion manipulation and ion guiding device 50. In the illustrated example of FIG. 1D, each of the outer guard electrodes 52a, 52b comprises a single elongated electrode that is elongated parallel to the central axis 57. The array 55 of electrodes comprises a series of individual electrodes 7a, 7b, 7c, . . . , 7m. Although twelve such individual electrodes are shown, the array 55 can comprise any number of electrodes. A voltage source (not shown) can apply a voltage to each electrode 7a-7m, individually. As noted above in the Background section of this document, U.S. Pat. No. 10,692,710 further teaches, using the ion manipulation device 50 as an example, that the various electrodes of the inner-electrode array 55 may be logically grouped into consecutive subsets of electrodes (e.g., sets comprising three or more electrodes each). The patent further teaches that, by providing a differently modulated RF waveform to each electrode of each subset, a travelling wave may be generated that tends to urge ions parallel to the central axis 57 through the apparatus 50.

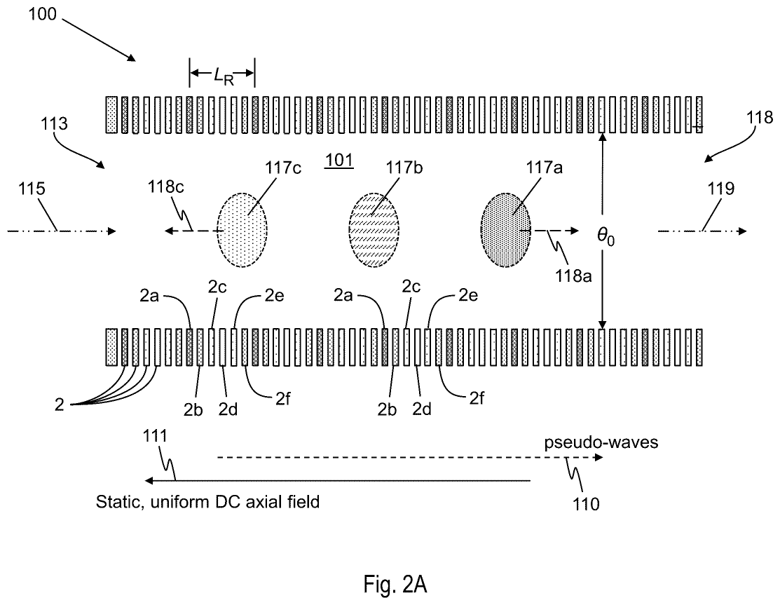

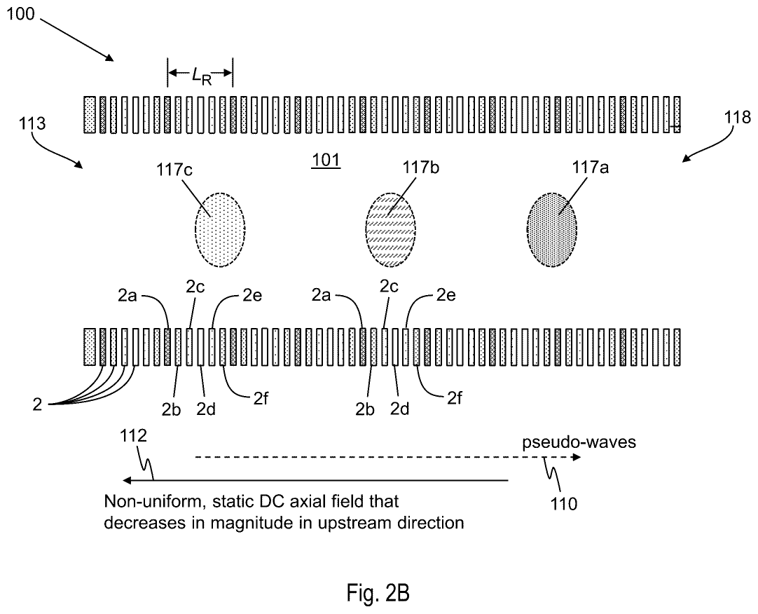

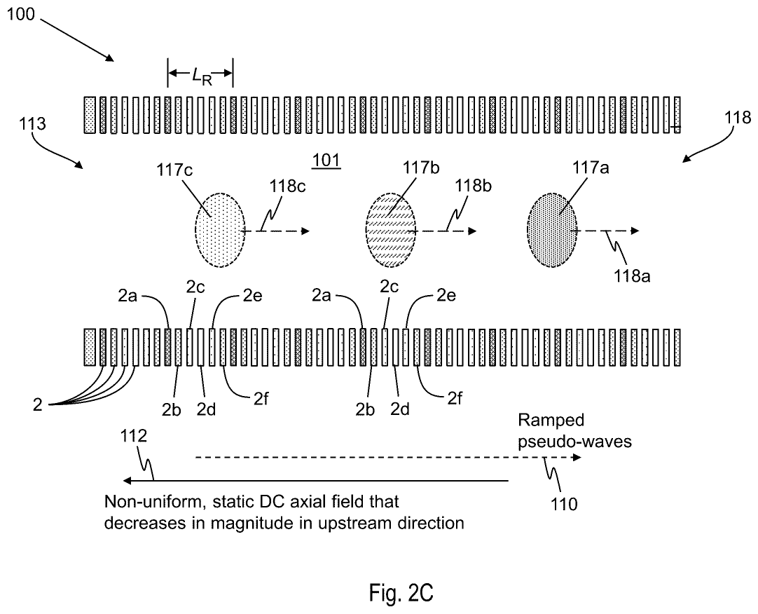

FIG. 2A is a schematic cross-sectional depiction of a first embodiment of an ion tunnel stacked-ring ion guide 100 in accordance with the present teachings. Although the stacked ring ion guide 100 is depicted as comprising only an ion tunnel portion, it may alternatively comprise a combination of any number of ion funnel and ion tunnel portions. In general operation of the apparatus 100, a stream of ions 115 comprising an unseparated mixture of ion species is delivered to an ion occupation volume 101 of the apparatus through an ion inlet 113. By means of the operation of the apparatus 100, the original mixture of ion species may be separated into a plurality of packets—for example, the ion packets 117a, 117b and 117c as shown—each of which comprises a different subset of the original set of ion species. These partially-separated packets of ions may then be caused to exit the apparatus as a stream 119 of ion packets through ion outlet 118.

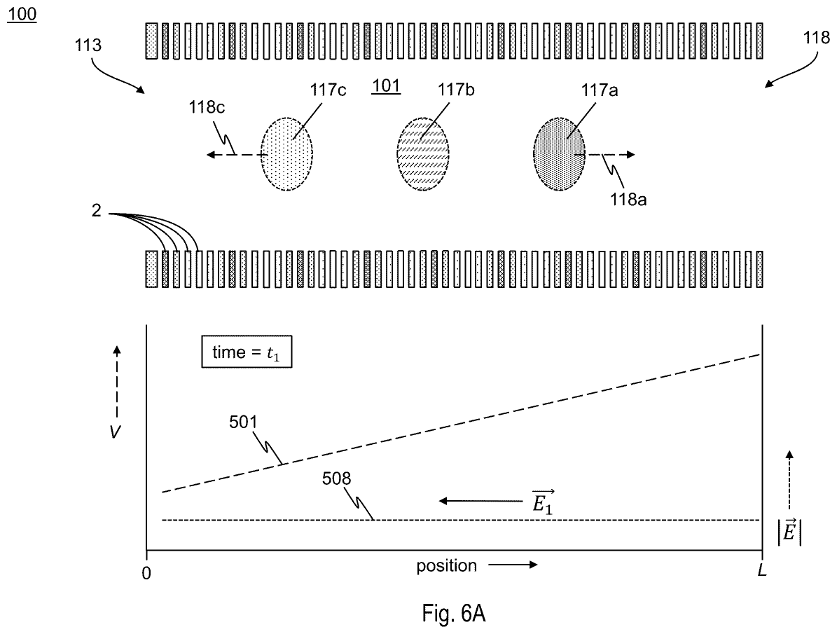

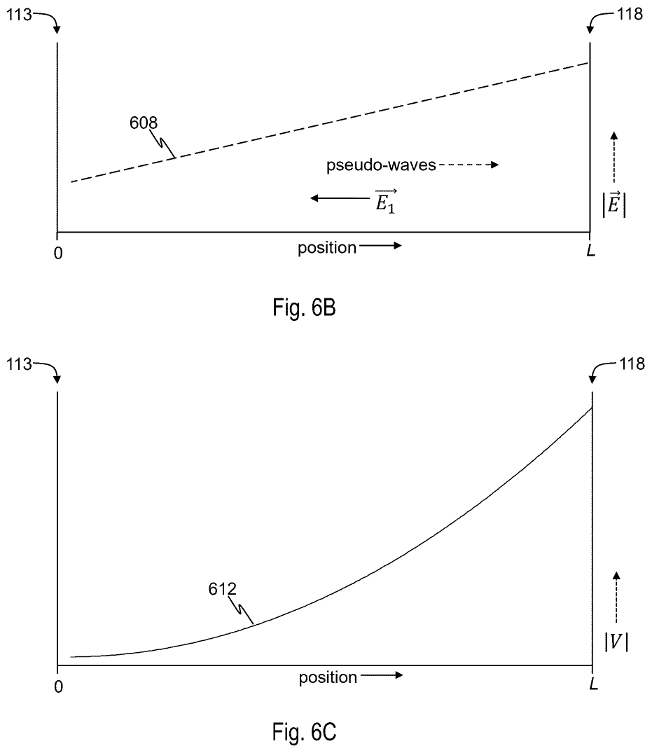

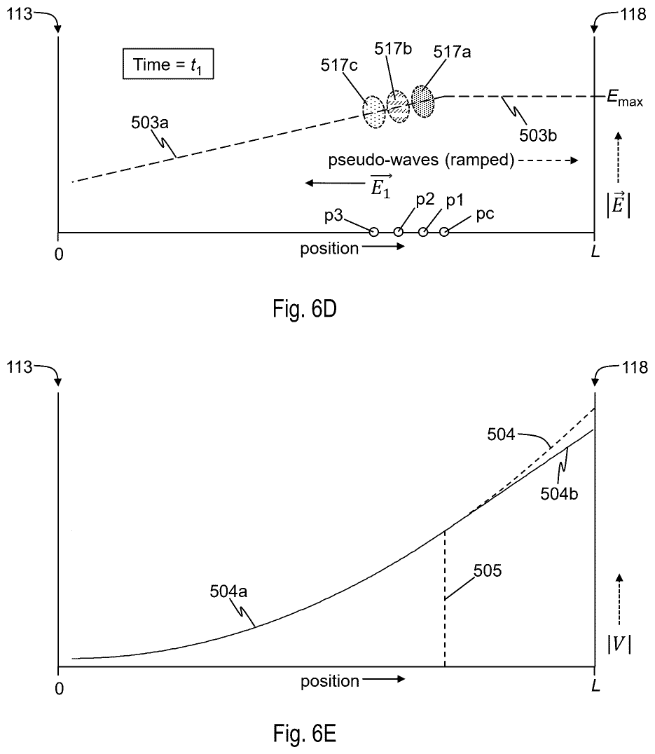

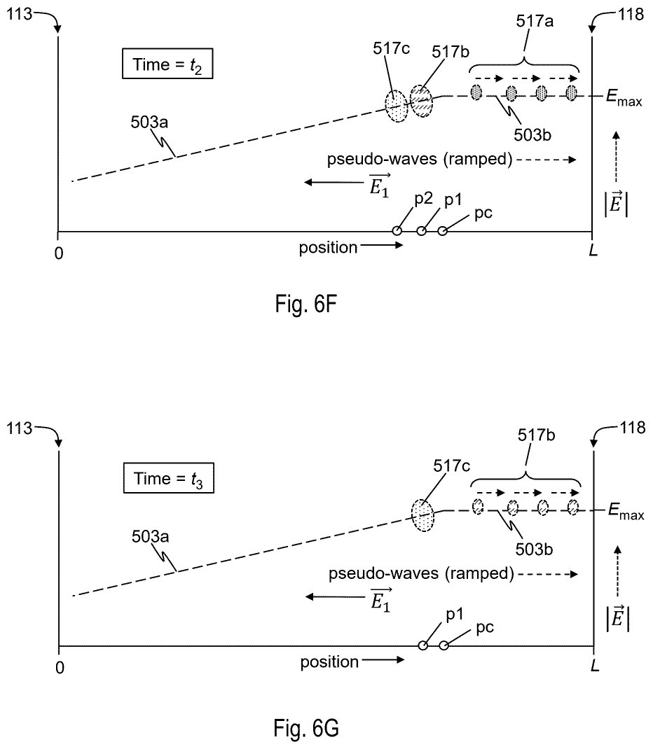

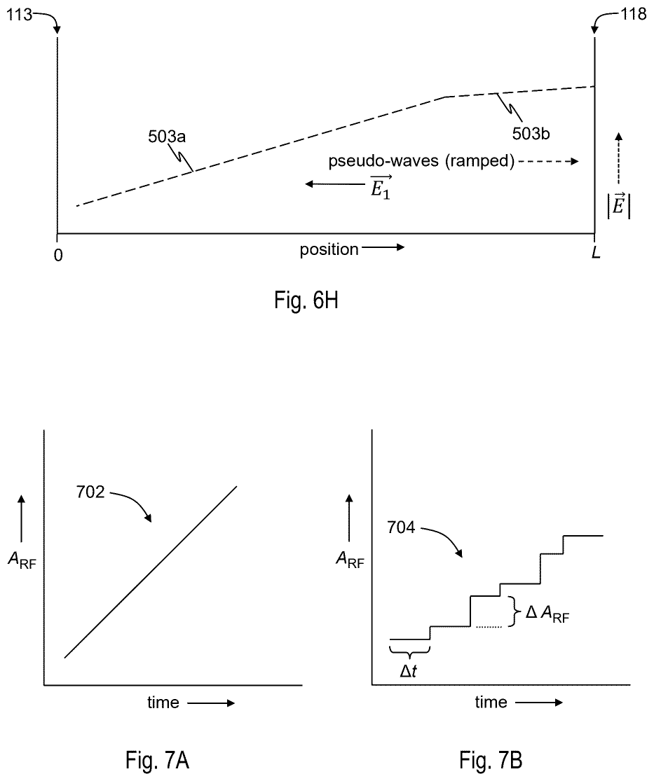

The physical configuration of electrodes 2 of the apparatus 100 (FIG. 2A) is similar to the physical configuration of the electrodes of the ion tunnel portion 12a of the stacked ring ion guide 10, with each electrode having an aperture of diameter θ₀ and the collection of apertures defining the ion occupation volume 101. Despite this similarity, the apparatus 100 differs from the apparatus 10 (FIG. 1A) in that:
(a) the electrodes are logically grouped into a stacked sequence of subsets of electrodes, with each of the subsets comprising (in this example) exactly four electrodes;
(b) RF voltage waveforms applied to the electrodes vary within each subset of electrodes and with time in a fashion that generates a plurality of pseudopotential wells within which ions tend to be concentrated, whereby the pseudopotential wells are caused to migrate in a desired direction parallel to the axis of the apparatus, the set of migrating pseudopotential wells being referred to herein as an RF travelling wave or, equivalently, a “pseudo-wave”; and
(c) an axial DC electric field is provided within the ion occupation volume that tends to urge ions in a direction opposite to the migration direction of the pseudopotential wells. FIG. 6A is a reproduction of the schematic cross-sectional depiction of the apparatus of FIG. 2A and of the ion packets therein, further showing a schematic example of how DC voltages, V, may be apportioned among stacked electrodes to generate the static, uniform DC axial field. The axial electric field vector, \vec{E₁}, in the vicinity of the axis of the apparatus is related to the gradient of the applied voltages (voltages shown as plot 501 in FIG. 6A). In the example, the gradient of V is essentially constant across the length of the ion tunnel apparatus 100. This is reflected in the fact that the magnitude, |\vec{E₁}|, of the electric field (shown as plot 508 in FIG. 6A) in the vicinity of the axis is constant.

Specifically, with regard to the logical grouping of the electrodes into subsets, FIG. 2A depicts two such groups (i.e., subsets), each group comprising a first electrode 2a, a second electrode 2b, a third electrode 2c and a fourth electrode 2d. Although only two such groups are labeled in FIG. 2A, it is to be understood that, in the illustrated embodiment, the grouping into subsets of four electrodes each pertains to all electrodes 2 of the apparatus, extending from the ion inlet 113 to the ion outlet 118. According to some alternative embodiments, some portion of the electrodes may not be so organized into groups. Although four electrodes per subset are illustrated, the number of electrodes per subset, Nₑ, is not necessarily limited to four per subset. More generally, Nₑ≥3. A repeat distance, L_{R}, along the axis of the apparatus 100 (parallel to the arrows 115 and 119) is defined as the distance between successive electrodes 2a (or successive electrodes 2b, etc.).

Within each subset of electrodes of the apparatus 100, the four electrodes of the subset differ in that, in operation, each electrode is provided with a respective different RF voltage waveform, as discussed further below. All electrodes 2a are provided with a first RF voltage waveform that is, in embodiments, identical among all electrodes 2a. Likewise, all electrodes 2b are provided with a second RF voltage waveform that is, in embodiments, identical among all electrodes 2b. Likewise, a third voltage waveform is applied to all electrodes 2c and a fourth voltage waveform is applied to all electrodes 2d. Generally described, the Nₑ voltage waveforms are chosen such that a set of migrating pseudopotential wells are generated along the axis of the apparatus (coincident with arrows 115 and 119), thereby forming a set of “travelling waves” that tend to urge ions along the axis. According to the example shown in FIG. 2A, the voltage waveforms are configured such that the travelling waves urge ions parallel to lines 115, 119 in a direction from the ion inlet 113 towards the ion outlet 118. However, according to some other embodiments as discussed further herein below, the voltage waveforms may be configured so as to urge ions in the opposite direction.

According to some embodiments of the present teachings, the RF voltage waveforms applied to the electrodes of the apparatus 100 may be selected as described in U.S. Pat. No. 9,799,503. That patent provides an example of a subset of four electrodes of a stacked-ring ion guide, wherein respective RF voltage waveforms are provided to the four electrodes such that a plurality of migrating pseudopotential wells create travelling waves within an ion guide. According to the aforementioned U.S. Pat. No. 9,799,503, the four RF voltage waveforms may be provided in accordance with the following first through fourth drive signals:

$${V}_{A} = {V}_{1} F ( {ω}_{m} t - {Φ}_{1} ) {e}^{j ω t} First RF drive signal \qquad Eq . 1 a$$

$${V}_{B} = {V}_{2} F ( {ω}_{m} t - {Φ}_{2} ) {e}^{j ω t} Second RF drive signal \qquad Eq . 1 b$$

$${V}_{C} = {V}_{3} F ( {ω}_{m} t - {Φ}_{3} ) {e}^{j ω t} Third RF drive signal \qquad Eq . 1 c$$

$${V}_{D} = {V}_{4} F ( {ω}_{m} t - {Φ}_{4} ) {e}^{j ω t} Fourth RF drive signal \qquad Eq . 1 d$$

where t is time, V₁ through V₄ are zero-to-peak amplitudes, j is the imaginary unit, the function F is a complex function of its argument and is periodic with period 2π, and where scalar value Φ₁ is a first phase, scalar value Φ₂ is a second phase that is shifted by 90 degrees (π/2 radians) relative to the first phase, scalar value Φ₃ is a third phase that is shifted by 180 degrees (π radians) relative to the first phase, scalar value Φ₄ is a third phase that is shifted by 270 degrees (3π/2 radians) relative to the first phase, and scalar values ω and ωₘ may be angular frequencies in radians per second, with ω>ωₘ. It is understood that the applied voltage is described by the real part of any resulting complex expression. The same patent also provides a specific example of the implementation of the expressions in Eqs. 1a-1d in which the applied voltages are as follows:

$${V}_{A} = {V}_{0} cos ( {ω}_{m} t ) cos ( ω t ) First RF drive signal \qquad Eq . 2 a$$

$${V}_{B} = {V}_{0} cos ( {ω}_{m} t - π / 2 ) cos ( ω t ) Second RF drive signal \qquad Eq . 2 b$$

$${V}_{C} = {V}_{0} cos ( {ω}_{m} t - π ) cos ( ωt ) Third RF drive signal \qquad Eq . 2 c$$

$${V}_{D} = {V}_{0} cos ( {ω}_{m} t - 3 π / 2 ) cos ( ω t ) Fourth RF drive signal {f}_{C} \qquad Eq . 2 d$$

As noted above, the number of electrodes per subset is not limited to four electrodes per subset and may comprise any integer number, Nₑ, where Nₑ≥3. In such instances, the various electrodes, R, of each subset and the various voltage waveforms, V(t), provided to the electrodes each subset may be enumerated, in order beginning with the electrode closest to the entrance inlet, by the index variable, i, as

$${R}_{1} , {R}_{2} , … , {R}_{i} , … , {R}_{{N}_{e}} ( 3 \leq i \leq {N}_{e} ) and$$

$${V}_{1} ( t ) , {V}_{2} ( t ) , … , {V}_{i} ( t ) , … , {V}_{{N}_{r}} ( t ) ( 3 \leq i \leq {N}_{e} )$$

Then, each and every electrode denoted as R₁ will be provided with the same, identical waveform, V₁(t). Likewise, each and every electrode denoted as R₂ will be provided with the same, identical waveform, V₂(t), etc. According to some embodiments, the phase shifts, ΔΦ, between any two successive electrodes of a subset are constant across the subset and are given by

$$Δ Φ = 2 π / {N}_{e} \qquad Eq . 3$$

However, in accordance with some other embodiments, the phase shifts are not necessarily uniform across each subset.

In accordance with some other embodiments of the present teachings, the RF voltage waveforms provided to the electrodes of the apparatus 100 may be selected as described in U.S. Pat. No. 10,692,710, which describes creation of travelling waves by the provision of frequency-modulated waveforms that are driven by frequency-modulated signals, S_{FM}, represented by

$${S}_{FM} = {V}_{c} cos ( 2 π {f}_{c} + β {S}_{M S} )$$

where f_{C} is the “carrier frequency” (i.e., the frequency of the unmodulated conventional RF voltage waveform), V_{C} is the voltage amplitude of the RF waveform, β is a frequency modulation index and S_{MS} is a frequency-modulating periodic waveform of frequency, f_{M}, which is a lower frequency than f_{C}. This latter patent provides a specific example in which the electrodes of a stacked-ring ion guide are organized into subsets of eight electrodes each and the phase of the frequency-modulating periodic waveform, S_{MS}, changes by 2π/8 radians (45 degrees) between each pair of electrodes.

With reference, once again, to FIG. 2A, arrow 110 represents the migration direction of RF-generated pseudopotential wells (i.e., travelling waves) that may be generated as described above. As indicated by arrow 110, the application of RF waveforms may be configured so that the travelling waves exert forces on ions that tends to urge the ions in the “forward” direction, which is generally from the ion inlet 113 towards the ion outlet 118. However, in alternative embodiments, the direction of the pseudopotential well migration may be reversed, relative to the migration direction indicated in FIG. 2A, by reversing the phase relationships of applied drive waveforms within each subset of electrodes. FIG. 2A also shows that, in accordance with the present teachings, a static, uniform DC axial field is also generated that exerts a force on the ions that tends to oppose the force that is exerted by the pseudopotential well migration. A schematic example of the magnitude of a static uniform DC axial field is provided by plot 508 of FIG. 6A. Accordingly, the arrow 111 indicates the direction in which the same ions are urged to migrate by the applied static, uniform DC axial field. Thus, according to the operation shown in FIG. 2A, the DC axial field is applied so as to tend to urge ions in a “reverse” direction, from the ion outlet 118 towards the ion inlet 113. It should be noted, however, that if the direction of the pseudopotential well migration is reversed from the direction shown in FIG. 2A, such that the travelling waves instead tend to urge the ions towards the ion inlet 113, then the direction of the DC axial field is also reversed relative to the direction shown in FIG. 2A, such that the so-reversed DC axial field urges ions towards the ion outlet 118.

The DC axial field that is created within the ion occupation volume 101 may be generated, in known fashion, by dividing an end-to-end voltage difference across the length of the apparatus through the inclusion of a series of resistors between the electrical connections to the various electrodes 2. Alternatively, the DC axial field may be generated by any one of a number of other known methods.

The opposed pseudopotential and DC axial field forces that are applied as shown in FIG. 2A create three different ion behavior conditions, as follows: (1) firstly, in the case of ions having the smallest m/z values (e.g., the ions of ion packet 117a), for which the force attributable to the RF travelling wave dominates over the DC-field force, the movement will be in the direction of the travelling wave, as indicated by motion vector 118a; (2) in the case of ions having the greatest m/z values (e.g., the ions of ion packet 117c), for which the DC axial field dominates, the movement will be opposite to the direction of the travelling wave, as indicated by motion vector 118c; and (3), finally, for ions having a particular critical m/z value that depends on the applied voltages (e.g., the ions of ion packet 117b), RF-derived and DC-gradient-derived forces will balance and such ions will not move in either direction. Thus, the apparatus 100, when operated as indicated in FIG. 2A, performs simultaneously as: (a) a mass filter that permits only ions having relatively low-m/z values (i.e., less than the critical value) to be transmitted along outlet stream 119 to a downstream apparatus (such as a quadrupole mass filter and/or a collision cell and/or a mass analyzer); (b) a single-mass-to-charge ion trap or ion accumulator for ions having the critical m/z value; and (c) a filter that eliminates all ions having m/z values that are greater than the critical value.

FIG. 2B is another schematic cross-sectional depiction of the ion tunnel stacked-ring ion guide 100, as introduced in FIG. 2A, but configured and operated in an alternative mode that causes differential migration of ions through the ion guide as well as spatially separated trapping of ion species in accordance with their respective mass-to-charge (m/z) ratios. According to the mode of operation indicated in FIG. 2B, the applied static DC axial field that opposes the pseudopotential-derived travelling waves is not uniform but, instead, decreases in magnitude in a general direction from the ion outlet 118 towards the ion inlet 113. Specifically, as indicated by arrow 112, the DC axial field continues to generate forces that tend to urge ions in an “upstream” direction, opposite to the “downstream” direction (as indicated by arrow 110) in which the ions are urged by the travelling waves. However, the magnitude of the DC axial field vector is non uniform and decreases in the upstream direction. Under such operation, various ion species within a range of m/z values will be trapped within the ion occupation volume, as each such ion species migrates to and accumulates at an axial position at which the upstream-directed DC axial field exactly balances the downstream-directed pseudopotential-derived force that is exerted on ions of the species' mass-to-charge value. For example, in FIG. 2B, schematic axial equilibrium positions are indicated for a first packet of ions 117a having mass-to-charge ratio (m/z)_{L}, a second packet of ions 117b having mass-to-charge ratio (m/z)_{M}, and a third packet of ions 117c having mass-to-charge ratio, (m/z)_{H}, where (m/z)_{H}>(m/Z)_{M}>(m/z)_{L}. Although the equilibrium positions of only three packets of ions having specific m/z values are illustrated in FIG. 2B, there will generally exist, in practice, a virtually continuous range of equilibrium positions for ions having m/z values within a certain m/z range, with the equilibrium m/z values decreasing in the general direction towards the ion outlet 118. Additionally, certain ion species having small m/z values that are outside of the range may migrate towards the ion outlet and certain other ion species having large m/z values that are outside of the range may migrate towards the ion inlet. Accordingly, in the mode of operation that is schematically illustrated in FIG. 2B, the apparatus 100 functions as a multiple-mass-to charge ion-sorting ion trap.

In order to extract the ions that are trapped at various equilibrium positions, as shown in FIG. 2B, the amplitude of the main RF voltage, either phase-shifted and/or frequency-modulated as described above, may be ramped upward (i.e., progressively increased) with time so that the equilibrium positions corresponding to all m/z values migrate, over the course of the RF voltage amplitude ramping, towards the ion outlet, as indicated by the displacement vectors 118a, 118b and 118c in FIG. 2C. Additionally or alternatively, the magnitude of the opposing DC field may be ramped downward (i.e., progressively decreased). In this instance, trapped ions having the smallest m/z values (e.g., the ions of packet 117a) will be the first to pass out of the ion outlet and ions having the greatest m/z values (e.g., the ions of packet 117c) will exit last.

It should be noted that, in alternative embodiments, the migration direction of the travelling waves and the direction of the opposing DC field may be reversed from the directions shown in FIGS. 2A-2C. In such alternative embodiments, the ion species having the greatest m/z values will be the first to be outlet from the apparatus, provided that the “direction” of ramping (i.e., either ramping “up” or ramping “down”) of the RF amplitude (of travelling waves that urge ions towards the ion inlet 113) and the “direction” of ramping of the magnitude of the DC field (that urge ions towards the ion outlet 118) are also reversed. It should be further noted that, although many of the elementary examples discussed herein refer to ramping of either the RF amplitude or the DC field, more generally the RF amplitude and DC field may be ramped simultaneously, whereby, during the simultaneous ramping, the RF amplitude and the magnitude of the DC field either both increase or both decrease. In other instances, the simultaneous ramping may comprise an increase of the RF amplitude and a simultaneous decrease in the magnitude of the DC field. In still other instances, the simultaneous ramping may comprise a decrease in the RF amplitude and a simultaneous increase in the magnitude of the DC field.

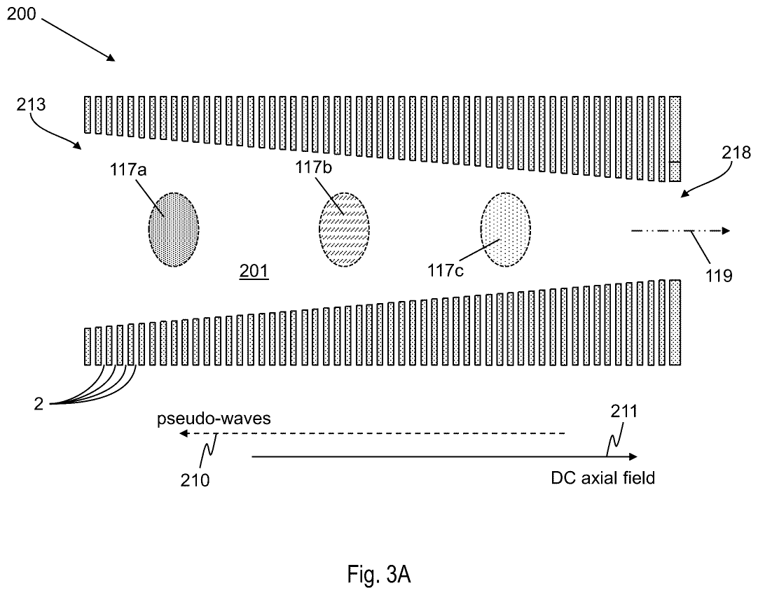

As described above, a stacked ring ion guide that is in the form of an ion tunnel may be made to function as either (a) a single-mass-to-charge ion trap or ion accumulator (as described with reference to FIG. 2A) by providing a uniform DC axial field in opposition to a travelling wave that is uniformly applied across the length of the apparatus or (b) a multiple-mass-to charge ion-sorting ion trap when there is a longitudinal spatial gradient in either the provided opposing DC field and/or the migrational motive force of the pseudo-wave. For an ion tunnel apparatus, the act of creating a “longitudinal spatial gradient in the migrational motive force of the pseudo-wave” requires providing different RF waveforms (e.g., different RF amplitudes) to the electrodes of the apparatus at various different positions between the ion inlet and the ion outlet. In such instances, the required electronics may be complex, expensive and/or difficult to design or fabricate. However, in the case of an ion funnel ion guide apparatus, such as the ion funnel apparatus 200 depicted in FIG. 3A, a gradient in the depth of pseudopotential wells—and, thereby, a gradient in the migrational motive force—is created by the geometry of the device. Specifically, within the ion funnel apparatus 200, the depths of the various pseudopotential wells increase in the direction of convergence of the ion funnel (e.g., see FIG. 1 of U.S. Pat. No. 9,799,503) essentially by virtue of the increasing proximity of electrode edges to the ion beam (centered near the device axis) in the same direction. Accordingly, with the direction of the RF-generated travelling waves directed (arrow 210) so as to urge ions towards the ion inlet 213 and the DC field directed (arrow 211) to urge ions towards the ion outlet 218, the apparatus 200 may be operated as a multiple-mass-to charge ion-sorting ion trap without the application of any field gradients. Using the configuration shown in FIG. 3A, relatively “light” (small m/z) ions may be trapped within region 117a proximal to the ion inlet 213 while, simultaneously, relatively “heavy” (large m/z) ions are trapped within region 117c which is proximal to the ion outlet 218. As noted previously, intermediate-m/z ions are trapped within region 117b. The trapped ions may be released, in reverse order of their m/z ratios by either ramping up (i.e., to greater values) the magnitude of the DC field and/or ramping down (i.e., to lesser values) the applied RF amplitudes.

FIG. 3B is a modified version, in accordance with the present teachings, of the ion manipulation and ion guiding device of FIG. 1C. The ion manipulation and ion guiding device 250 that is depicted in FIG. 3B is modified, relative to the device 50 (FIG. 1C), in a fashion that enables it to be operated similarly to the operation, as discussed above, of the ion funnel 200 (FIG. 3A). In contrast to the device 50, in which parallel plates or wafers 51 and 53 are configured to support the arrays 55 of inner electrodes as well as the sets of outer guard electrodes 52a, 52b, the modified device 250 is configured such that the plates or wafers 251 and 253 converge towards one another along a direction away from an ion inlet 313 and towards an ion outlet 318. For example, as shown in FIG. 3B, the plates/wafers 251 and 253 are separated from one another at the ion inlet 313 by a first separation distance, s₁, and are separated from one another at the ion outlet 318 by a second separation distance, s₂, where s₁>s₂ and wherein there is a continuous convergence of the plates/wafers 251, 253 between the ion inlet 313 and the ion outlet 318.

In some examples, an RF travelling wave may be created along the axis 57 of the device 50 by the manipulation of main RF axial-confinement waveform(s) that are applied to the series of individual electrodes 7a, 7b, 7c, . . . of the mutually-facing electrode arrays 55 (see FIG. 1D). Additionally, a DC field that opposes the ion motion that is urged by the RF travelling waves may also be generated within either the device 50 (FIG. 1C) or the modified device 250 (FIG. 3B). For example, a static uniform DC field may be generated within either the device 50 or the modified device 250 by apportioning, among the plurality of inner electrodes of each plate/wafer 251, 253, a DC potential difference that is imposed between the ion inlet 313 and the ion outlet 318. The apportionment of the voltage difference may be achieved, in known fashion, by a voltage divider system. Additionally or alternatively, an axial DC field may be generated or an otherwise-generated axial field may be supplemented by providing the guard electrodes 52a, 52b of each plate/wafer as composed of an electrically resistive material (as opposed to an electrically conductive material, such as a metal). For example, resistive guard electrodes 52a, 52b may be formed of any one of a number of suitable materials (e.g., without limitation, doped glasses, cermets, polymers, etc.) having electrically resistive properties.

Because, within the device 250, the electrodes of the two electrode arrays 55 (one electrode array supported on each of the plates/wafers 251, 253) progressively approach one another along a direction from the ion inlet 313 towards the ion outlet 318, there thus exists a gradient in the depth of pseudopotential wells, with the well depth increasing in the same direction. The increasing well depth creates a gradient in the migrational motive force that is provided by the RF-generated travelling waves. Accordingly, if the RF-generated travelling waves are configured to urge ions that are within the device 250 away from the ion outlet 318 and towards the ion inlet 313 and if the urging of the travelling waves is opposed by a static, uniform DC field that urges the ions towards the ion outlet 318, then different ion species having different respective m/z values will establish different respective equilibrium positions within the device. In this situation, the distribution of equilibrium positions will be similar to the depiction in FIG. 3A, wherein ions 117a having lesser mass-to-charge ratios are closer to the ion inlet than ions 117b, 117c having greater mass-to-charge ratios and wherein ions 117c having the greatest mass-to-charge ratios are closest to the ion outlet. The trapped ions may then be released from the device 250, in reverse order of their m/z ratios by either ramping up (i.e., to greater values) the magnitude of the DC field and/or ramping down (i.e., to lesser values) the applied RF amplitudes.

The following discussion relates to FIGS. 6A-6H, which are various schematic graphs of voltages and DC electric fields within an ion guide that is operated in accordance with the present teachings. With regard to each of these figures, it is assumed that an ion inlet 113, at position 0, corresponds to the left-hand side of the respective graph and that an ion outlet 118, at position L, corresponds to the right-hand side of the plot. It is also assumed that a set of pseudo-waves are applied to electrodes of the respective ion guide so as to urge ions away from the ion inlet and towards the ion outlet. It is to be noted that that absolute magnitude of applied DC voltage is plotted in each of FIGS. 6C and 6E. If positively charged ions are introduced into an ion guide or ion separator apparatus that is operated as described herein, then the general movement of ions within the apparatus will be as described if the applied DC voltage profiles are of the general form as the profiles shown in FIGS. 6C and 6E. However, if negatively charged ions are introduced into the apparatus, then the general movement of ions within the apparatus will be as described if the applied DC voltage profiles have the general form of mirror images (i.e., as reflected across the horizontal axis) of the profiles shown in FIGS. 6C and 6E.

As noted above, a uniform DC field may be applied in opposition to the motion of a set of travelling RF potential wells (i.e., a set of pseudo-waves) in order to isolate ions comprising a particular m/z range within an ion guide (e.g., see FIG. 2A). For example, plot 508 of FIG. 6A depicts a uniform axial DC field as may be created by applying a series of DC voltages to the various individual electrodes of the ion guide wherein the applied voltages linearly increase from an ion inlet towards an ion outlet (i.e., plot 501 of FIG. 6A). As also noted above, a non-uniform axial DC field may be applied in opposition to the motion of the pseudo-waves to cause the ion guide to emit ions from its ion outlet in either increasing or decreasing order of the m/z values (e.g., see FIG. 2C.

FIG. 6B schematically illustrates the variation of the absolute magnitude, |\vec{E₁}|, of an applied non-uniform axial electric field, \vec{E₁}, that urges ions towards an ion inlet 113 in which the absolute magnitude, |\vec{E₁}|, increases towards an ion outlet 118 that is located at position L. As shown schematically in FIG. 6C, the non-uniform axial field may be generated by applying a series of voltages to the various electrodes of the ion guide wherein the magnitude, |V|, of the applied voltages increases in accordance with a quadratic function from the ion inlet to the ion outlet, as shown by plot 612 of FIG. 6C. Although the magnitude of the field is shown as increasing linearly in FIG. 6B and the corresponding voltage profile in FIG. 6C is described as a quadratic function, the electric field magnitude may be non-linear and the voltage profile may not necessarily conform to a quadratic function.

With regard to the utilization of an ion guide as an ion separation and sorting device (e.g., FIG. 2C) from which ions are emitted in the order of their m/z values in accordance with the present teachings, the mass spectral resolution, R, of the device may be tailored by utilizing a non-uniform electric field profile as is schematically depicted in FIG. 6D, which may be generated by applying DC voltages to electrodes in accordance with the voltage profile that is shown by segments 504a and 504b in FIG. 6E. Specifically, good mass spectral resolution may be achieved be employing an electric field profile (dashed lines in FIG. 6D) comprising a first segment 503a and a second segment 503b, wherein a magnitude, |\vec{E₁}|, of the DC axial field that opposes the ion motion caused by the pseudo-waves increases to a maximum value, Eₘₐₓ, within the first segment 503a and remains constant at Eₘₐₓ within the second segment 503b. The corresponding profile of DC voltages that are applied to the electrodes (solid lines in FIG. 6E) comprises a quadratic section 504a and a linear section 504b (for comparison, dashed line 504 represents the extension of the purely quadratic profile). The position of the junction between segments 503a and 503b in FIG. 6D is denoted by point pc along the axial length of the apparatus and corresponds to the demarcation, denoted by line 505 in FIG. 6E between the quadratic and linear segments of the voltage profile.

Ions are introduced, via ion inlet 113, into an ion guide apparatus that is capable of being configured with travelling RF voltages and static DC voltages as shown in FIGS. 6D and 6E. The position of the ion inlet 113 is indicated as position 0 in FIGS. 6D and 6E. Radio Frequency (RF) voltage waveforms are applied to the electrodes of the apparatus to create a set of RF travelling waves that create pseudopotential wells that urge ions through the apparatus from the ion inlet 113 to an outlet 118, which is located at position L. At the same time, DC voltages are applied to the electrodes that create an axial field that has the general form indicated by the dashed lines 503a, 503b in FIG. 6D and that urges ions towards the ion inlet 113. After introduction of the ions, the amplitude(s), A_{RF}, of the applied RF voltages is/are ramped (i.e., increased) with time. Under such conditions, as described previously herein, packets of ions having different respective m/z values separate from one another and migrate through the apparatus towards the ion outlet 118 at different rates. FIG. 6D schematically depicts the positions, within the apparatus, of three packets of ions 517a, 517b, 517c having mass-to-charge ratios (m/z)_{L}, (m/z)_{M}, and (m/z)_{H}, respectively, where (m/z)_{H}>(m/z)_{M}>(m/z)_{L} at a particular time, t₁, during the ramping before any of the ions reach the plateau region 503b of the DC field profile. The instantaneous position, at any particular time, of any such packet of ions represents the axial location, within the apparatus, at which the instantaneous forward-directed urging of the ions of the packet by the pseudo-waves, as generated by the ramped RF amplitudes at the particular time, slightly overcomes the backward-directed urging of the ions by the static electric field along field segment 503a. As discussed previously, these opposed forces cause the ions having the smallest m/z values (e.g., ions of packet 517a) to migrate towards the ion outlet the most rapidly and, thus, these ions arrive at point p1 at time t₁. The ions having the greatest m/z values (e.g., ions of packet 517c) migrate the most slowly and, thus, only reach point p3 at time t₁. At the same time, the ions having intermediate m/z values (e.g., ions of packet 517b) arrive at point p2.

FIG. 6F is a schematic depiction of the positions of the packets of ions of FIG. 6D at a second time, t₂, subsequent to time t₁, at which the applied RF amplitude(s) has/have been ramped to such an extent that the forward-urging pseudopotential forces on the ions of ion packet 517a first equal and then substantially exceed the maximum backward-urging electrostatic forces corresponding to Eₘₐₓ along field-magnitude segment 503b. As a result, multiple portions of the ions of packet 517a are collected by individual travelling pseudopotential wells and are transported downstream thereby, conveyor-belt style, from position pc to the ion outlet 118 at position L. This movement of the ions along the flat field-strength profile 503b is relatively rapid, in comparison to the migration along the ascending voltage profile 503a, since additional ramping of the RF amplitude(s) is not met by a corresponding increase in the backward-urging DC field. Simulations of ion motions indicate that although a portion of the ions of each ion packet may migrate in the reverse direction (i.e., towards the ion inlet 113) within constant field region 503b, they do so less frequently than within the variable field region 503a. The ions are able to efficiently escape from the region 503a in the vicinity of point pc because, on average, the travelling pseudopotential wells move them forward away from point pc and towards the ion outlet 118.

At the same time that ions of packet 517a are transported from position pc to position L, the ions of packets 517b and 517c remain at positions p1 and p2 that are upstream from position pc as a result of the earlier spatial separation of the various packets of ions. Since the forward-urging pseudopotential forces at these positions are merely sufficient to approximately balance (i.e., slightly exceed) the backward-urging DC field forces, the ions in both of these packets continue to migrate relatively slowly towards position pc as the RF amplitude is further ramped until a subsequent time, t₃, at which packet 517b reaches position pc. As shown in FIG. 6G, still further ramping of the RF amplitude(s) causes relatively rapid transport of the ions of the packet 517b from position pc to position L. Yet additional ramping causes the ions of packet 517c to be similarly transported (not shown).

The transport of ions through an ion guide, in the fashion described above with reference to FIGS. 6G-6H, causes the emergence, from the ion outlet 118 of the apparatus, of ion packets having different respective m/z values to be spaced apart, in time, by at least the time of flight of the ions from position pc to the ion outlet 118. The axial field profile that opposes the forward motion of the ions need not be exactly as shown in FIGS. 6D, 6F and 6G. For example, a voltage profile of the general form shown in FIG. 6H, wherein the profile along the second segment 503b is not constant, may also be usefully employed. Simulations of ion motions and distributions show that the exact form of the electric field in the “constant” region (i.e., the region indicated by voltage profile segment 503b) is not critical. The simulations indicate that, although the best m/z resolution is achieved when the field within the profile segment 503b is constant, small variations have only minor impacts on performance. Regardless, any gradient of the DC field in the profile segment 503b should be less than the gradient of the DC field in the profile region 503a that is used for initial spatial separation of ion species according to m/z.

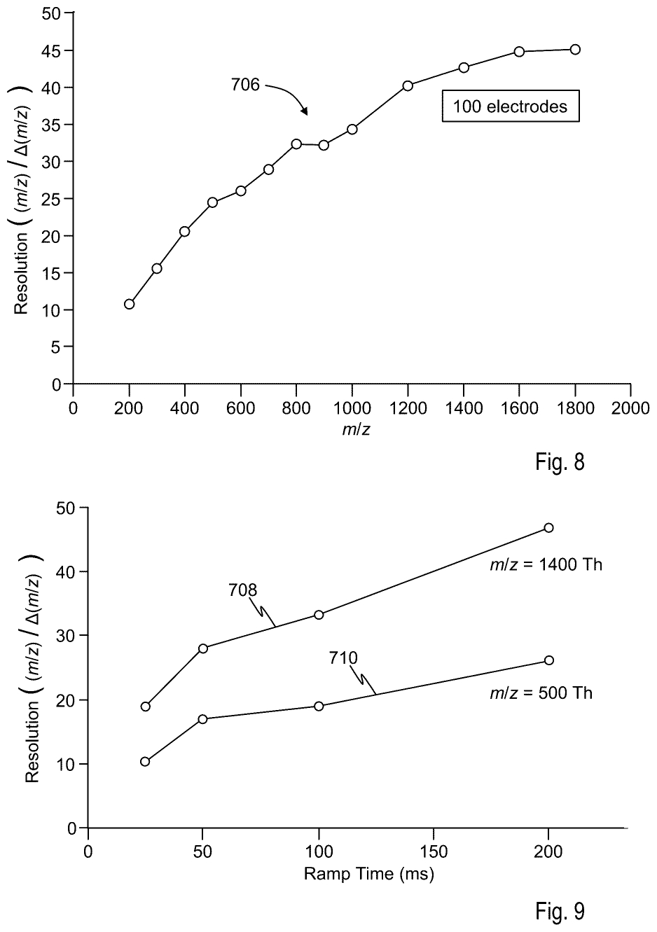

Further, the rate of ramping of the amplitude(s), A_{RF}, of the applied RF waveform(s) may be chosen depending on the requirements of a particular measurement. For example, if the ion guide apparatus is employed as a type of mass spectrometer that is operated in a general survey mode, with detection of all ions as they emerge from an ion outlet, then a continuous ramping of A_{RF}, as is schematically depicted in FIG. 7A, may be employed. Although FIG. 7A illustrates a linear variation of A_{RF} with time, the variation may alternatively be non-linear, with steeper slopes (i.e., more rapid increase in amplitude) at those times during the ramping at which it is expected that the ions that emerge from the apparatus do not require detection at the maximum achievable resolution and shallower slopes (i.e., slower rate of increase of amplitude) at other times at which it is expected that the emerging ions require a greater level of m/z discrimination. For example, FIG. 8 shows the expected achievable mass spectral resolution of ions as a function of m/z at a constant RF ramp rate. FIG. 9 shows that greater resolution is expected with longer time durations allotted for completion of the ramping. FIG. 7B illustrates discontinuous, stepped ramping with, for example, longer dwell times, Δt, at times at which ions of particular interest are expected to emerge from the apparatus, and variable amplitude jumps, ΔA_{RF}, at times at which no ions of interest are expected. Such expected times of emergence of ions of particular m/z values may be pre-determined by calibration of the transit times of known standard ions through the apparatus under various conditions.

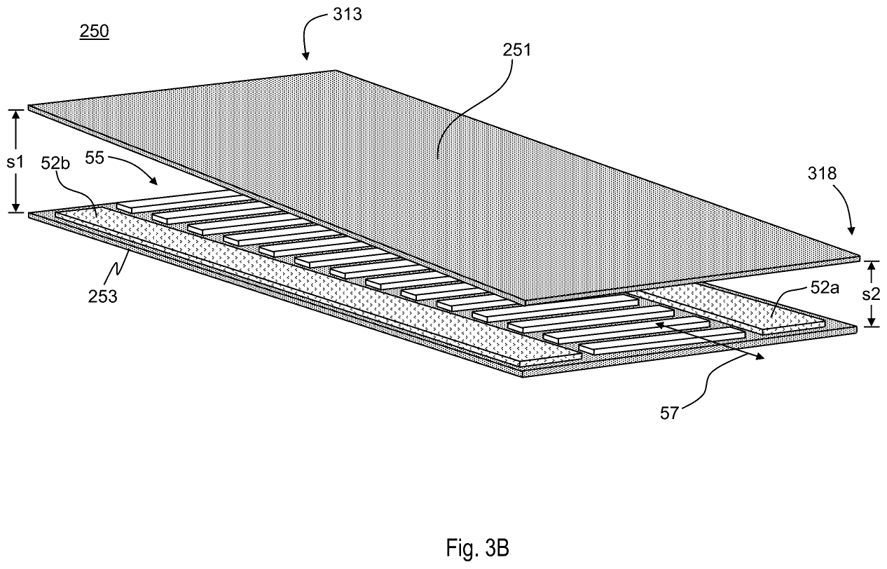

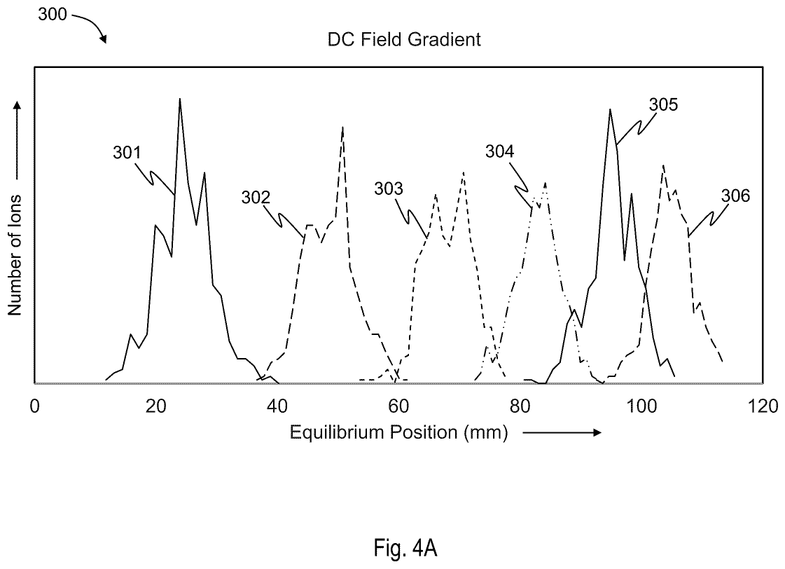

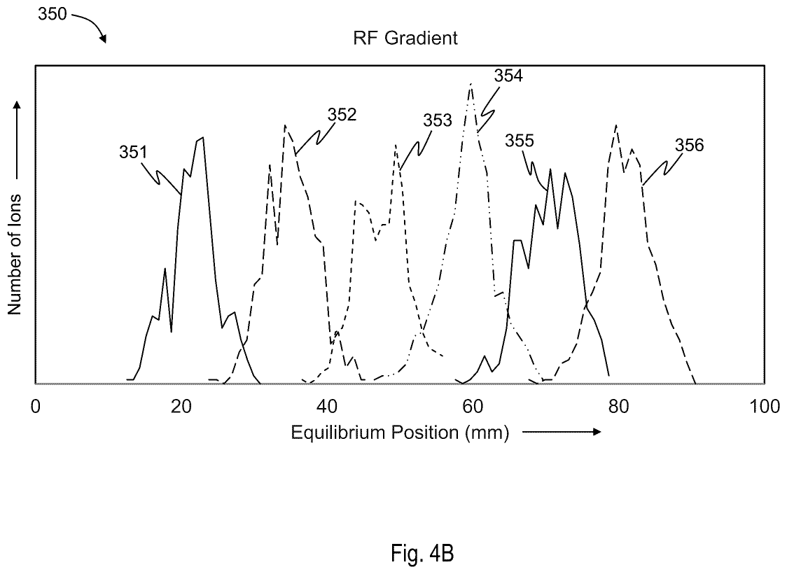

FIGS. 4A and 4B represent simulated performance of an ion sorting apparatus that is configured and operated in accordance with the present teachings. The simulated apparatus is 160 mm wide, having 320 electrodes, and 160 pseudopotential wells. The simulation assumed a general separation/equilibration time of 40 msec and assumed operation in the presence of 100 mTorr of nitrogen gas. The plots in FIG. 4A represent the equilibrium positions of ions of various m/z ratios within such an apparatus under the application of a DC axial field gradient while, at the same time, under the application of RF waveforms that do not vary across the length of the apparatus. In contrast, the plots in FIG. 4B represent the equilibrium positions of the same ions under application of an RF amplitude gradient across the length of the apparatus in the presence of a uniform DC axial field. Both trace 301 (FIG. 4A) and trace 351 (FIG. 4B) represent ions having a hypothetical m/z value of 500 Th. Similarly, traces 302 and 352 represent ions having m/z ratio of 600 Th; traces 303 and 353 represent ions having m/z ratio of 700 Th; traces 304 and 354 represent ions having m/z ratio of 800 Th; traces 305 and 352 represent ions having m/z ratio of 900 Th; and traces 306 and 356 represent ions having m/z ratio of 1000 Th.

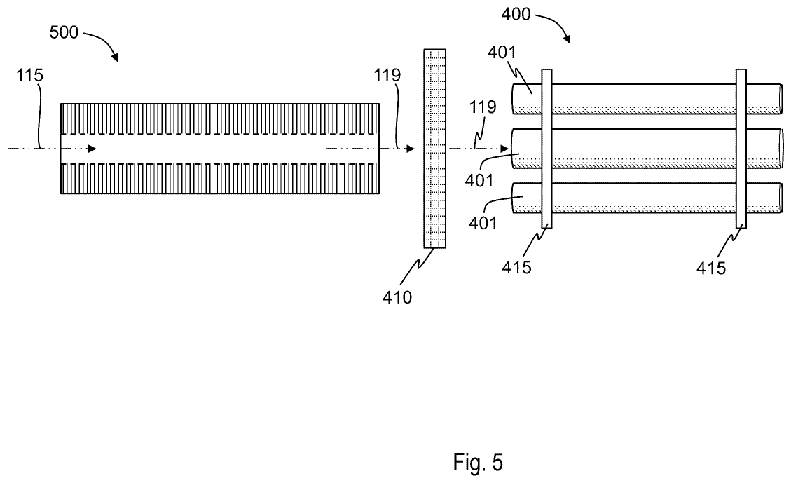

FIG. 5 is a schematic depiction of a portion of a mass spectrometer apparatus that includes an ion filter 400 or other mass spectrometer component arranged in series with an ion transport apparatus 500 that is configured in accordance with the above-described teachings. The apparatus 500 may comprise any of the embodiments that are illustrated in the accompanying drawings or may comprise any non-illustrated apparatus that is operated in accordance with the present teachings including but not limited to: ion guides comprising series of electrodes disposed on or otherwise adhered to parallel plates or wafers (e.g., FIGS. 1C, 1D), ion guides comprising series of electrodes disposed on or otherwise adhered to non-parallel plates or wafers (e.g., FIG. 3B), ion tunnels (e.g., FIGS. 2A-2C), ion funnels (e.g., FIG. 3A), ion guides having both ion tunnel and ion funnel portions in any number (e.g., FIGS. 1A-1B), ion guides in which the series of electrodes comprise series of segments of segmented quadrupole rods; and other ion guides that are capable of providing both an axial field gradient (either end-to-end or across only a portion of the length of the device) as well as a longitudinal gradient (either end-to-end or across only a portion of the length of the device) in RF amplitude or in some other RF parameter.

As illustrated, the apparatus 400 is a quadrupole mass filter that comprises four mutually parallel rod electrodes 401 that are maintained in mutual alignment by support structures 415 that may also provide electrical connections to the rods. In other instances, the apparatus may comprise, without limitation, a multipole ion trap, a multipole fragmentation cell, an ion guide, or a mass analyzer of any type. Preferably, a controllable ion gate 410 is disposed between an ion outlet of the apparatus 500 and an ion inlet of the apparatus 400.

In operation of the system depicted in FIG. 5, the apparatus 500 provides an outlet stream 119 of ions wherein, at any one time, the range of mass-to-charge (m/z) values of ions composing the outlet stream 119 is reduced relative to a broader range of m/z values that are provided to an inlet end of the apparatus 500 within an inlet ion stream 115 and wherein the range of (m/z) values composing the outlet stream 119 changes, over time, to either greater m/z values or smaller m/z values. In a practical sense, the operation of the apparatus 500 is thus similar to the operation of a conventional mass filter in which the mass-to-charge pass band of the mass filter is scanned with time with the exceptions that the pass band of the apparatus 500 is broader than that of a conventional mass filter and that ions within each pass band range may be accumulated and temporarily stored within the apparatus 500 prior to their release from the apparatus. Thus, the apparatus 500 performs the function of ion accumulation as well as the function of partial pre-separation of ions prior to transferring the ions into the conventional apparatus 400. If the conventional apparatus 400 comprises a quadrupole mass filter, then such mass filter may isolate narrower m/z ranges, each isolated range comprising ion species of particular analytical interest.

The ion outlet stream 119 may be either continuous in time or discontinuous in time. The continuity of delivery of the ion outlet stream to the apparatus 400 may be controlled by operation of an ion gate 410, thereby restricting the m/z range of ions that may be transferred to the downstream apparatus during any particular time interval. During the times that the ion gate 410 is closed (thereby restricting transmission), new packets of ions from the inlet ion stream 115 may be accumulated and sorted within the upstream apparatus 500 as described herein supra. At such times, the applied RF waveforms and DC voltages are coordinated so as to cause the sorting (e.g., FIG. 2B). At the time that the ion gate 410 is open, the internal RF waveforms and DC voltages are adjusted to permit migration of the accumulated ions out of the apparatus in either increasing order (e.g., FIG. 2C) or decreasing order (e.g., FIG. 3A) of their m/z values.

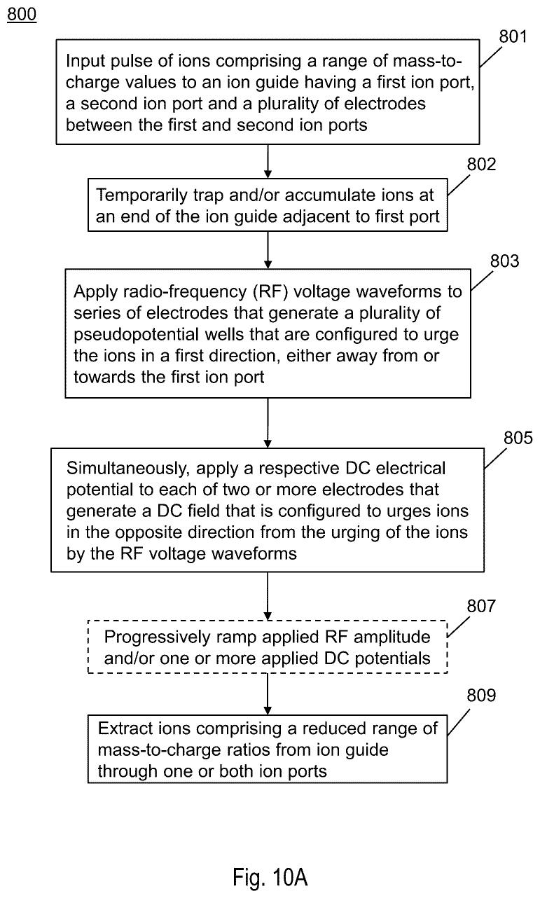

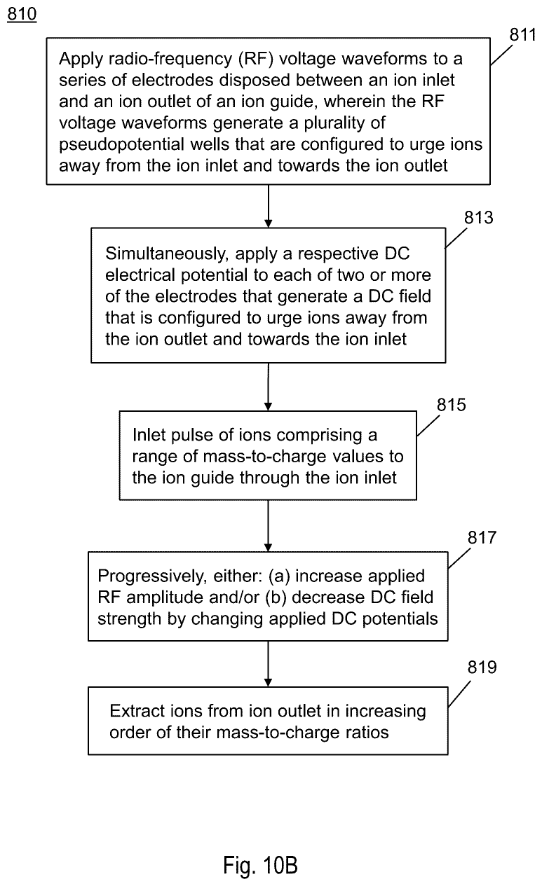

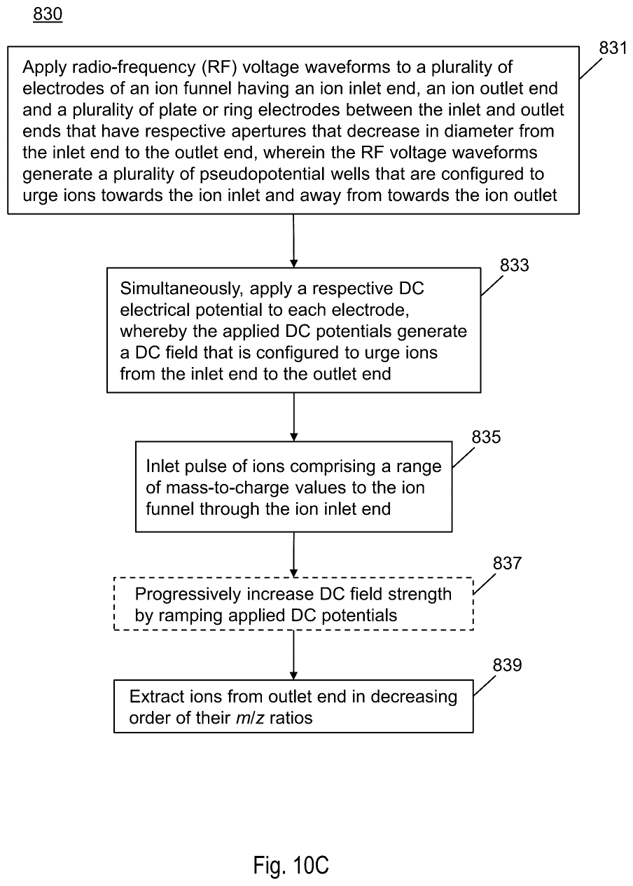

FIG. 10A is a flow diagram of a first method (method 800) of operating an ion guide in accordance with the present teachings. In the first step, step 801 of the method 800, a pulse of ions comprising a range of mass-to-charge (m/z) ratios are input to a first port of two separate ion ports of an ion guide. In step 802, the ions are temporarily trapped and/or accumulated within the ion guide at an end of the ion guide that is adjacent to the first port. The ions may be trapped and/or accumulated thereat by applying DC voltages to electrodes near the first port that temporarily create a temporary, static potential well near that port. In the following step 803 (which may be performed prior to or simultaneously with steps 801 and 802), radio-frequency (RF) voltage waveforms that generate a plurality of pseudopotential wells that are configured to urge the ions in a first direction that is either away from the first ion port and towards the second ion port or, alternatively, towards the first ion port are applied to series of electrodes of the ion guide. In step 805, which occurs simultaneously with step 803, DC electrical potentials that generate a DC field that urges the ions in a direction that is opposite to the urging of the ions by the pseudopotential wells are applied to each of two or more respective electrodes. The DC field may either be uniform (i.e., constant magnitude that does not vary with position) or non-uniform (i.e., having magnitude that is variable with position) across the length of the ion guide. In optional step 807, either the applied RF amplitude(s) and/or the one or more applied DC potentials are progressively ramped over time, in either an increasing or a decreasing fashion, in order to facilitate the differential migration of ions towards the second ion port. Finally, in step 809 ions comprising a range of m/z ratios that is reduced relative to the range of m/z ratios (i.e., is a subset of the range) of the originally input ions, are extracted from the second port of the ion guide. The extracted ions may be inlet to another component of a mass spectrometer apparatus, such as a mass filter, a collision cell or a mass analyzer.

FIG. 10B is a flow diagram of a second method (method 810) of operating an ion guide in accordance with the present teachings. In step 811 of the method 810, radio-frequency (RF) voltage waveforms are applied to a series of electrodes disposed between an ion inlet and an ion outlet of an ion guide, wherein the RF voltage waveforms generate a plurality of pseudopotential wells that are configured to urge ions away from the ion inlet and towards the ion outlet. In step 813, which is executed simultaneously with the execution of step 811, respective DC electrical potentials are applied to each of two or more of the electrodes that generate a DC field that is configured to urge ions away from the ion outlet and towards the ion inlet. The DC field may either be uniform (i.e., constant magnitude that does not vary with position) or non-uniform (i.e., having magnitude that is variable with position) across the length of the ion guide. Subsequently, in step 815, a pulse of ions comprising a range of mass-to-charge values is inlet to the ion guide through the ion inlet. In step 817, either (a) the amplitude(s) of the applied RF waveforms are increased and/or (b) the magnitude of the applied DC field is progressively decreased to cause ions to differentially migrate through the ion guide and towards the ion outlet. In step 819, the ions are extracted from the ion outlet in increasing order of their mass-to-charge ratios. The extracted ions may be inlet to another component of a mass spectrometer apparatus, such as a mass filter, a collision cell or a mass analyzer. According to a variation of the method 810, the step 815 may be executed prior to the steps 811-813 and an additional step of trapping the pulse of ions within a region of the ion guide adjacent to the ion inlet may be executed together with execution of the steps 811-813.

FIG. 10C is a flow diagram of a third method (method 830) of operating an ion guide in accordance with the present teachings. In step 831, radio-frequency (RF) voltage waveforms are applied to a plurality of electrodes of an ion funnel having an ion inlet end, an ion outlet end and a plurality of plate or ring electrodes between the inlet and outlet ends that have respective apertures that decrease in diameter from the inlet end to the outlet end, wherein the RF voltage waveforms generate a plurality of pseudopotential wells that are configured to urge ions towards the ion inlet and away from the ion outlet. In step 833, which is executed simultaneously with the execution of step 831, a respective DC electrical potential is applied to each of the electrodes, whereby the applied potentials generate a DC field that is configured to urge ions away from the inlet end towards the outlet end. Subsequently, in step 835, a pulse of ions comprising a range of mass-to-charge values is inlet to the ion funnel through its ion inlet end. In optional step 837, the magnitude (i.e., strength) of the DC field towards the ion outlet end of the ion funnel may be increased by ramping the DC voltages that are applied to the electrodes in order to facilitate the migration of ions towards the ion outlet end of the ion funnel. Finally, in step 839, ions are extracted from the outlet end of the ion funnel in decreasing order of their m/z ratios. The extracted ions may be inlet to another component of a mass spectrometer apparatus, such as a mass filter, a collision cell or a mass analyzer.

The discussion included in this application is intended to serve as a basic description. The present invention is not intended to be limited in scope by the specific embodiments described herein, which are intended as single illustrations of individual aspects of the invention. Functionally equivalent methods and components are within the scope of the invention, as defined by the claims. Various other modifications of the invention, in addition to those shown and described herein will become apparent to those skilled in the art. For example, a method of generating axial DC fields is described herein in which an end-to-end DC voltage is proportioned (e.g., by using voltage dividers) across a series or stack of electrodes to which RF voltages are also applied. However, many other means of generating axial fields within ion guides have been described, many of which utilize sets of auxiliary electrodes to generate axial fields. Such auxiliary electrodes are often separate from and in addition to a series or stack of main electrodes that receive the RF voltage waveforms. Many alternative methods for generating axial fields or drag fields are described in U.S. Pat. No. 7,675,031 (Konicek at al.); U.S. Pat. No. 5,847,386 (Thomson et al.); U.S. Pat. No. 7,985,951 (Okumura et al.; U.S. Pat. No. 7,064,322 (Crawford, et al.); U.S. Pat. No. 7,064,322 (Crawford, et al.); and U.S. Pat. No. 6,417,511 (Russ, I V, et al.). Adaptation of one or more of these known axial field generation techniques to the methods and apparatuses described herein is contemplated and would be within the ability of one of ordinary skill in the art.

As another example of a modification of the above teachings, a variation in the spacing between adjacent ring electrodes 2 (FIGS. 1A, 2A, 2B, 2C) or between adjacent electrodes of an array 55 that is supported on a substrate (FIG. 1C) may be used as an additional method for creating a longitudinal spatial gradient in the migrational motive force of an RF-derived travelling wave. For example, the inter-electrode spacing could vary in either a continuous or a discontinuous fashion along the length of an axis of an ion guide or ion separator apparatus in accordance with the present teachings and this variation would create a corresponding variation in the depth of the pseudopotential wells along the length of the device.

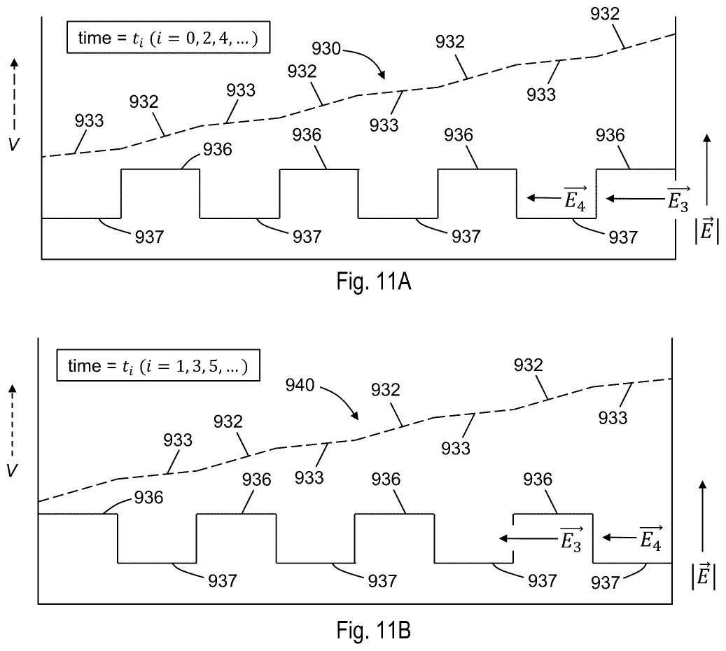

As still another example of a modification of the above teachings, reference is now made to FIGS. 11A-11B. The hypothetical voltage plots that are depicted in FIGS. 11A-11B, when considered together, provide an example of the application, to an ion guide apparatus, of two separate DC voltage profiles 930, 940 that alternate in time with one another. The left end of each voltage profile corresponds to an ion inlet or “upstream” end of an ion guide apparatus and the right end of each profile corresponds to an ion outlet or “downstream” end of the apparatus. In operation, each DC profile is provided simultaneously with the providing of an RF-modulated travelling-wave that generates RF-induced pseudopotential wells that urge ions towards the downstream end of the apparatus to which the DC profiles are provided. The DC voltage profiles 930, 940 are provided in order to provide forces to ions that are in opposition to the pseudopotential-derived force and that thus urge ions towards the upstream end of the apparatus. Accordingly, the algebraic sign of the slope of the profiles 930, 940 implicitly assumes that the ions are positively charged.

Each voltage profile in FIGS. 11A-11B comprises a series of steep-slope segments 932 separated from one another by a series of shallow-slope segments 933. The terms “steep-slope” and “shallow-slope” are used herein in only a relative sense and do not imply any particular numerical values of slopes or of applied voltages. The steep-slope segments of the voltage profile correspond to an upstream-directed electric field vector \vec{E₃} and the shallow-slope segments correspond to a second upstream-directed electric field vector, \vec{E₄}, where the vector magnitudes are such that |\vec{E₄}|<|\vec{E₃}|. The voltage profile 930, is applied at time periods, tᵢ, where i=0, 2, 4, . . . and the voltage profile 940, is applied at time periods where i=1, 3, 5, . . . . Each time the voltage profile changes, a section of the apparatus that was previously provided with the steep-slope profile is subsequently provided with the shallow-slope profile and vice versa.

It may be observed that the change from voltage profile 930 (FIG. 11A) to voltage profile 940 (FIG. 11B) and vice versa is equivalent to either a simple leftward or rightward shift of a single profile, with the shift being equal to the constant spatial width of the profile segments. However, with appropriate finer control of the apportioning of voltages provided to the various individual electrode segments that create the electric fields and to the cycling of the provided voltages to those electrodes, the shift may be caused to be much smaller than the segment widths. In such cases, the positional changes of voltage profiles as well as of the “peaks” 936 and “valleys” 937 of the profile of electric field magnitude may be made to more closely approximate a continuous profile shift and the positional changes of the peaks and valleys 936, 937 may be termed as a “DC travelling wave”. The providing of such an upstream-migrating DC travelling wave in conjunction with the simultaneous providing of a downstream-migrating RF travelling wave may facilitate the separation and concentration, at an upstream end of an ion guide apparatus, of certain targeted “heavy” ion species if the rate of upstream migration of the peaks 936 is controlled so as to match the speed of movement of the target ions along the length of the apparatus. Generally, “light” ions will also migrate towards the downstream end of the apparatus under such conditions, but with less efficiency. Conversely, a downstream-migrating DC travelling wave may facilitate the separation of “light” ions and the concentration of those ions at the downstream end of the apparatus and/or their elimination from the apparatus at the ion outlet. Various operational parameters may be controlled as needed.

It should be noted that, with progressively increasing gas pressure above 0.01 Torr, the performance of an ion guide apparatus as described above will be progressively altered. Such changes are anticipated to result from the increasing probability of collisions between ions and gas molecules at increasing gas pressures. With slight increases in pressure above 0.01 Torr, the general characteristics of apparatus performance will continue to be as described above but there will be changes in m/z resolution and in the speed at which ion species migrate through the apparatus. In general, although the greater gas pressure will counteract both the downstream-directed and upstream-directed urgings created by the applied voltages, the pressure effect will be greatest in regard to the RF travelling waves because of a reduction in the pseudopotential well depths with increasing gas pressure. As a result, as the internal pressure increases, the effects of the m/z independent force that is exerted on all ions by the applied DC field will become more pronounced, relative to the urgings exerted by the RF travelling wave. Accordingly, at such gas pressures, the performance of an ion guide apparatus (e.g., m/z resolution, ion residence time) as described above may be advantageously modified, depending on the requirements of a particular measurement, experiment or analytical program, by control of the gas pressure.

As the gas pressure inside an ion guide apparatus increases still further, the ion-molecule collisional effects will become increasingly pronounced, relative to the effects of the applied DC and RF voltages, such that, above some gas pressure that depends on apparatus configuration (e.g., length, cross-sectional area, gas composition, etc.), the collisional effects dominate over the m/z dependent effects of the applied voltages and the apparatus performance tends to resemble an ion mobility separation apparatus, the performance of which is moderated by the applied DC and RF voltages. The performance of such an ion mobility apparatus may be advantageously modified, depending on the requirements of a particular measurement, experiment or analytical program, by controlling the magnitude or magnitudes of one or more applied RF voltage waveforms or by controlling one of more of the frequencies of the applied voltage waveforms.

Accordingly, gas pressure may be considered as an additional parameter to be taken into account during calibration of the performance of an apparatus that is operated as described by the present teachings. More generally, gas pressure is one of many operational parameters, such as apparatus length, apparatus cross-sectional area, gas composition, RF frequencies, etc., that may affect mass spectral results (e.g., mass spectral resolution and measurement speed) but that are difficult to theoretically model, when taken in combination. As a result, apparatus behavior should be calibrated for each particular apparatus prior to operation so that the effects of these parameters are well understood in each instance.

In some examples, an ion router may be used to selectively guide ions from a component of a mass spectrometry system to another component of the mass spectrometry system. Such components of a mass spectrometry system may include, for example, an ion guide as described above (e.g., ion guide 100), an accumulator, a mass filter, a mass analyzer, ion optics, a detector, and/or any other suitable component. Illustrative ion routers that include multiple channels for guiding ions between selectively operated ports are described herein. In some examples, an ion router includes a pair of opposing surfaces, at least three ports, each port defining an opening between the pair of opposing surfaces, and a plurality of ion channels defined by arrays of electrodes coupled to the pair of surfaces. In some examples, at least one port included in the at least three ports is configured as an entrance port through which ions are received into the ion router and at least two ports included in the at least three ports are configured to be selectively operated as either one of an exit port through which ions exit the ion router or a closed port through which ions are neither received nor ejected by the ion router. In further examples, each of the ports included in the at least three ports is selectively operated as any one of an entrance port, an exit port, or a closed port. In some examples, the plurality of ion channels converge toward a common position within the ion router and are configured to receive one or more voltages for guiding ions from a port configured as an entrance port to a port selectively operated as an exit port. In some examples, multiple ports are selectively operated as entrance ports, multiple ports are selectively operated as exit ports, and/or multiple ports are selectively operated as closed ports.

The ion routers described herein have various advantages over conventional ion guides. For example, the selectively operated ports allow for more flexibility in guiding ions, such as by receiving and/or ejecting ions at any port included in the ion router, guiding ions from various sources to various destinations, and/or routing ions at various angles within the ion router. Furthermore, the ion routers described herein have a simple construction because each port is selectively operated by voltages applied to a port electrode to guide ions from a port operated as an entrance port to a port operated as an exit port. Hence, the same electronic drive circuitry is used to selectively operate each port and guide the ions between the ports, thus simplifying the construction and operation of the ion guides.

Various examples will now be described in more detail with reference to the figures. The systems and methods described herein may provide one or more of the benefits mentioned above and/or various additional and/or alternative benefits that will be made apparent herein.

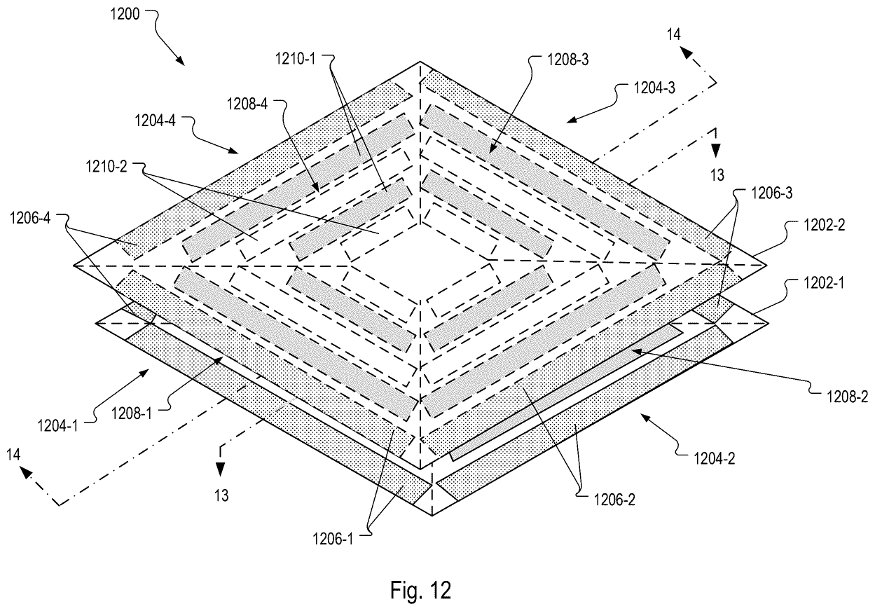

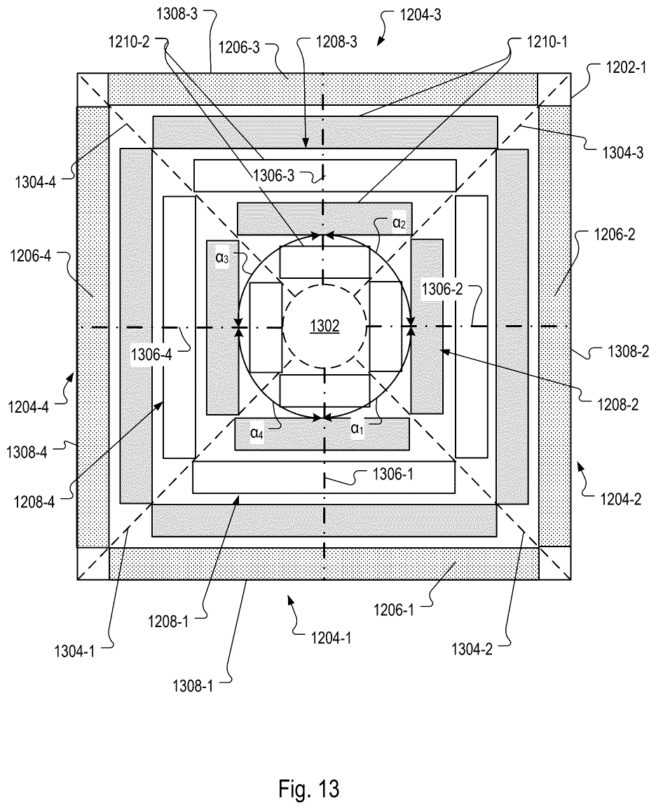

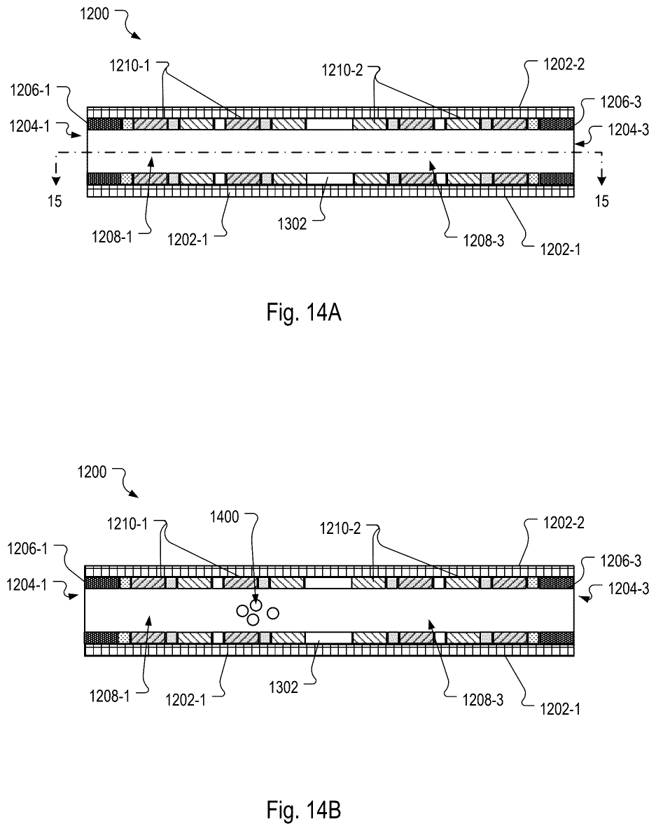

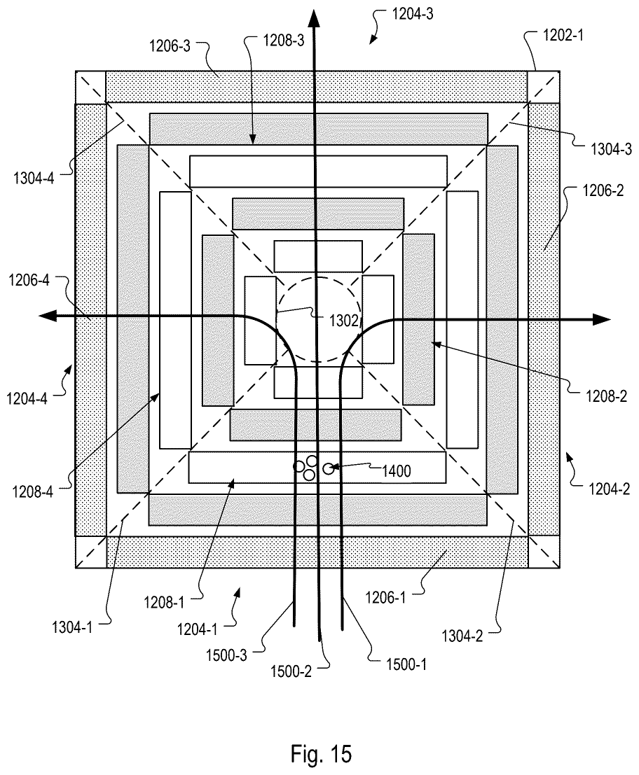

FIGS. 12-15 show various views of an illustrative ion router 1200. FIG. 12 shows a perspective view of ion router 1200. FIG. 13 shows a cross-sectional view of ion router 1200 taken along the dash-dot-dash line labeled 13 in FIG. 12. FIGS. 14A and 14B show cross-sectional views of ion router 1200 taken along the dash-dot-dash line labeled 14 in FIG. 12. FIG. 15 shows a cross-sectional view of ion router 1200 taken along the dash-dot-dash lines labeled 15 in FIG. 14A.

Ion router 1200 includes a pair of opposing surfaces 1202 (e.g., surfaces 1202-1 and 1202-2). As shown, a first surface 1202-1 and a second surface 1202-2 are planar surfaces positioned substantially parallel to one another and facing one another with a gap therebetween. First surface 1202-1 and second surface 1202-2 may each be implemented by any suitable planar structure, such as a PCB or a solid substrate (e.g., a glass substrate, a ceramic substrate, a polymer substrate, etc.). In other examples, first surface 1202-1 and second surface 1202-2 are not planar but have a curved, contoured, concave, convex, or other non-planar shape as may suit a particular implementation. Moreover, surfaces 1202 are shown as having a square shape, though any other suitable shapes may be used that may suit a particular implementation, such as a polygonal shape (e.g., triangle, rectangle, pentagon, hexagon, etc.).

Ion router 1200 further includes a plurality of ports 1204 (e.g., ports 1204-1 through 1204-4). While FIG. 12 shows four ports 1204, ion router 1200 may have any other suitable number of ports, such as at least three ports 1204 or more than four ports 1204. Each port 1204 is defined at an opening (e.g., the gap) between the pair of opposing surfaces 1202. In some examples, each port 1204 is configured to be selectively operated as any one of an entrance port through which ions are received into ion router 1200, an exit port through which ions exit ion router 1200, or a closed port through which ions are neither received into nor ejected by ion router 1200. In some other examples, at least one port 1204 is configured as an entrance port, while at least two ports 1204 are configured to be selectively operated as either one of an exit port or a closed port. Ports 1204 may further be configured to switch between operation as an entrance port, an exit port, and/or a closed port, such as during operation of ion router 1200. Such selective operation of ports 1204 allows ion router 1200 to be customizable to selectively receive ions from one or more sources (e.g., an ion source, an accumulator, an ion guide, an ion sorter etc.) at any one or more ports 1204 and/or transfer ions to one or more destinations (e.g., an accumulator, an ion guide, an ion sorter, a mass spectrometer, etc.) from any one or more other ports 1204.

In the illustrated example, each port 1204 includes one or more port electrodes 1206 (e.g., pairs of port electrodes 1206-1 through 1206-4) configured to receive one or more voltages (e.g., DC voltages and/or RF voltages) to selectively operate each port 1204 as an entrance port, an exit port, or a closed port. For example, port electrodes 1206 are formed of an electrically conductive material (e.g., a metal) configured to receive the one or more voltages. As will be explained in more detail below, pairs of port electrodes 1206 on opposing surfaces 1202 at a port 1204 may receive DC voltages to thereby generate forces to confine ions within ion router 1200 at a port 1204 operated as a closed port, allow ions to enter a port 1204 operated as an entrance port, and/or allow ions to exit a port 1204 operated as an exit port. Accordingly, port electrodes 1206 at each port 1204 may be configured to receive different voltages so as to operate each port 1204 independently relative to the other ports 1204. Still other suitable configurations may be used to selectively operate ports 1204. For example, ports 1204 may include any other suitable components (e.g., one or more lenses, etc.) configured to receive one or more voltages for selectively operating ports 1204 in addition to or instead of port electrodes 1206.

Ion router 1200 further includes a plurality of ion channels 1208 (e.g., ion channels 1208-1 through 1208-4) defined by arrays of electrodes 1210 coupled to the pair of opposing surfaces 1202 and configured to receive one or more voltages for guiding ions from one or more ports 1204 operated as an entrance port to one or more ports 1204 operated as an exit port. To illustrate, each ion channel 1208 includes a plurality of first electrodes 1210-1 (shown in gray shading) and a plurality of second electrodes 1210-2 (shown without shading) arranged in an alternating pattern on each surface 1202. As shown, a plurality of first electrodes 1210-1 and a plurality of second electrodes 1210-2 are arranged on first surface 1202-1 and another plurality of first electrodes 1210-1 and another plurality of second electrodes 1210-2 are arranged on second surface 1202-2 opposite to first surface 1202-1. In FIG. 12, electrodes 1210 on second surface 1202-2 are shown in broken lines to indicate that the electrodes 1210 are positioned on a side of second surface 1202-2 facing first surface 1202-1. Second surface 1202-2 is spaced away from first surface 1202-1 to form ion channels 1208 defined by electrodes 1210 therebetween. Any suitable number of electrodes 1210 and/or sets of electrodes 1210 may be used for each ion channel 1208 as may serve a particular implementation, such as depending on a length of each ion channel 1208. For example, each electrode in a set of electrodes (e.g., electrodes 2a-2f) may receive the same RF voltage waveform, which may vary across the sets of electrodes. In some examples, ion channels 1208 may include the same number of electrodes 1210 and/or a different number of electrodes 1210.

Electrodes 1210 are formed of an electrically conductive material (e.g., a metal) configured to receive the one or more voltages, as will be explained below in more detail, for guiding ions through ion channels 1208. In some examples, electrodes 1210 on opposing surfaces 1202 within ion channels 1208 may receive transient voltages (e.g., DC gradient voltages and/or RF traveling wave voltages) to thereby generate one or more forces to guide ions within ion channels 1208 (e.g., from one or more ports 1204 operated as an entrance port to one or more ports 1204 operated as an exit port). In some examples, electrodes 1210 are further configured to receive confinement voltages (e.g., RF trapping voltages and/or DC trapping voltages) to thereby generate one or more confinement fields to prevent ions from colliding with first surface 1202-1 and second surface 1202-2. Such confinement voltages may be superimposed on electrodes 1210 with transient voltages. Ion channels 1208 may be under vacuum, low pressure, or high pressure.

Accordingly, ion channels 1208 include a volume in the gap between first surface 1202-1 and second surface 1202-2 in which ions may be guided (e.g., driven, transported, propelled, etc.). Each ion channel 1208 is connected with a port 1204 to allow ions to flow from the port 1204 to the respective ion channel 1208 and from the ion channel 1208 to the respective port 1204. While the illustrated example shows a single ion channel 1208 connected to a single port 1204, any suitable number of ion channels 1208 may be connected to any suitable number of ports 1204 for guiding ions through ion router 1200.

Although not shown, ion router 1200 may include other components as may suit a particular implementation, such as spacers that maintain a spacing between first surface 1202-1 and second surface 1202-2, a voltage source and wiring for connecting electrodes 1210 to the voltage source, electronics for controlling a voltage applied to electrodes 1210, and/or guard electrodes positioned between ion channels 1208 for confining ions within each ion channel 1208.

Referring now to FIG. 13, the array of electrodes 1210 of each ion channel 1208 included in the plurality of ion channels 1208 extends toward a common position 1302 within ion router 1200. To illustrate, a first ion channel 1208-1 extends from a first port 1204-1 to common position 1302 (e.g., first channel 1208-1 represented by the area between dashed lines 1304-1 and 1304-2), a second ion channel 1208-2 extends from a second port 1204-2 to common position 1302 (e.g., second channel 1208-2 represented by the area between dashed lines 1304-2 and 1304-3), a third ion channel 1208-3 extends from a third port 1204-3 to common position 1302 (e.g., third ion channel 1208-3 represented by area between dashed lines 1304-3 and 1304-4), and a fourth ion channel 1208-4 extends from a fourth port 1204-4 to common position 1302 (e.g., fourth ion channel 1208-4 represented by area between dashed lines 1304-4 and 1304-1). Accordingly, the plurality of ion channels 1208 meet at common position 1302 to allow ions to flow from any ion channel 1208 to any other ion channel 1208. As an illustrative example, ions may be configured to flow from first port 1204-1 operated as an entrance port, through first ion channel 1208-1 toward common position 1302, and to second ion channel 1208-2 toward second port 1204-2 operated as an exit port. In the illustrated example, common position 1302 is positioned at a central portion of ion router 1200 (e.g., at a central position of surfaces 1202). However, common position 1302 may be positioned at any other portion (e.g., off-center, an edge portion, a corner portion, etc.) of ion router 1200 as may serve a particular orientation.

Electrodes 1210 defining ion channels 1208 are arranged along an axis 1306 (e.g., axes 1306-1 through 1306-4) of each ion channel 1208 (e.g., extending from a port 1204 to common position 1302). For example, electrodes 1210 of first ion channel 1208-1 are arranged along a first axis 1306-1 of first ion channel 1208-1, electrodes 1210 of second ion channel 1208-2 are arranged along a second axis 1306-2 of second ion channel 1208-2, electrodes 1210 of third ion channel 1208-3 are arranged along a third axis 1306-3 of third ion channel 1208-3, and electrodes 1210 of fourth ion channel 1208-4 are arranged along a fourth axis 1306-4 of fourth ion channel 1208-4. As shown, each axis 1306 of each ion channel 1208 is oriented at a different angle α (e.g., angles α₁ through α₄) relative to the axis 1306 of another adjacent ion channel 1208. For example, first axis 1306-1 is oriented at a first angle α₁ relative to second axis 1306-2, second axis 1306-2 is oriented at a second angle α₂ relative to third axis 1306-3, third axis 1306-3 is oriented at a third angle α₃ relative to fourth axis 1306-4, and fourth axis 1306-4 is oriented at a fourth angle α₄ relative to first axis 1306-1. In the example of FIG. 13, each axis 1306 of each ion channel 1208 is oriented at the same angle α of about 90 degrees relative to the axes 1306 of each adjacent ion channel 1208. However, any other suitable configurations for ion channels 1208 may be used as may serve a particular implementation. For example, various angles α (e.g., about 30 degrees to about 180 degrees, about 60 degrees to about 120 degrees, etc.) may be used. Additionally or alternatively, the angle α may be the same between any one or more axes 1306 or may vary between any one or more axes 1306.

In some examples, the axis 1306 of each ion channel 1208 forms an ion path along which ions travel through the ion channel 1208. To illustrate, the plurality of first electrodes 1210-1 and the plurality of second electrodes 1210-2 are alternatingly arranged on first surface 1202-1 along the axis 1306 of each ion channel 1208 to form an ion path having a central axis corresponding to the axis 1306 of the ion channel 1208. Accordingly, the ion paths extend within each ion channel 1208, such as between a port 1204 to common position 1302. In the example of FIG. 13, the central axis of the ion path corresponds to the axis 1306 of the ion channel 1208. However, the central axis of the ion path is not limited to this configuration, but may have any other suitable shapes (e.g., curved, wavy, or irregular) and/or orientation relative to the axis 1306 of the ion channel 1208. In some examples, the axis 1306 of each ion channel 1208 is a central axis, and the central axes for all ion channels 1208 intersect at the common position 1302.

As shown, each electrode 1210 has an elongate rectangular shape having a width that extends outwardly from the axis 1306 of each ion channel 1208 toward each side edge (e.g., represented by dashed lines 1304) of each ion channel 1208. Additionally, the width of each electrode 1210 included in the array of electrodes 1210 forming each ion channel 1208 decreases sequentially along the ion channel 1208 (e.g., from an electrode 1210 positioned adjacent to a port 1204 to an electrode 1210 positioned adjacent to common position 1302). The width of each ion channel 1208 thereby decreases along the axis 1306 of the ion channel 1208 in a direction from a port 1204 toward common position 1302 such that each ion channel 1208 converges from a port 1204 toward common position 1302. Such a convergence of ion channels 1208 toward common position 1302 may facilitate in guiding ions toward common position 1302 and into another ion channel 1208. In some examples, the convergence of ion channels 1208 may guide ions along the ion path along central axes 1306 of ion channels 1208 such as by directing ions inwardly toward central axes 1306 of ion channels 1208 and common position 1302.

However, electrodes 1210 are not limited to this configuration and may have any other suitable shape (e.g., curved, elliptical, oval, wavy, chevron, L-shaped, U-shaped, V-shaped, or irregular) as may serve a particular implementation. In some examples, the width of each electrode 1210 in an array of electrodes 1210 may be continuous without sequentially decreasing. For example, the width of electrodes 1210 may be continuous along axes 1306 of ion channels 1208 and/or the widths of electrodes 1210 within an ion channel 1208 positioned toward ports 1204 may be continuous, while the widths of electrodes 1210 within the ion channel 1208 positioned toward common position 1302 may decrease. Additionally or alternatively, a gap may be provided between electrodes 1210 of different ion channels 1208.

In some examples, the plurality of ion channels 1208 are positioned relative to each other to form a polygonal shape (e.g., a triangle, a square, a rectangle, a pentagon, a hexagon, etc.). As shown, four ion channels 1208 are oriented relative to each other to form a square shape. However, any other suitable number of ion channels 1208 may be used to form any other suitable polygonal shape as may serve a particular implementation. To illustrate, three ion channels 1208 may be oriented relative to each other to form a triangular shape, four ion channels 1208 may be oriented relative to each other to form a rectangular shape, five ion channels 1208 may be oriented relative to each other to form a pentagonal shape, and/or six ion channels 1208 may be oriented relative to each other to form a hexagonal shape. Such polygonal shapes formed by ion channels 1208 may correspond to the shape of surfaces 1202 and/or the combined polygonal shapes formed by ion channels 1208, which may be different than the shape of surfaces 1202. In some examples, ion channels 1208 are oriented about common position 1302 such that each ion channel 1208 forms a radial segment within the polygonal shape formed by ion channels 1208.

FIG. 13 further shows each port electrode 1206 of ports 1204 positioned at an edge 1308 (e.g., edges 1308-1 through 1308-4) of surface 1202. For example, each port electrode 1206 is positioned to extend along at least a portion of each edge 1308 defining the polygonal shape of surface 1202. As shown, surface 1202 is a square shape including four edges 1308 forming a perimeter of the square shape and four port electrodes 1206 positioned at each edge 1308 about the perimeter. While each port electrode 1206 is shown as extending straight along each edge 1308 of surface 1202, port electrodes 1206 and/or edges 1308 may be curved or contoured. Additionally or alternatively, port electrodes 1206 may be spaced away from edges 1308 of surface 1202 and/or any suitable number of port electrodes 1206 may be included at any suitable number of edges 1308 (e.g., to omit a port 1204 from one or more edges 1308 and/or to form multiple ports 1204 at one or more edges 1308).

FIGS. 14A and 14B show first surface 1202-1 positioned opposite to second surface 1202-2 to form one or more ports 1204 at one or more openings therebetween. As shown, each port 1204 includes a port electrode 1206 positioned on each opposing surface 1202. Each surface 1202 further includes a plurality of first electrodes 1210-1 and a plurality of second electrodes 1210-2 alternately arranged to define ion channels 1208 therebetween. In some examples, port electrodes 1206, first electrodes 1210-1 and second electrodes 1210-2 are attached (e.g., printed, mounted, fastened, glued, printed, embedded within, etc.) directly to surfaces 1202 and/or are spaced away from surfaces 1202 within ports 1204 or ion channels 1208. Still other suitable configurations for port electrodes 1206 and/or electrodes 1210 may be used. For example, port electrodes 1206 and/or electrodes 1210 may additionally or alternatively be flush with surfaces 1202.

As mentioned above, port electrodes 1206 on opposing surfaces 1202 at a port 1204 receive DC voltages to thereby generate forces to confine ions within ion router 1200 at a port 1204 operated as a closed port, allow ions to enter a port 1204 operated as an entrance port, and/or allow ions to exit a port 1204 operated as an exit port. Accordingly, port electrodes 1206 at each port 1204 may be configured to receive different voltages so as to operate each port 1204 independently relative to the other ports 1204. For example, first port electrodes 1206-1 may be connected to a first circuit (not shown) configured to supply first DC voltages from a voltage source (not shown), second port electrodes 1206-2 may be connected to a second circuit (not shown) configured to supply second DC voltages from the same voltage source or a different voltage source, third port electrodes 1206-3 may be connected to a third circuit (not shown) configured to supply third DC voltages from the same voltage source or a different voltage source, and fourth port electrodes 1206-4 may be connected to a fourth circuit (not shown) configured to supply fourth DC voltages from the same voltage source or a different voltage source.

The first, second, third, and/or fourth DC voltages may be adjusted to selectively operate each port 1204 as an entrance port, an exit port, or a closed port. As an illustrative example, for positive ions, a port electrode 1206 of a port 1204 to be operated as an exit port may receive a lower DC voltage than a port electrode of a port 1204 to be operated as an entrance port and a port electrode 1206 of a port 1204 to be operated as a closed port may receive the same DC voltages or higher DC voltages than the port electrode 1206 of a port 1204 to be operated as an entrance port. Alternatively, for negative ions, the exit port may receive a higher DC voltage than a closed port, which may receive a higher DC voltage than an entrance port. In some examples, the DC voltages applied to the port electrode 1206 of the entrance port and the DC voltages applied to the port electrode 1206 of the exit port generate a DC gradient from the entrance port to the exit port. To switch the operation of a port 1204 from an entrance port to a closed port, the DC voltages received by the port electrodes 1206 may be increased. Alternatively, to switch the operation of a port 1204 from an entrance port to an exit port, the DC voltages received by the port electrodes 1206 may be decreased.

Electrodes 1210 within ion channels 1208 are configured to receive one or more voltages for guiding ions through ion channels 1208. In a first voltage scheme, electrodes 1210 may receive DC gradient voltages to thereby generate one or more forces to guide ions within ion channels 1208. For example, voltage dividers may be included in the voltage supply circuitry to connect electrodes 1210 with one other and/or with port electrodes 1206. When DC voltages are applied to port electrodes 1206, the voltage dividers provide DC gradient voltages across electrodes 1210 (e.g., the voltage dividers reduce the DC potential generated at each successive electrode 1210 in the direction of ion flow to thereby generate the DC gradient). As shown in FIG. 14B, such a DC gradient may guide ions 1400 through ion channels 1208, which may allow ion router 1200 to be operated by only applying individual DC voltages at port electrodes 1206.

In a second voltage scheme, electrodes 1210 are further configured to receive trapping voltages (e.g., RF trapping voltages) to superimpose on the DC gradient a trapping potential to confine ions 1400 between first surface 1202-1 and second surface 1202-2. In a third voltage scheme, electrodes 1210 are configured to receive trapping voltages (e.g., DC trapping voltages) to generate a trapping potential to confine ions 1400 between first surface 1202-1 and second surface 1202-2 and RF traveling wave voltages (e.g., instead of DC gradient voltages) to superimpose an RF traveling wave potential on the trapping potential to guide ions through ion channels 1208. To illustrate, the RF traveling wave voltages may include transient RF voltages applied to certain electrodes 1210 so that pseudopotential wells are formed between these electrodes 1210 to create trapping regions within ion channels 1208. The transient RF voltages are then progressively applied to subsequent electrodes 1210 along the ion path in the direction of ion flow so that the trapping regions move along ion channels 1208, which may be referred to as a “traveling wave potential”. When electrodes 1210 receive RF traveling wave voltages to generate the traveling wave potential, the traveling wave potential is applied along the ion path (e.g., axes 1306) to guide the ions along the ion path. An amplitude and/or frequency of the traveling wave may vary, such as based on a size of ion channels 1208.

In configurations in which electrodes 1210 are configured to receive RF voltages (e.g., RF trapping voltages and/or RF traveling wave voltages), first electrodes 1210-1 are configured to receive first RF voltages and second electrodes 1210-2 are configured to receive second RF voltages that are phase-shifted with respect to the first RF voltages. In the figures, electrodes 1210 of a first phase (e.g., first electrodes 1210-1) are shaded gray and electrodes 1210 of a second phase (e.g., second electrodes 1210-2) are not shaded. In some examples, the RF voltages received by first electrodes 1210-1 are out of phase with the RF voltages received by second electrodes 1210-2.

In configurations in which electrodes are configured to receive RF voltages, first electrodes 1210-1 are connected to a fifth circuit (not shown) configured to supply first RF voltages from a voltage source (not shown) and second electrodes 1210-2 are connected to a sixth circuit (not shown) configured to supply second RF voltages from the same voltage source or a different voltage source. In examples in which the voltage source is the same for the fifth circuit and the sixth circuit, either the fifth circuit or the sixth circuit may include any suitable phase shift circuit or phase shift module. Alternatively, first electrodes 1210-1 may receive first RF voltages while second electrodes 1210-2 receive DC voltages and/or are grounded. In instances in which electrodes 1210 are configured to receive RF traveling wave voltages, ion channels 1208 may include at least three sets of electrodes 1210 to impart directionality to the traveling wave. For example, a third set of electrodes may be alternatingly positioned between first electrodes 1210-1 and second electrodes 1210-2 and configured to receive third RF voltages. Waveform amplitudes of the first, second, and third RF voltages are modulated, with the phase of the modulation changing between electrode sets, to produce a traveling wave pseudo-potential that guides the ions along the axis of each ion channel 1208.

FIG. 15 depicts illustrative ion trajectories 1500 (e.g., ion trajectories 1500-1 through 1500-3) depicting the flow of ions 1400 along ion paths of one or more ion channels 1208 corresponding to axes (e.g., axes 1306) of ion channels 1208. To illustrate, a first ion trajectory 1500-1 includes routing ions 1400 from a first port 1204-1 operated as an entrance port to a second port 1204-2 operated as an exit port, while a third port 1204-3 and a fourth port 1204-4 are operated as closed ports. Accordingly, first port electrodes 1206-1 on each opposing surface 1202 receive first DC voltages to allow the flow of ions 1400 within first port 1204-1 and into first ion channel 1208-1. Electrodes 1210 of first ion channel 1208-1 receive DC gradient voltages or RF traveling wave voltages to guide ions 1400 through first ion channel 1208-1 toward common position 1302 (e.g., along first axis 1306-1). Electrodes 1210 of second ion channel 1208-2 receive DC gradient voltages or RF traveling wave voltages to route ions 1400 to second ion channel 1208-2 and guide ions 1400 from common position 1302 through second ion channel 1208-2 toward second port 1204-2 (e.g., along second axis 1306-2). Because the second axis 1306-2 of the second ion channel 1208-2 is oriented at an angle (e.g., first angle α₁) relative to the first axis 1306-1 of the first ion channel 1208-1, the flow of ions 1400 along the first ion trajectory 1500-1 turns about the angle from the first ion channel 1208-1 to the second ion channel 1208-2. Second port electrodes 1206-2 on each opposing surface 1202 receive second DC voltages that are lower than the first DC voltages applied to first port electrodes 1206-1 to allow ejection of ions 1400 from second port 1204-2. Meanwhile, third port electrodes 1206-3 receive third DC voltages and fourth port electrodes 1206-4 receive fourth DC voltages that are both equal to or higher than the first DC voltages to operate the third port 1204-3 and the fourth port 1204-4 as closed ports.

As another example, a second ion trajectory 1500-2 includes switching the second port 1204-2 from an exit port to a closed port and switching the third port 1204-3 from a closed port to an exit port to rout ions 1400 from the first port 1204-1 to the third port 1204-3, while the second port 1204-2 and the fourth port 1204-4 are operated as closed ports. Accordingly, first port electrodes 1206-1 on each opposing surface 1202 continue to receive the same first DC voltages to allow the flow of ions 1400 within first port 1204-1 and into first ion channel 1208-1. Electrodes 1210 of first ion channel 1208-1 receive DC gradient voltages or RF traveling wave voltages to guide ions 1400 through first ion channel 1208-1 toward common position 1302 (e.g., along first axis 1306-1). Electrodes 1210 of third ion channel 1208-3 receive DC gradient voltages or RF traveling wave voltages to route ions 1400 to third ion channel 1208-3 and guide ions 1400 from common position 1302 through third ion channel 1208-3 toward third port 1204-3 (e.g., along third axis 1306-3). Because the third axis 1306-3 of the third ion channel 1208-3 aligns with the first axis 1306-1 of the first ion channel 1208-1 (e.g., the combination of first angle α₁ and second angle α₂), the flow of ions 1400 along the second ion trajectory 1500-2 continues straight from the first ion channel 1208-1 to the third ion channel 1208-3. The third DC voltages received by the third port electrodes 1206-3 on each opposing surface 1202 are adjusted (e.g., decreased) to an amount lower than the first DC voltages to allow ejection of ions 1400 from third port 1204-3. Meanwhile, the second DC voltages received by the second port electrodes 1206-2 and the fourth DC voltages received by the fourth port electrodes 1206-4 are adjusted to be equal to or higher than the first DC voltages to operate the second port 1204-2 and the fourth port 1204-4 as closed ports.

As another example, a third ion trajectory 1500-3 includes switching the third port 1204-3 to be operated as a closed port and switching the fourth port 1204-4 to be operated as an exit port to rout ions 1400 from the first port 1204-1 to the fourth port 1204-4, while the second port 1204-2 and the third port 1204-3 are operated as closed ports. Accordingly, first port electrodes 1206-1 on each opposing surface 1202 continue to receive the same first DC voltages to allow the flow of ions 1400 within first port 1204-1 and into first ion channel 1208-1. Electrodes 1210 of first ion channel 1208-1 receive DC gradient voltages or RF traveling wave voltages to guide ions 1400 through first ion channel 1208-1 toward common position 1302 (e.g., along first axis 1306-1). Electrodes 1210 of the fourth ion channel 1208-4 receive DC gradient voltages or RF traveling wave voltages to route ions 1400 to fourth ion channel 1208-4 and guide ions 1400 from common position 1302 through fourth ion channel 1208-4 toward fourth port 1204-4 (e.g., along fourth axis 1306-4). Because the fourth axis 1306-4 of the fourth ion channel 1208-4 is oriented at an angle (e.g., the fourth angle α₄) relative to the first axis 1306-1 of the first ion channel 1208-1, the flow of ions 1400 along the third ion trajectory 1500-3 is turned along the angle from the first ion channel 1208-1 to the fourth ion channel 1208-4. The fourth DC voltages received by fourth port electrodes 1206-4 on each opposing surface 1202 are adjusted to an amount lower than the first DC voltages to allow ejection of ions 1400 from the fourth port 1204-4. Meanwhile, the second DC voltages received by second port electrodes 1206-2 and the third DC voltages received by third port electrodes 1206-3 adjusted to be equal to or higher than the first DC voltages to operate the second port 1204-2 and the third port 1204-3 as closed ports.

While the illustrative examples show the first port 1204-1 designated as the entrance port with ions 1400 flowing from the first port 1204-1 to common position 1302 and from thence to another port 1204, in some other examples, any of the other ports 1204 may be operated as an entrance port in addition to or instead of first port 1204-1. In some examples, multiple ports 1204 are simultaneously selectively operated as an entrance port. Additionally or alternatively, any port 1204 (e.g., not operating as an entrance port) may be operated as an exit port such that, in some examples, multiple ports 1204 are simultaneously selectively operated as an exit port. Still other suitable configurations for selectively operating ports 1204 may be used as may serve a particular implementation. For example, ports 1204 may be configured to simultaneously guide ions in the same direction (e.g., toward common position 1302 or away from common position 1302). Alternatively, each port 1204 may be selectively operated independently of the other ports 1204 (e.g., voltages received by each port 1204 may be different than voltages received by the other ports 1204).

During operation of ion router 1200, a voltage may be provided at common position 1302, such as an average voltage of the voltages applied at ports 1204. Accordingly, the voltage provided at common position 1302 is less than the voltage applied at a port 1204 operated as an entrance port and greater than the voltage applied at a port 1204 operated as an exit port. In some examples, common position 1302 further includes an electrode configured to receive fifth DC voltages so as to simultaneously generate a DC field at common position 1302, which may facilitate guiding ions 1400 from an ion channel 1208 associated with a port 1204 selectively operated as an entrance port to another ion channel 1208 associated with a port 1204 selectively operated as an exit port. Such an electrode may be operated independently from port electrodes 1206 and/or electrodes 1210.

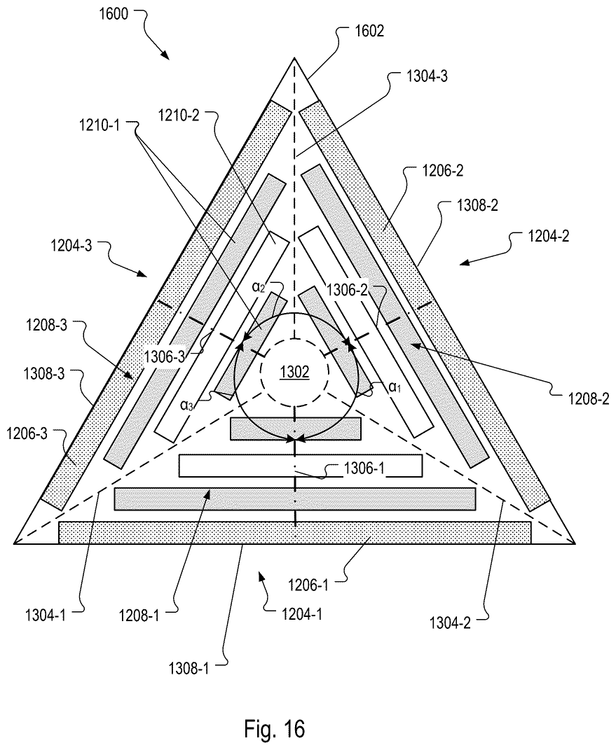

In the examples described above, routing ions within ion router 1200 is achieved by using ion channels 1208 having triangular shapes such that the plurality of ion channels 1208 form a square shape. However, the routing of ions may be achieved by using other ion channel shapes. Examples of alternative ion channel shapes will now be described with reference to FIGS. 16-18.

FIG. 16 shows a triangular configuration 1600 of electrodes 1210 on a surface 1602. Surface 1602 may implement first surface 1202-1 and/or second surface 1202-2 of ion router 1200. For example, port electrodes 1206 and electrodes 1210 on surface 1602 may be aligned with port electrodes 1206 and electrodes 1210 on another opposing surface 1602 so as to form ports 1204 and channels 1208 therebetween. In FIG. 16, surface 1602 includes three edges 1308 forming a triangular shape. A port electrode 1206 extends along each edge 1308 so as to form three ports 1204 when surface 1602 is positioned relative to an opposing surface 1602. Additionally, three arrays of electrodes 1210 extend from each port electrode 1206 toward common position 1302 to form three ion channels 1208 when surface 1602 is positioned relative to an opposing surface 1602. Electrodes 1210 defining ion channels 1208 are arranged along axes 1306 of the ion channels 1208. Each axis 1306 of each ion channel 1208 is oriented at a different angle α relative to the axis 1306 of another adjacent ion channel 1208. As shown, the three axes 1306 of ion channels 1208 are positioned at equal angles α about common position 1302 such that each angle α is about 120 degrees.

Moreover, the width of each electrode 1210 included in the array of electrodes 1210 forming each ion channel 1208 decreases sequentially along the ion channel 1208 (e.g., from an electrode 1210 positioned adjacent to a port 1204 to an electrode 1210 positioned adjacent to common position 1302). Accordingly, the width of each ion channel 1208 (e.g., between dashed lines 1304) decreases along the axis 1306 of the ion channel 1208 in a direction from a port 1204 toward common position 1302. However, electrodes 1210 are not limited to this configuration. For example, the width of electrodes 1210 (e.g., orthogonal to axis 1306) may be continuous along axes 1306 of ion channels 1208 and/or the widths of electrodes 1210 within an ion channel 1208 positioned toward ports 1204 may be continuous, while the widths of electrodes 1210 within the ion channel 1208 positioned toward common position 1302 may decrease. Additionally or alternatively, a gap may be provided between electrodes 1210 of different ion channels 1208. In some examples, the arrays of electrodes 1210 may form ion channels 1208 in a T-shape or a Y-shape.

While the triangular shape of ion channels 1208 corresponds to the triangular shape of surface 1602, in some other examples, ion channels 1208 may form the triangular shape on a surface 1602 having another shape (e.g., square, rectangle, etc.). The arrays of electrodes 1210 of ion channels 1208 are oriented about common position 1302 such that each ion channel 1208 forms a radial segment within the triangular shape formed by ion channels 1208.

The illustrated example further shows each port electrode 1206 positioned at an edge 1308 of surface 1602 in a triangular configuration. When surface 1602 is positioned relative to another opposing surface 1602, port electrodes 1206 may receive DC voltages to selectively operate each port 1204 as an entrance port, an exit port, or a closed port and electrodes 1210 of ion channels 1208 may receive voltages to guide ions from a port 1204 operated as an entrance port to a port 1204 operated as an exit port. Accordingly, an ion router 1200 incorporating a pair of opposing surfaces 1602 may receive and/or eject ions at any of the three ports 1204.

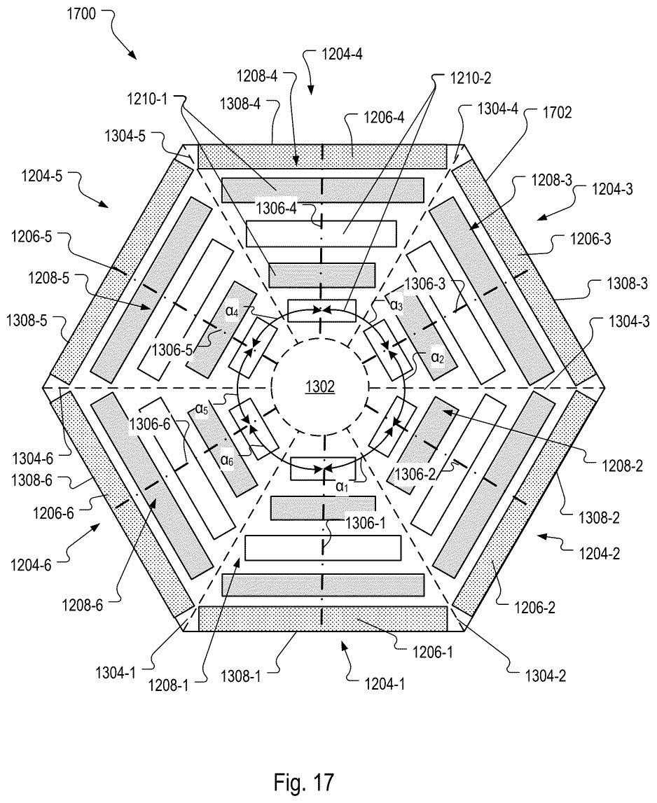

As another example, FIG. 17 shows a hexagonal configuration 1700 of electrodes 1210 on a surface 1702. Surface 1702 may implement first surface 1202-1 and/or second surface 1202-2 of ion router 1200. For example, port electrodes 1206 and electrodes 1210 on surface 1702 may be aligned with port electrodes 1206 and electrodes 1210 on another opposing surface 1702 so as to form ports 1204 and channels 1208 therebetween. In FIG. 17, surface 1702 includes six edges 1308 forming a hexagonal shape. A port electrode 1206 extends along each edge 1308 so as to form six ports 1204 when surface 1702 is positioned relative to an opposing surface 1702. Additionally, six arrays of electrodes 1210 extend from each port electrode 1206 toward common position 1302 to form six ion channels 1208 when surface 1702 is positioned relative to an opposing surface 1702. Electrodes 1210 defining ion channels 1208 are arranged along axes 1306 of the ion channels 1208. Each axis 1306 of each ion channel 1208 is oriented at a different angle α relative to the axis 1306 of another adjacent ion channel 1208. As shown, axes 1306 of ion channels 1208 are positioned at equal angles α about common position 1302 such that each angle α is about 60 degrees.

Moreover, the width of each electrode 1210 included in the array of electrodes 1210 forming each ion channel 1208 decreases sequentially along the ion channel 1208 (e.g., from an electrode 1210 positioned adjacent to a port 1204 to an electrode 1210 positioned adjacent to common position 1302). Accordingly, the width of each ion channel 1208 (e.g., between dashed lines 1304) decreases along the axis 1306 of the ion channel 1208 in a direction from a port 1204 toward common position 1302. However, electrodes 1210 are not limited to this configuration. For example, the width of electrodes 1210 may be continuous along axes 1306 of ion channels 1208 and/or the widths of electrodes 1210 within an ion channel 1208 positioned toward ports 1204 may be continuous, while the widths of electrodes 1210 within the ion channel 1208 positioned toward common position 1302 may decrease. Additionally or alternatively, a gap may be provided between electrodes 1210 of different ion channels 1208.

The arrays of electrodes 1210 are further positioned such that the plurality of ion channels 1208 are positioned relative to each other to form a hexagonal shape. While the hexagonal shape formed by ion channels 1208 corresponds to the hexagonal shape of surface 1702, in some other examples, ion channels 1208 may form the hexagonal shape on a surface 1702 having another shape (e.g., square, rectangle, etc.). The arrays of electrodes 1210 of ion channels 1208 are oriented about common position 1302 such that each ion channel 1208 forms a radial segment within the hexagonal shape formed by ion channels 1208.

The illustrated example further shows each port electrode 1206 positioned at an edge 1308 of surface 1702 in a hexagonal configuration. When surface 1702 is positioned relative to another opposing surface 1702, port electrodes 1206 may receive DC voltages to selectively operate each port 1204 as an entrance port, an exit port, or a closed port and electrodes 1210 of ion channels 1208 may receive voltages to guide ions from a port 1204 operated as an entrance port to a port 1204 operated as an exit port. Accordingly, an ion router 1200 incorporating a pair of opposing surfaces 1702 may receive and/or eject ions at any of the six ports 1204.

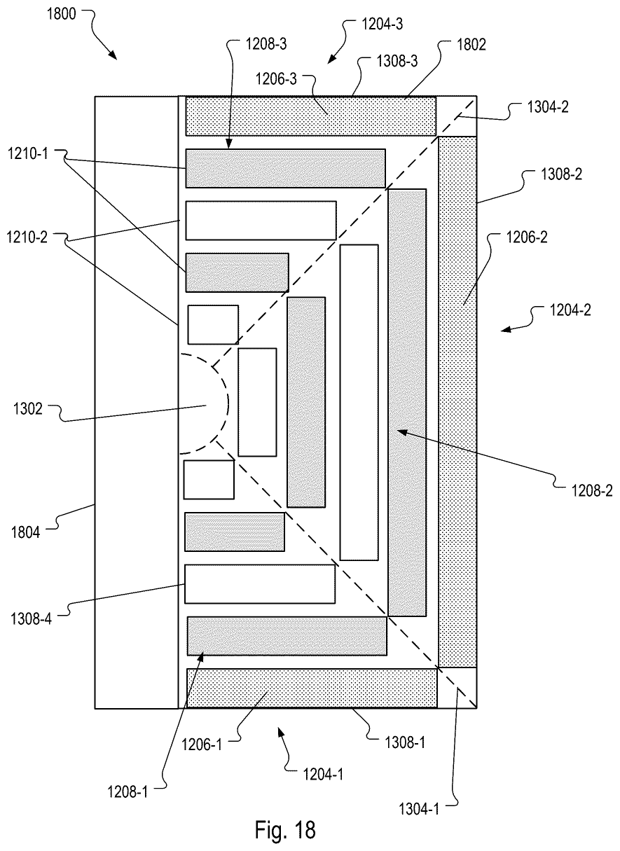

As another example, FIG. 18 shows a rectangular configuration 1800 of electrodes 1210 on a surface 1802. Surface 1802 may implement first surface 1202-1 and/or second surface 1202-2 of ion router 1200. For example, port electrodes 1206 and electrodes 1210 on surface 1802 may be aligned with port electrodes 1206 and electrodes 1210 on another opposing surface 1802 so as to form ports 1204 and channels 1208 therebetween. In FIG. 18, surface 1802 includes four edges 1308 forming a rectangular shape. A port electrode 1206 extends along three of edges 1308 so as to form three ports 1204 when surface 1802 is positioned relative to an opposing surface 1802. Additionally, three arrays of electrodes 1210 extend from each port electrode 1206 toward common position 1302 to form three ion channels 1208 when surface 1802 is positioned relative to an opposing surface 1802.

A guard electrode 1804 is further positioned to extend along the fourth edge 1308-4 of surface 1802 and is configured to receive voltages (e.g., DC trapping voltages and/or RF trapping voltages) so as to urge ions away from fourth edge 1308-4. In the illustrated example, guard electrode 1804 extends along a side of first port 1204-1, first ion channel 1208-1, common position 1302, third ion channel 1208-3, and third port 1204-3. Accordingly, guard electrode 1804 forms a side boundary of first port 1204-1, first ion channel 1208-1, common position 1302, third ion channel 1208-3, and third port 1204-3 to help confine ions within first port 1204-1, first ion channel 1208-1, common position 1302, third ion channel 1208-3, and third port 1204-3.

Moreover, the width of each electrode 1210 included in the array of electrodes 1210 forming each ion channel 1208 decreases sequentially along the ion channel 1208 (e.g., from an electrode 1210 positioned adjacent to a port 1204 to an electrode 1210 positioned adjacent to common position 1302). Accordingly, the width of each ion channel 1208 (e.g., between dashed lines 1304) decreases along the axis 1306 of the ion channel 1208 in a direction from a port 1204 toward common position 1302. However, electrodes 1210 are not limited to this configuration. For example, the width of electrodes 1210 may be continuous along axes 1306 of ion channels 1208 and/or the widths of electrodes 1210 within an ion channel 1208 positioned toward ports 1204 may be continuous, while the widths of electrodes 1210 within the ion channel 1208 positioned toward common position 1302 may decrease. Additionally or alternatively, a gap may be provided between electrodes 1210 of different ion channels 1208.

The arrays of electrodes 1210 are further positioned such that the plurality of ion channels 1208 are positioned relative to each other to form a rectangular shape. While the rectangular shape formed by ion channels 1208 corresponds to the rectangular shape of surface 1802, in some other examples, ion channels 1208 may form the rectangular shape on a surface 1802 having another shape (e.g., square, etc.). The arrays of electrodes 1210 of ion channels 1208 further are oriented about common position 1302 such that each ion channel 1208 forms a radial segment within the rectangular shape formed by ion channels 1208. In the illustrated example, common position 1302 is positioned at an edge 1308-4 of surface 1802 instead of at a central portion. With this configuration, second port 1204-2 is wider than first port 1204-1 and third port 1204-3, and second ion channel 1208-2 is wider than first ion channel 1208-1 and third ion channel 1208-3.

The illustrated example further shows each port electrode 1206 positioned at an edge 1308 of surface 1802 in a rectangular configuration. When surface 1802 is positioned relative to another opposing surface 1802, port electrodes 1206 may receive DC voltages to selectively operate each port 1204 as an entrance port, an exit port, or a closed port and electrodes 1210 of ion channels 1208 may receive voltages to guide ions from a port 1204 operated as an entrance port to a port 1204 operated as an exit port. Accordingly, an ion router 1200 incorporating a pair of opposing surfaces 1802 may receive and/or eject ions at any of the three ports 1204.

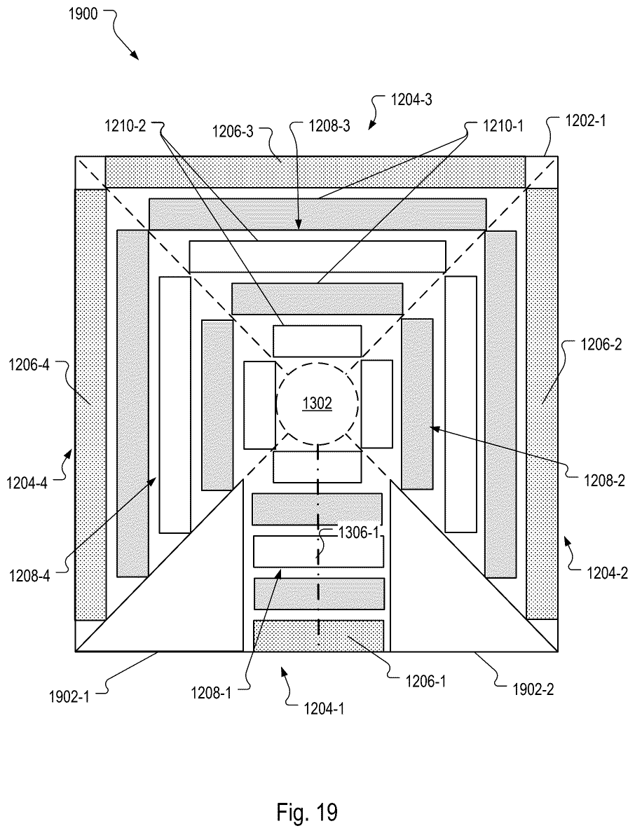

FIG. 19 shows another illustrative configuration 1900 of port electrodes 1206 and electrodes 1210 on first surface 1202-1 further comprising supplemental guard electrodes 1902 (e.g., guard electrodes 1902-1 through 1902-2) at first port 1204-1 and extending along a portion of the associated first ion channel 1208-1. As shown, each guard electrode 1902 is positioned on each side of first port 1204-1 on first surface 1202-1 (e.g., opposite axis 1306-1) and within ion channel 1208-1 toward common position 1302. Each guard electrode 1902 is configured to receive voltages (e.g., DC trapping voltages and/or RF trapping voltages) so as to generate forces to confine ions within first port 1204-1 and the first ion channel 1208-1 (e.g., toward axis 1306-1 of the ion channel 1208-1). Guard electrodes 1902 may accordingly prevent a stream of ions within the ion channel 1208 from expanding outward away from the axis 1306-1 of the first ion channel 1208-1.

While FIG. 19 shows guard electrodes 1902 positioned along first port 1204-1 and first ion channel 1208-1, guard electrodes 1902 may be positioned within any suitable number and/or configuration of ports 1204 and/or ion channels 1208. For example, guard electrodes 1902 may be positioned along any port 1204 to be selectively operated as an entrance port or an exit port and/or any ion channel 1208 associated with a port 1204 to be selectively operated as an entrance port or exit port. Such placement of guard electrodes 1902 may prevent the expansion of the stream of ions near the entrance port or exit port, which may allow a width (e.g., transverse to axis 1306 of ion channel 1208) of the stream of ions to correspond to a width of another optical element configured to receive and/or transmit ions to ion router 1200 (e.g., without the use of an ion funnel). Additionally or alternatively, guard electrodes 1902 may be positioned between each of the ion channels 1208 and along a length of each ion channel 1208 from a port 1204 to common position 1302 so as to confine ions within each ion channel 1208 and prevent ions from flowing between the ion channels 1208 prior to common position 1302.

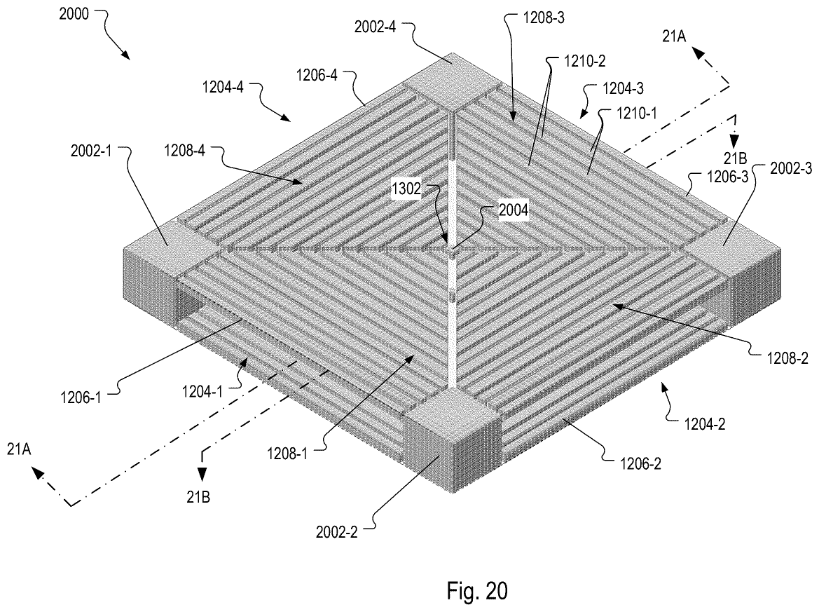

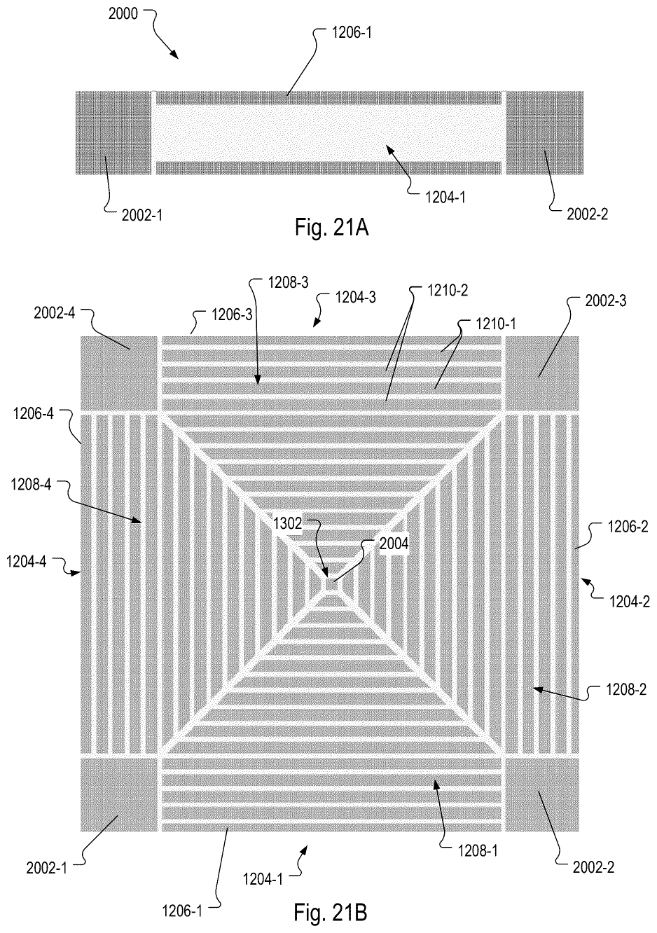

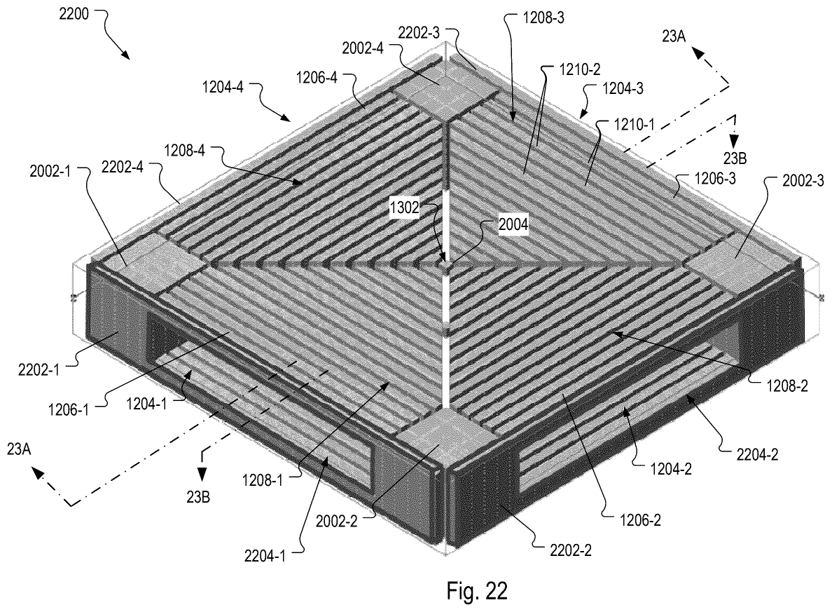

FIGS. 20-21B show another illustrative configuration 2000 of ion router 1200 that further includes a plurality of supports 2002 (e.g., supports 2002-1 through 2002-4). Supports 2002 are configured to extend between the pair of opposing surfaces on which port electrodes 1206 and electrodes 1210 are positioned (e.g., surfaces 1202) to maintain a space between the pair of opposing surfaces. The pair of opposing surfaces have been omitted from ion router 2000 shown in FIGS. 20-21B for illustrative purposes. As shown, a support 2002 is positioned between each port 1204 (e.g., between each port electrode 1206) at the corners of the polygonal shape formed by ion channels 1208. In some examples, supports 2002 are configured to receive one or more voltages (e.g., DC trapping voltages and/or RF trapping voltages) to generate forces to confine ions within ports 1204 and prevent a stream of ions from exiting between ports 1204. To illustrate, for positive ions, supports 2002 may receive DC voltages that are greater than the voltages provided at an entrance port. In some examples, supports 2002 are configured to receive voltages independently from port electrodes 1206 and electrodes 1210. Moreover, supports 2002 may be configured to receive the same voltages or supports 2002 may be configured to receive voltages independently relative to other supports 2002. Ion router 2000 further includes an electrode 2004 positioned at common position 1302 that may independently receive voltages (e.g., DC voltages) to provide additional flexibility in providing a DC gradient between ports 1204 for guiding ions from a port 1204 operated as an entrance port to a port 1204 operated as an exit port.

As an illustrative example for positive ions, first port electrode 1206-1 may be configured to receive first DC voltages (e.g., 2 Volts (V)) to operate first port 1204-1 as an entrance port. Second port electrode 1206-2 may be configured to receive second DC voltages (e.g., −2V) that are less than the first DC voltages to operate the second port 1204-2 as an exit port. Third port electrode 1206-3 may be configured to receive third DC voltages (e.g., 2V) and fourth port electrode 1206-4 may be configured to receive fourth DC voltages (e.g., 2V) that are equal to or greater than the first DC voltages (e.g., voltages applied to the entrance port) to operate the third port 1204-3 and the fourth port 1204-4 as closed ports. In instances where the third DC voltages and/or the fourth DC voltages are equal to the first DC voltages, ion router 2000 may be configured to further receive ions in the third port 1204-3 and/or the fourth port 1204-4. Alternatively, in instances where the third DC voltages and/or the fourth DC voltages are equal to the second DC voltages, ion router 2000 may be configured to further eject ions at the third port 1204-3 and/or the fourth port 1204-4.

In some examples, electrode 2004 at common position 1302 may be configured to receive fifth DC voltages (e.g., less than the voltages applied to the entrance port and greater than the voltages applied to the exit port) to guide ions from the entrance port to the exit port. In some examples, supports 2002 may be configured to receive sixth DC voltages (e.g., 2V) that are equal to or greater than the first DC voltages (e.g., voltages applied to the entrance port) to prevent ions from exiting ion router 2000 at supports 2002.

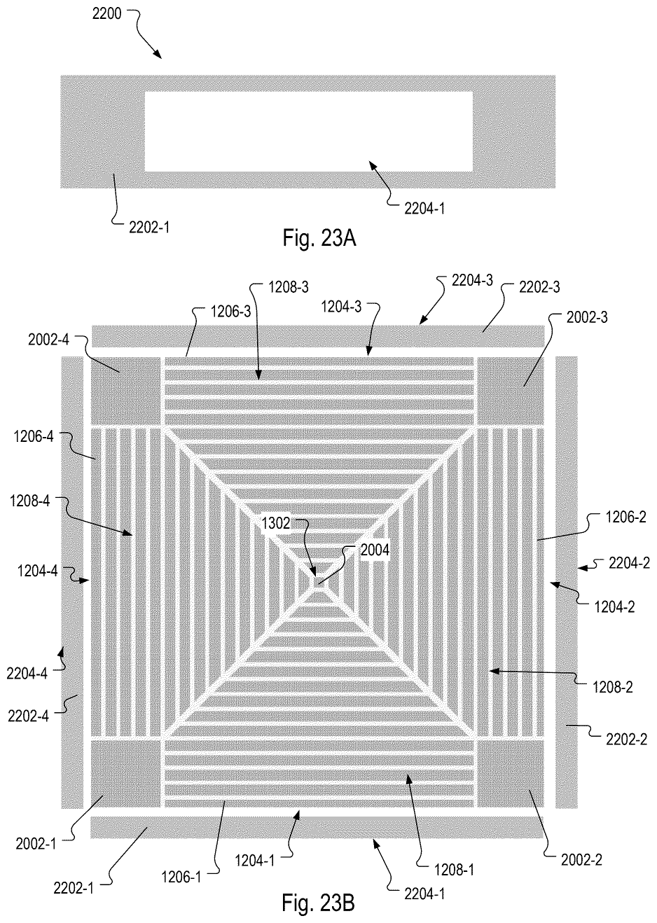

FIGS. 22-23B show another illustrative configuration 2200 of ion router 1200 that further includes lenses 2202 (e.g., lenses 2202-1 through 2202-4) positioned at each port 1204 outside of each ion channel 1208. As shown, each lens 2202 forms a lens opening 2204 (e.g., lens openings 2204-1 through 2204-4) that is aligned with each opening of ports 1204 to allow ions to flow through each lens 2202 and into the respective port 1204. Each lens 2202 is configured to receive one or more DC voltages to selectively operate each port 1204 as the entrance port, the exit port, or the closed port in addition to, or instead of, port electrodes 1206. For example, for positive ions, a lens 2202 associated with a port 1204 operated as an entrance port may receive a first DC voltage (e.g., configured to allow the flow of ions through lens opening 2204 and into the entrance port), another lens 2202 associated with a port 1204 operated as an exit port may receive a second DC voltage that is lower than the first DC voltage (e.g., configured to allow the flow of ions out of the exit port and through the lens opening 2204), and/or another lens 2202 associated with a port 1204 operated as a closed port may receive a third DC voltage that is higher than the first DC voltage (e.g., to prevent ions from flowing through the closed port and the lens opening 2204). Accordingly, each lens 2202 may be configured to independently receive DC voltages to operate each lens 2202 individually with respect to the other lenses 2202. In some examples, voltages applied to lenses 2202 may be adjusted to focus or defocus an ion beam flowing through lens openings 2204, such as to reduce or increase a size of the ion beam delivered to ion router 2200. Additionally, lenses 2202 may be included in addition to, or instead of, port electrodes 1206. In some examples, lenses 2202 are provided at ports 1204 of ion router 2200 in use (e.g., ports 1204 connected with another device) and not provided at ports 1204 of ion router 2200 not in use (e.g., ports 1204 not connected with another device).

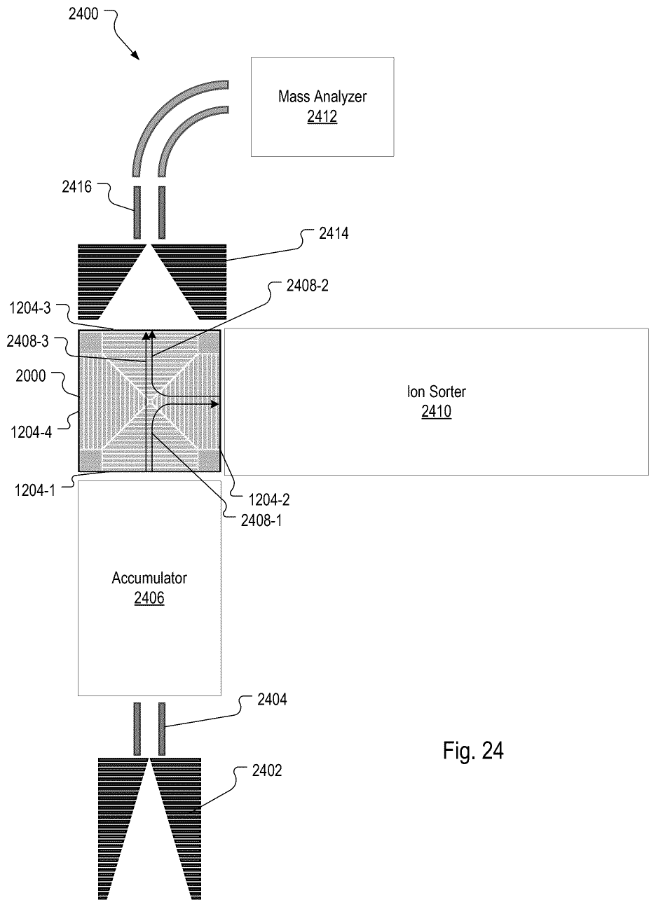

FIG. 24 shows an illustrative configuration 2400 of a mass spectrometry system incorporating an ion router (e.g., ion router 1200, 2000, or 2200) according to the principles described herein. As shown, mass spectrometry system 2400 is configured to receive ions (e.g., from an ion source) at an ion funnel 2402 configured to guide ions inward toward a central axis of ion funnel 2402 as ions flow through ion funnel 2402 and toward an ion guide 2404. In the example of FIG. 24, ion funnel 2402 is depicted as a funnel. However, a funnel is merely optional, as any one or more additional and/or alternative devices and/or ion optics may be used to guide ions to ion guide 2404.

Ion guide 2404 may be implemented by any suitable ion guide and is configured to guide ions from funnel 2402 to accumulator 2406. In some examples, ion guide 2404 is configured to filter ions received from funnel 2402 (e.g., based on m/z). Accumulator 2406 is configured to accumulate and store ions received from ion guide 2404. An exit of accumulator 2406 is aligned with a first port 1204-1 of ion router 2000. Accordingly, first port 1204-1 may receive first DC voltages (e.g., at first port electrode 1206-1) to operate first port 1204-1 as an entrance port to receive ions through first port 1204-1 from accumulator 2406.

When ions are received from accumulator 2406 into first port 1204-1, ion router 2000 may be configured to route the ions from first port 1204-1 to a second port 1204-2 operated as an exit port. For example, for positive ions, second port 1204-2 may be configured to receive second DC voltages (e.g., at second port electrode 1206-2) to operate second port 1204-2 as an exit port (e.g., when the first DC voltages are applied to first port 1204-1 and the second DC voltages are applied to second port 1204-2, ion router 2000 is configured to guide ions from first port 1204-1, through first ion channel 1208-1 toward common position 1302 and through second ion channel 1208-2 to second port 1204-2). In the example of FIG. 24, second port 1204-2 is oriented at about 90 degrees relative to first port 1204-1 such that the ions routed from first port 1204-1 to second port 1204-2 are turned about 90 degrees within ion router 2000 to second port 1204-2, as shown by first ion trajectory 2408-1. While ions are being routed by ion router 2000 from first port 1204-1 to second port 1204-2, third port 1204-3 and fourth port 1204-4 are configured to receive DC voltages to operate third port 1204-3 and fourth port 1204-4 as closed ports.

In the example of FIG. 24, an ion sorter 2410 is positioned at second port 1204-2 such that ions exiting ion router 2000 at second port 1204-2 enter ion sorter 2410. Ion sorter 2410 may be implemented by an ion guide (e.g., ion guide 100), as described above, configured to spatially separate ions (e.g., according to m/z). After ions are sorted within ion sorter 2410, second port 1204-2 of ion router 2000 may be selectively switched from operating as an exit port to operating as an entrance port such as by adjusting (e.g., increasing) DC voltages received by second port 1204-2. Accordingly, second port 1204-2 may then be configured to receive ions separated by ion sorter 2410. Moreover, third port 1204-3 may be selectively switched from a closed port to an exit port such as by adjusting (e.g., decreasing) DC voltages received by third port 1204-3 to operate third port 1204-3 as an exit port (e.g., ion router 2000 is configured to guide ions from second port 1204-2, through second ion channel 1208-2 toward common position 1302 and through third ion channel 1208-3 to third port 1204-3). In the example of FIG. 24, third port 1204-3 is oriented at about 90 degrees relative to second port 1204-2 such that the ions routed from second port 1204-2 to third port 1204-3 are turned about 90 degrees within ion router 2000 to third port 1204-3, as shown by second ion trajectory 2408-2.

Ions exiting ion router 2000 at third port 1204-3 may be directed to a mass analyzer 2412 for mass analysis. For example, ions exiting third port 1204-3 may be directed to mass analyzer 2412 such as by another ion funnel 2414 and/or ion guide 2416 positioned at third port 1204-3 such that ions exiting ion router 2000 at third port 1204-3 may enter ion funnel 2414 and/or ion guide 2416 to direct ions to mass analyzer 2412. However, ion funnel 2414 and/or ion guide 2416 are merely optional, as any one or more additional and/or alternative devices and/or ion optics may be used to guide ions to mass analyzer 2412.

Mass analyzer 2412 may be configured to separate ions according to m/z and/or perform a mass analysis of ions received from ion router 2000. In some examples, mass analyzer 2412 may be implemented by any suitable mass analyzer, such as a quadrupole mass filter, an ion trap (e.g., a three-dimensional quadrupole ion trap, a cylindrical ion trap, a linear quadrupole ion trap, a toroidal ion trap, etc.), a time-of-flight (TOF) mass analyzer, an electrostatic trap mass analyzer (e.g. an orbital electrostatic trap such as an Orbitrap mass analyzer, a Kingdon trap, an electrostatic linear ion trap, etc.), a Fourier transform ion cyclotron resonance (FT-ICR) mass analyzer, a sector mass analyzer, etc. Mass analyzer 2412 may be included in a mass spectrometer (not shown), which may further include any additional or alternative components not shown as may suit a particular implementation (e.g., ion optics, filters, lenses, ion stores, an autosampler, a detector, a collision cell, etc.).

While ions are being routed by ion router 2000 from second port 1204-2 to third port 1204-3, fourth port 1204-4 may continue to receive DC voltages to operate fourth port 1204-4 as a closed port. First port 1204-1 may also continue to receive first DC voltages to operate first port 1204-1 as an entrance port. Alternatively, the DC voltages received by first port 1204-1 may be adjusted (e.g., increased) to operate first port 1204-1 as a closed port. In instances where first port 1204-1 is continually operated as an entrance port, first port 1204-1 may be configured to continually receive DC voltages to operate first port 1204-1 as an entrance port without selectively switching first port 1204-1 to a closed port and/or an exit port.

Alternatively, ion router 2000 may be configured to route ions from accumulator 2406 to mass analyzer 2412, bypassing ion sorter 2410. In such a configuration, first port 1204-1 may receive first DC voltages (e.g., at first port electrode 1206-1) to operate first port 1204-1 as an entrance port to receive ions through first port 1204-1 from accumulator 2406. When ions are received from accumulator 2406 into first port 1204-1, ion router 2000 may be configured to route the ions from first port 1204-1 to third port 1204-3 operated as an exit port. For example, for positive ions, third port 1204-3 may be configured to receive DC voltages (e.g., at third port electrode 1206-3) to operate third port 1204-3 as an exit port (e.g., when the first DC voltages are applied to first port 1204-1 and the second DC voltages are applied to third port 1204-3, ion router 2000 is configured to guide ions from first port 1204-1, through first ion channel 1208-1 toward common position 1302 and through third ion channel 1208-3 to third port 1204-3). In the example of FIG. 24, third port 1204-3 is oriented at about 180 degrees relative to first port 1204-1 such that the ions routed from first port 1204-1 to third port 1204-3 flow straight through ion router 2000 to third port 1204-3, as shown by third ion trajectory 2408-3. While ions are being routed by ion router 2000 from first port 1204-1 to third port 1204-3, second port 1204-2 and fourth port 1204-4 may be configured to receive DC voltages to operate second port 1204-2 and fourth port 1204-4 as closed ports.

In some examples, ion router 2000 may be configured to receive ions included in a first sample at first port 1204-1 from accumulator 2406 and route the ions from first port 1204-1 to second port 1204-2 along first ion trajectory 2408-1 to eject the ions into ion sorter 2410. Ion router 2000 may then be configured to receive the ions included in the first sample at second port 1204-2 from ion sorter 2410 and route the ions from second port 1204-2 to third port 1204-3 along second ion trajectory 2408-2 to guide the ions toward mass analyzer 2412 for mass analysis. Ion router 2000 may further be configured to receive ions included in a second sample at first port 1204-1 from accumulator 2406 and route the ions from first port 1204-1 to third port 1204-3 along third ion trajectory 2408-3, bypassing ion sorter 2410, to guide the ions toward mass analyzer 2412 for mass analysis. In some examples, the passthrough of ions of the second sample from first port 1204-1 to third port 1204-3 can occur while ions of the first sample are being sorted in the ion sorter 2410. Such an arrangement can increase the duty cycle of analysis by enabling continuous operation of the mass analyzer 2412 (i.e., analysis of second sample ions while first sample ions are sorted) while also enabling the resolution and scheduling improvements provided by the ion sorter 2410. Still other suitable configurations for mass spectrometry system 2400 may be used as may suit a particular implementation. For example, any suitable component of mass spectrometry system 2400 may be positioned at any port 1204 of ion router 2000 to route ions from any component of mass spectrometry system 2400 to any other component of mass spectrometry system 2400. In addition, any other suitable ion router described herein may be used in place of ion router 2000.

Various modifications may be made to the apparatuses described herein. In some examples, port electrodes 1206 and/or electrodes 1210 arranged on first surface 1202-1 have a different configuration from port electrodes 1206 and/or electrodes 1210 arranged on second surface 1202-2.

In some examples, port electrodes 1206 and/or electrodes 1210 arranged on first surface 1202-1 and/or second surface 1202-2 include a combination of different electrode shapes or configurations. For example, port electrodes 1206 and/or electrodes 1210 arranged on first surface 1202-1 and/or second surface 1202-2 may include any combination of V-shaped electrodes or U-shaped electrodes.

In the examples described above, port electrodes 1206 and/or electrodes 1210 are rectangular. However, port electrodes 1206 and/or electrodes 1210 may have any other shape as may suit a particular implementation (e.g., rounded, oval, irregular, etc.).

In the examples described above, electrodes 1210 are arranged to form a linear (straight) ion path and/or ion channel 1208. In other examples, electrodes 1210 are arranged to form a non-linear ion path and/or ion channel 1208. For example, the ion path and/or ion channel 1208 may include one or more bends, turns, curves, and/or angles. Moreover, the ion routers described herein may include multiple ion paths and one or more common positions 1302 with other ion paths.

In the examples described above, electrodes 1210 are arranged on planar surfaces 1202. In other examples, electrodes 1210 are arranged on non-planar surfaces (e.g., surfaces 1202 may be angled or sloped) such that ion channels 1208 converge toward common position 1302 in two-dimensions. To illustrate, a depth of one or more ion channels 1208 may increase and/or decrease along axes 1306 to common position 1302. In some examples, ion channels 1208 associated with an entrance port and/or a closed port have a depth that increases from a port electrode 1206 to common position 1302 (e.g., common position 1302 is positioned lower than port electrodes 1206) and ion channels 1208 associated with an exit port have a depth that further increases from common position 1302 to a port electrode 1206 (e.g., the port electrodes 1206 are positioned lower than common position 1302).

In some examples, any one or more of ports 1204 and/or ion channels 1208 are formed by a stacked-ring ion guide.

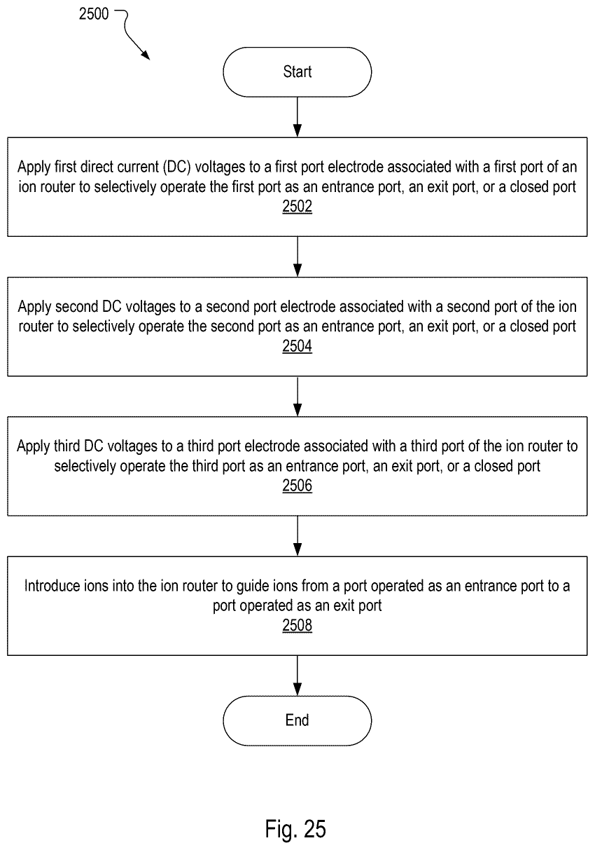

FIG. 25 shows a flowchart of an illustrative method 2500 of guiding ions. While FIG. 25 shows illustrative operations according to one example, other examples may omit, add to, reorder, and/or modify one or more operations of the method 2500 depicted in FIG. 25. Each operation of method 2500 depicted in FIG. 25 may be performed in any manner described herein.

At operation 2502, first DC voltages are applied to a first port electrode 1206-1 associated with a first port 1204-1 included in an ion router configured as described herein (e.g., ion router 1200, ion router 2000, or ion router 2200). The ion router includes a pair of opposing surfaces 1202, at least three ports 1204, and a plurality of ion channels 1208. The first DC voltage applied to first port electrode 1206-1 is configured to selectively operate the first port 1204-1 as an entrance port through which ions are received into the ion router, an exit port from which ions exit the ion router, or a closed port through which ions are neither received nor ejected by the ion router. The plurality of ion channels are defined by arrays of electrodes 1210 coupled to the pair of opposing surfaces and configured to receive one or more voltages for guiding ions form a port selectively operated as an entrance port to a port selectively operated as an exit port. In some examples, the plurality of ion channels converge toward a common position 1302 within the ion router and/or form a polygonal shape such that each ion channel is a radial segment within the polygonal shape.

At operation 2504, second DC voltages are applied to a second port electrode 1206-2 associated with a second port 1204-2 of the ion router to selectively operate the second port as an entrance port, an exit port, or a closed port.

At operation 2506, third DC voltages are applied to a third port electrode 1206-3 associated with a third port 1204-3 of the ion router to selectively operate the third port as an entrance port, an exit port, or a closed port.

At operation 2508, ions are introduced into the ion router to guide ions from a port operated as an entrance port to a port operated as an exit port. As an illustrative example, the first DC voltages may be applied to the first port electrode 1206-1 to operate the first port 1204-1 as an entrance port, the second DC voltages may be applied to the second port electrode 1206-2 to operate the second port 1204-2 as an exit port, and the third DC voltages may be applied to the third port electrode 1206-3 to operate the third port 1204-3 as a closed port. In such a configuration, when ions are introduced into the ion router, the ion router may guide the ions received at the first port 1204-1 to the second port 1204-2, where the ions may be ejected. To illustrate, the ions may be guided from the first port 1204-1 to the second port 1204-2 by the plurality of ions channels 1208.

In some examples, one or more of the first DC voltages, the second DC voltages, or the third DC voltages may be adjusted to switch one or more of the first port, the second port, or the third port to another of an entrance port, an exit port, or a closed port. In some examples, the first DC voltages, the second DC voltages, and the third DC voltages may be applied to selectively operate multiple ports of the ion router as entrance ports, to selectively operate multiple ports of the ion router as exit ports, and/or to selectively operate multiple ports of the ion router as closed ports. In some examples, at least one port of the ion router is designated as an entrance port and at least two other ports are configured to selectively operate as an exit port or a closed port.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

Advantages and features of the present disclosure can be further described by the following examples:
Example 1. An ion router comprising: a pair of opposing surfaces; at least three ports, each port included in the at least three ports defining an opening between the pair of opposing surfaces, wherein at least one port included in the at least three ports is configured as an entrance port through which ions are received into the ion router, and wherein at least two ports included in the at least three ports are configured to be selectively operated as either one of an exit port through which ions exit the ion router or a closed port through which ions are neither received nor ejected by the ion router; and a plurality of ion channels defined by arrays of electrodes coupled to the pair of surfaces and configured to receive one or more voltages for guiding ions from a port configured as an entrance port to a port selectively operated as an exit port, wherein the plurality of ion channels converge toward a common position within the ion router.
Example 2. The ion router of example 1, further comprising an electrode positioned at the common position and configured to receive one or more DC voltages for guiding ions from an ion channel associated with a port configured as an entrance port to another ion channel associated with a port selectively operated as an exit port.
Example 3. The ion router of example 1, wherein the plurality of ion channels are positioned relative to each other to form a polygonal shape.
Example 4. The ion router of example 3, wherein the polygonal shape includes one of a triangle, a square, a rectangle, a pentagon, or a hexagon.
Example 5. The ion router of example 3, wherein each ion channel included in the plurality of ion channels forms a radial segment within the polygonal shape.
Example 6. The ion router of example 1, wherein each ion channel included in the plurality of ion channels is connected with a port included in the at least three ports to allow ions to flow from the ion channel to the port or from the port to the ion channel.
Example 7. The ion router of example 6, wherein each ion channel included in the plurality of ion channels has a width that decreases from the port along an axis of the ion channel.
Example 8. The ion router of example 1, wherein each port included in the at least three ports is positioned at an edge of the pair of opposing surfaces.
Example 9. The ion router of example 1, wherein the at least two ports are configured to be selectively operated to switch between the exit port or the closed port during operation of the ion router.
Example 10. The ion router of example 1, wherein each port included in the at least three ports are configured to be selectively operated as any one of an entrance port, an exit port, or a closed port.
Example 11. The ion router of example 10, wherein the at least three ports each include a port electrode configured to receive one or more direct current (DC) voltages to selectively operate each port as the entrance port, the exit port, or the closed port.
Example 12. The ion router of example 11, wherein: a first port includes a first port electrode configured to receive a first DC voltage to selectively operate the first port as the closed port; a second port includes a second port electrode configured to receive a second DC voltage that is lower than the first DC voltage to selectively operate the second port as the entrance port; and a third port includes a third port electrode configured to receive a third DC voltage that is lower than the second DC voltage to selectively operate the third port as the exit port.
Example 13. The ion router of example 11, wherein the plurality of ion channels further includes one or more voltage dividers configured to provide a DC gradient from the at least three ports to a common position of the plurality of ion channels.
Example 14. The ion router of example 10, wherein the at least three ports each include a lens configured to receive the one or more DC voltages to selectively operate each port as the entrance port, the exit port, or the closed port.
Example 15. The ion router of example 14, wherein the lens is positioned at the opening of each port and includes a lens opening aligned with the opening of each port.
Example 16. The ion router of example 10, wherein multiple ports of the at least three ports are simultaneously selectively operated as an entrance port.
Example 17. The ion router of example 1, wherein each ion channel included in the plurality of ion channels is connected with a port included in the at least three ports to allow ions to flow from the ion channel to the port or from the port to the ion channel.
Example 18. The ion router of example 1, wherein the arrays of electrodes of the plurality of ion channels include: a first plurality of electrodes arranged along an axis of each ion channel and configured to receive first RF voltages; a second plurality of electrodes arranged along the axis of each ion channel in an alternating pattern with the first plurality of electrodes and configured to receive second RF voltages; and a third plurality of electrodes arranged along the axis of each ion channel in an alternating pattern with the first plurality of electrodes and the second plurality of electrodes and configured to receive third RF voltages; wherein, when the first plurality of electrodes receive the first RF voltages, the second plurality of electrodes receive the second RF voltages, and the third plurality of electrodes receive the third RF voltages, the first plurality of electrodes, the second plurality of electrodes, and the third plurality of electrodes apply a traveling wave pseudo-potential along the axis of each channel to guide the ions along the axis.
Example 19. The ion router of example 1, wherein an ion channel included in the plurality of ion channels and associated with a port configured as an entrance port or an exit port further includes one or more guard electrodes positioned along an axis of the ion channel, wherein the one or more guard electrodes are configured to receive one or more DC voltages for preventing a stream of ions from expanding outward along the axis of the ion channel.
Example 20. The ion router of example 1, further comprising a guard electrode extending longitudinally along an edge of one or more ion channels included in the plurality of ion channels, wherein the guard electrode is configured to receive one or more DC voltages for preventing ions from exiting laterally from the one or more ion channels.
Example 21. The ion router of example 1, further comprising a plurality of supports for maintaining a space between the pair of opposing surfaces, each support positioned between each port of the at least three ports and extending between the pair of opposing surfaces.
Example 22. The ion router of example 21, wherein each support is configured to receive one or more DC voltages for preventing a stream of ions from exiting between the at least three ports.
Example 23. An ion router comprising: a pair of opposing surfaces; at least three ports, each port included in the at least three ports defining an opening between the pair of opposing surfaces, wherein at least one port included in the at least three ports is configured to be selectively operated as any one of an entrance port through which ions are received into the ion router, an exit port through which ions exit the ion router, or a closed port through which ions are neither received nor ejected by the ion router; and a plurality of ion channels defined by arrays of electrodes coupled to the pair of surfaces and configured to receive one or more voltages for guiding ions from a port operated as an entrance port to a port operated as an exit port.
Example 24. A system comprising: an ion router comprising: a pair of opposing surfaces; at least three ports, each port included in the at least three ports defining an opening between the pair of opposing surfaces, wherein each port included in the at least three ports is configured to be selectively operated as any of an entrance port through which ions are received into the ion router, an exit port through which ions exit the ion router, or a closed port through which ions are neither received nor ejected by the ion router; and a plurality of ion channels defined by arrays of electrodes coupled to the pair of surfaces and configured to receive one or more voltages for guiding ions from a port operated as an entrance port to a port operated as an exit port; and an ion sorter coupled with a first port included in the at least three ports, wherein the ion router is configured to transmit ions to the ion sorter when the first port is selectively operated as an exit port and to receive ions from the ion sorter when the first port is selectively operated as an entrance port.
Example 25. The system of example 24, wherein the first port is selectively switched from operating as the exit port to operating as the entrance port after ions have been transmitted to the ion sorter.
Example 26. The system of example 24, wherein a second port included in the at least three ports is coupled with a mass spectrometer for performing a mass analysis of the ions, wherein the ion router is configured to transmit ions to the mass spectrometer when the second port is selectively operated as the exit port.
Example 27. The system of example 26, wherein the second port is selectively operated as a closed port when the first port is selectively operated as an exit port.
Example 28. The system of example 26, further comprising an accumulator configured to store ions and coupled with a third port included in the at least three ports, wherein the ion router is configured to receive ions from the accumulator when the third port is selectively operated as an entrance port.
Example 29. The system of example 28, wherein the ion router is configured so that ions bypass the ion sorter when the first port is selectively operated as a closed port, the second port is selectively operated as an exit port, and the third port is selectively operated as an entrance port.
Example 30. A method of operating an ion router comprising: applying a first direct current (DC) voltage to a first port electrode associated with a first port to selectively operate the first port as an entrance port through which ions are received into the ion router, an exit port through which ions exit the ion router, or as a closed port through which ions are neither received nor ejected by the ion router; applying a second DC voltage to a second port electrode associated with a second port to selectively operate the second port as an entrance port through which ions are received into the ion router, an exit port through which ions exit the ion router, or as a closed port through which ions are neither received nor ejected by the ion router; applying a third DC voltage to a third port electrode associated with a third port to selectively operate the third port as an entrance port through which ions are received into the ion router, an exit port through which ions exit the ion router, or as a closed port through which ions are neither received nor ejected by the ion router; and introducing ions into a port operated as an entrance port to guide the ions from the port operated as an entrance port to a port operated as an exit port.
Example 31. The method of example 30, further comprising adjusting one or more of the first DC voltage, the second DC voltage, or the third DC voltage to switch one or more of the first port, the second port, or the third port to another of an entrance port, an exit port, or a closed port.
Example 32. The method of example 30, further comprising applying voltages to a plurality of ion channels defined by arrays of electrodes to guide ions from the port operated as the entrance port to the port operated as the exit port.
Example 33. The ion router of example 11, wherein: a first port includes a first port electrode configured to receive a first DC voltage to selectively operate the first port as the closed port; a second port includes a second port electrode configured to receive a second DC voltage that is higher than the first DC voltage to selectively operate the second port as the entrance port; and a third port includes a third port electrode configured to receive a third DC voltage that is higher than the second DC voltage to selectively operate the third port as the exit port.

What is claimed is:

1. An ion router comprising:
a pair of opposing surfaces;
at least three ports, each port included in the at least three ports defining an opening between the pair of opposing surfaces, wherein at least one port included in the at least three ports is configured as an entrance port through which ions are received into the ion router, and wherein at least two ports included in the at least three ports are configured to be selectively operated as either one of an exit port through which ions exit the ion router or a closed port through which ions are neither received nor ejected by the ion router; and
a plurality of ion channels defined by arrays of electrodes coupled to the pair of surfaces and configured to receive one or more voltages for guiding ions from a port configured as an entrance port to a port selectively operated as an exit port, wherein the plurality of ion channels converge toward a common position within the ion router.

2. The ion router of claim 1, further comprising an electrode positioned at the common position and configured to receive one or more DC voltages for guiding ions from an ion channel associated with a port configured as an entrance port to another ion channel associated with a port selectively operated as an exit port.

3. The ion router of claim 1, wherein the plurality of ion channels are positioned relative to each other to form a polygonal shape.

4. The ion router of claim 3, wherein each ion channel included in the plurality of ion channels forms a radial segment within the polygonal shape.

5. The ion router of claim 1, wherein each ion channel included in the plurality of ion channels has a width that decreases from a port included in the at least three ports toward the common position.

6. The ion router of claim 1, wherein the at least two ports are configured to be selectively operated to switch between the exit port or the closed port during operation of the ion router.

7. The ion router of claim 1, wherein each port included in the at least three ports are configured to be selectively operated as any one of an entrance port, an exit port, or a closed port.

8. The ion router of claim 7, wherein the at least three ports each include a port electrode configured to receive one or more direct current (DC) voltages to selectively operate each port as the entrance port, the exit port, or the closed port.

9. The ion router of claim 8, wherein:
a first port includes a first port electrode configured to receive a first DC voltage to selectively operate the first port as the closed port;
a second port includes a second port electrode configured to receive a second DC voltage that is lower than the first DC voltage to selectively operate the second port as the entrance port; and
a third port includes a third port electrode configured to receive a third DC voltage that is lower than the second DC voltage to selectively operate the third port as the exit port.

10. The ion router of claim 8, wherein the plurality of ion channels further includes one or more voltage dividers configured to provide a DC gradient from the at least three ports to a common position of the plurality of ion channels.

11. The ion router of claim 8, wherein the at least three ports each include a lens configured to receive the one or more DC voltages to selectively operate each port as the entrance port, the exit port, or the closed port.

12. The ion router of claim 11, wherein the lens is positioned at the opening of each port and includes a lens opening aligned with the opening of each port.

13. The ion router of claim 7, wherein multiple ports of the at least three ports are simultaneously selectively operated as an entrance port.

14. The ion router of claim 1, wherein each ion channel included in the plurality of ion channels is connected with a port included in the at least three ports to allow ions to flow from the ion channel to the port or from the port to the ion channel.

15. The ion router of claim 1, wherein the arrays of electrodes of the plurality of ion channels include:
a first plurality of electrodes arranged along an axis of each ion channel and configured to receive first RF voltages;
a second plurality of electrodes arranged along the axis of each ion channel in an alternating pattern with the first plurality of electrodes and configured to receive second RF voltages; and
a third plurality of electrodes arranged along the axis of each ion channel in an alternating pattern with the first plurality of electrodes and the second plurality of electrodes and configured to receive third RF voltages;
wherein, when the first plurality of electrodes receive the first RF voltages, the second plurality of electrodes receive the second RF voltages, and the third plurality of electrodes receive the third RF voltages, the first plurality of electrodes, the second plurality of electrodes, and the third plurality of electrodes apply a traveling wave pseudo-potential along the axis of each channel to guide the ions along the axis.

16. The ion router of claim 1, wherein an ion channel included in the plurality of ion channels and associated with a port configured as an entrance port or an exit port further includes one or more guard electrodes positioned along an axis of the ion channel, wherein the one or more guard electrodes are configured to receive one or more DC voltages for preventing a stream of ions from expanding outward along the axis of the ion channel.

17. The ion router of claim 1, further comprising a plurality of supports for maintaining a space between the pair of opposing surfaces, each support positioned between each port of the at least three ports and extending between the pair of opposing surfaces.

18. The ion router of claim 17, wherein each support is configured to receive one or more DC voltages for preventing a stream of ions from exiting between the at least three ports.

19. An ion router comprising:
a pair of opposing surfaces;
at least three ports, each port included in the at least three ports defining an opening between the pair of opposing surfaces, wherein at least one port included in the at least three ports is configured to be selectively operated as any one of an entrance port through which ions are received into the ion router, an exit port through which ions exit the ion router, or a closed port through which ions are neither received nor ejected by the ion router; and
a plurality of ion channels defined by arrays of electrodes coupled to the pair of surfaces and configured to receive one or more voltages for guiding ions from a port operated as an entrance port to a port operated as an exit port.

20. A system comprising:
an ion router comprising:
a pair of opposing surfaces;
at least three ports, each port included in the at least three ports defining an opening between the pair of opposing surfaces, wherein each port included in the at least three ports is configured to be selectively operated as any of an entrance port through which ions are received into the ion router, an exit port through which ions exit the ion router, or a closed port through which ions are neither received nor ejected by the ion router; and
a plurality of ion channels defined by arrays of electrodes coupled to the pair of surfaces and configured to receive one or more voltages for guiding ions from a port operated as an entrance port to a port operated as an exit port; and
an ion sorter coupled with a first port included in the at least three ports, wherein the ion router is configured to transmit ions to the ion sorter when the first port is selectively operated as an exit port and to receive ions from the ion sorter when the first port is selectively operated as an entrance port.
